(19) United States
(12) Patent Application Publication
(10) Pub. No.: US 2025/0274409 A1
(43) Pub. Date: Aug. 28, 2025

(54) EMAIL INTERFACE FOR GENERATIVE ARTIFICIAL INTELLIGENCE MODELS

(71) Applicant: Riffback LLC, Dresher, PA (US)

(72) Inventor: Kevin Augustine Rieffel, Dresher, PA (US)

(73) Assignee: Riffback LLC, Dresher, PA (US)

(21) Appl. No.: 19/055,467

(22) Filed: Feb. 17, 2025

Related U.S. Application Data
(60) Provisional application No. 63/556,836, filed on Feb. 22, 2024.

(51) Int. Cl. H04L 51/02; H04L 51/18; H04L 51/226

(52) U.S. Cl. CPC H04L 51/02; H04L 51/18; H04L 51/226

(57) ABSTRACT

Some embodiments of the present disclosure may include a method for processing request emails using a Generative AI email platform, including receiving a request email from a sender. Some embodiments may also include identifying the sender of the request email. Some embodiments may also include determining whether the sender may be an authenticated user. Some embodiments may also include, if the sender may be not an authenticated user, generating a reply email inviting the sender to sign up. Some embodiments may also include, if the sender may be an authenticated user, determining a prompt from the request email and inputting the prompt into the AI model. Some embodiments may also include receiving an output from the AI model based on the prompt. Some embodiments may also include generating a reply email based on the output and transmitting the reply email to the sender and/or another address.

### CROSS-REFERENCE TO RELATED APPLICATIONS

This application is a continuation of U.S. Provisional Patent Application No. 63/556,836, filed Feb. 22, 2024, the disclosure of which is hereby incorporated by reference herein in its entirety.

### BACKGROUND

The present disclosure relates to interfacing with Generative Artificial Intelligence (AI) models, and more particularly to systems and related processes for providing an interface with a Generative AI model via email.

### SUMMARY

Generative Artificial Intelligence (Gen AI) represents a significant advancement in the field of machine learning and AI. Gen AI refers to a class of AI models that are capable of generating new content based on their training. For example, it can write a poem, draw a picture, or make a song. To do this, Gen AI is trained on a lot of data and follows the input prompt as a guide. Input access for Gen AI is typically provided via chatbots, which often have issues with privacy and security. Gen AI chatbots are designed to respond quickly and require immense resources to process and reply in multiple contemporaneous conversations. Gen AI is resource intense, requires powerful hardware, and a global semiconductor shortage limits the industry's growth. Moreover, each Gen AI platform has its own corresponding web application and/or downloadable mobile application for access to a chatbot or other input—each with its own unfamiliar interface and quirks. Email, on the other hand, has been, e.g., consistent, secure, private, asynchronous, and easily accessible for several decades. An interface that monitors incoming mail for Gen AI prompts and relays inputs and outputs can improve privacy, security, accessibility, and resource allocation for Gen AI platforms. Receiving prompts via an electronic mailbox can facilitate easy access to millions of email users who may not want to download a new app or use a new interface. Prioritizing tasks as they are received via email can help balance processing timing for a Gen AI model. Tracking subscriber usage can prevent overuse and abuse of system resources. There exists a need to bring the best aspects of email to the Gen AI world.

Artificial Intelligence has seen remarkable advancements in recent years, with generative AI models emerging as a significant area of research and application. Generally, generative AI models learn from existing data and then generate new instances of data that reflect the patterns and structures found in the training data. This ability to generate novel content has opened up a plethora of applications, from creating realistic images to writing coherent and contextually relevant text. The ability of these models to create new and coherent outputs has opened up new possibilities in various industries, from entertainment and art to healthcare and technology.

One of the most impactful developments in generative AI has been the advent of large language models (LLMs). These models, trained on vast amounts of text data, have the ability to generate human-like text that is contextually relevant, grammatically correct, and often indistinguishable from text written by humans. Large language models leverage a type of neural network architecture known as transformers, which allow the models to understand the context of words and sentences by taking into account their relationships with all other words in the text, rather than just their immediate neighbors. The power of these large language models lies in their ability to understand and generate text across a wide range of topics and styles. They can write essays, answer questions, create poetry, and even generate code. This versatility makes them valuable tools in a variety of fields, including customer service, content creation, education, and more.

Generative AI models for image creation are trained on vast datasets comprising billions of image-text pairs. This extensive training enables the AI to learn the visual characteristics of various objects, colors, and patterns. Upon receiving a textual prompt, the trained AI can generate corresponding images, thereby demonstrating its understanding of the visual world.

Typically, in the context of generative AI for language and/or images, a chatbot serves as an interface that allows users to interact with the AI model. For instance, specific Generative AI models may be accessed via a chatbot that interfaces with, e.g., ChatGPT, Microsoft Copilot, Google Bard, and more. Generally, a chatbot is a software application that simulates human conversation with an end user through text or voice interactions. A chatbot can use artificial intelligence techniques, such as natural language processing and machine learning, to understand the user's questions and generate appropriate responses. With Gen AI, a user provides a prompt, which is a directive or instruction, to the chatbot. This prompt can be in the form of text, an image, a video, or any format that the generative solution can process.

In terms of security, while large language models have the potential to generate useful and creative content, they also pose risks. One of the primary security concerns with Gen AI models is data privacy. These models receive a substantial amount of data input, which may include sensitive or proprietary information. If not properly managed, this data could be exposed or misused, leading to potential privacy breaches. This is particularly concerning given the increasing regulations around data privacy, such as the General Data Protection Regulation (GDPR) in the European Union.

Another security challenge is the potential for adversarial attacks. These attacks involve manipulating the input to the model in a way that causes it to produce incorrect or misleading output. For instance, an attacker could craft a specific input that causes the model to reveal sensitive information it has learned during training. In some cases, an attacker can use brute force and/or speed to overwhelm a Generative AI chatbot with multitudes of prompts. Defending against these attacks requires robust security measures and constant vigilance.

The use of Gen AI models in chatbots introduces additional security challenges.

Chatbots are often deployed on public platforms and interact with a wide range of users, increasing the risk of exposure to malicious inputs. Furthermore, chatbots often handle sensitive user data, such as personal details or financial information, which could be targeted by attackers.

The real-time nature of chatbots also presents a security challenge. Unlike traditional applications, where there may be time to detect and respond to security threats, chatbots need to respond to user inputs immediately. This leaves little time for traditional security measures such as manual review or moderation.

Efficiency is another critical concern of generative AI systems. Systems do not always process requests and generate responses promptly, leading to an inconsistent experience. One of the primary efficiency challenges is the computational resources required by Gen AI models. These models are typically large and complex, requiring significant processing power and memory to generate responses. This can lead to latency issues, particularly in real-time chatbot applications where quick response times are crucial.

Moore's law is an empirical observation that the number of transistors in an integrated circuit (IC) doubles approximately every two years, while the cost of the IC decreases proportionally. Generative AI relies heavily on the computational power and memory capacity of the hardware devices that run the neural networks. Moore's law has a direct impact on the performance and efficiency of generative AI, as it enables the development of more complex and sophisticated models and algorithms. Semiconductor chips are the essential components that enable the processing, storage, and transmission of data. Without sufficient supply of semiconductor chips, the performance, functionality, and availability of these devices can be severely compromised.

The semiconductor industry has been facing a worldwide shortage of chips due to the lingering issues from the pandemic along with surging demand from various sectors. The chip shortage poses a significant challenge for accessing Gen AI, as it limits the ability of users to obtain and use the devices that run Generative AI applications. The chip shortage also hinders the development and innovation of Gen AI, as it constrains the capacity and capability of the hardware platforms that support Generative AI models and algorithms.

The development and maintenance of Generative AI models require substantial computational resources and expertise, leading to various monetization strategies such as premium subscriptions or à la carte API key access.

A premium subscription model allows users to access the Gen AI model's capabilities for a recurring fec. This model often includes tiered pricing, where users can choose from different levels of service based on their needs. Higher tiers may offer more extensive usage, faster response times, or access to more advanced features. This model provides a steady revenue stream for the service provider and allows for continuous development and improvement of the Gen AI model.

API key access is another common monetization strategy. In this model, users are given a unique key that allows them to make requests to the Gen AI model via an API (Application Programming Interface). Users are typically charged based on the number of requests made or the amount of data processed. This model allows for flexible usage and can cater to both small-scale and large-scale users. However, service providers must still ensure that their systems can handle the potentially high demand and that usage is accurately tracked and billed.

The use of Gen AI models in chatbots also presents challenges in terms of scalability. As the number of users or the complexity of the interactions increases, the demands on the Generative AI model also increase. Managing these demands while maintaining efficient operation can be a significant challenge.

The iterative nature of Gen AI chatbot interactions can also present efficiency challenges. Each user input requires a new response from the Gen AI model, and the model must maintain the context of the conversation across multiple inputs. This requires efficient management of state and memory, adding another layer of complexity to the operation of the chatbot.

While chatbots have been hailed as a significant advancement in human-computer interaction, their near-exclusive use as an interface for generative AI systems has raised some concerns. The reliance on chatbots for input can limit the scope of interaction, confining it to a conversational format that may not always be the most effective or efficient. Generative AI has undoubtedly enhanced the capabilities of chatbots, enabling them to produce contextually appropriate responses. However, this has led to an over-reliance on chatbots, potentially stifling the exploration of other, possibly more effective, interfaces for generative AI.

Another alternative approach to chatbots may be using voice as input. Voice assistants, as a form of human-computer interaction, have also revolutionized the way users engage with digital services by, e.g., providing a hands-free, natural language interface for a variety of digital content. By integrating with generative AI models, these assistants can generate human-like responses, making the interaction more dynamic and engaging.

Despite these advancements, the use of voice assistants as interfaces with generative AI models presents several challenges including, e.g., privacy, security, a lack of visual cues, and an inability to handle attachments. For instance, voice assistants are often always listening for a wake word to activate, leading to potential eavesdropping-digital or otherwise. Users may inadvertently share sensitive information, which could be misused if the data is not properly secured. This constant listening feature raises significant privacy concerns that need to be addressed to ensure user trust and acceptance.

Security is another significant issue. As voice assistants become more integrated into our daily lives, they become attractive targets for hackers. Ensuring that these systems are secure from external threats is paramount. This includes securing the data transmission between the device and the server, protecting the data stored on the device, and ensuring that the AI models themselves are robust against adversarial attacks.

The lack of visual cues in voice assistants can also pose a challenge. Users do not receive immediate visual feedback that they would typically get from a graphical interface. This can make it difficult for users to know whether the voice assistant has correctly understood their request, leading to potential misunderstandings and frustration. These misunderstandings could exacerbate hallucinations.

Moreover, voice assistants currently lack the ability to handle documents, images, PDFs, or other attachments as input or output effectively. This limits their use in scenarios where users need to interact with complex documents or receive detailed written responses. While advancements are being made in this area, the current state of technology does not yet fully support this functionality.

Email has become a ubiquitous form of communication, transcending age, physical abilities, and professional boundaries. Its simplicity, accessibility, and efficiency have made it a preferred mode of communication for diverse groups of people, including older adults, individuals with disabilities, and children.

In the business world, email is indispensable. It facilitates internal and external communication, document sharing, and coordination of tasks. Its ability to reach multiple recipients simultaneously makes it ideal for disseminating information to teams or entire organizations. Furthermore, the traceability of email communication aids accountability and record-keeping. Despite the rise of collaborative work platforms, email remains a mainstay in business communication due to its universality, versatility, and the privacy it offers for one-on-one communication.

While both email and chatbot webpages have their own security measures, the encryption, authentication, control, and accountability offered by email systems can provide a higher degree of security and privacy. Email has been routinely demonstrated as secure enough for government use. Corporations and government agencies often handle sensitive information that requires a high level of security and privacy. As such, they typically employ advanced email systems that incorporate robust security measures and privacy controls. These systems may include features such as end-to-end encryption, multi-factor authentication, intrusion detection systems, and secure email gateways. End-to-end encryption ensures that emails are only readable by the sender and the intended recipient, even while in transit. Multi-factor authentication adds an extra layer of security by requiring users to provide two or more forms of identification before accessing their email accounts.

Prior approaches to generative artificial intelligence have indeed faced challenges in areas such as security, efficiency, and accessibility. For instance, traditional AI systems often lack robust security measures. They may not have mechanisms to authenticate users or verify the legitimacy of requests. This can lead to unauthorized access or misuse of the system. Additionally, these systems may not have adequate data protection measures in place, potentially compromising the privacy and confidentiality of user data.

As described herein are systems and methods for processing user requests via email, incorporating advanced Generative AI Models, and ensuring the integrity and efficiency of the process. The interface, referred to as a Generative AI via Email Interface, brings the most dependable features of email to Gen AI platforms.

The integration of robust, secure email systems, as used by corporations or government agencies, into the access mechanisms for large language models or other generative AI models can offer several advantages. These advantages span enhanced security, improved privacy, and better control over the use of Generative AI models. The security features inherent in corporate or government email systems can help protect the AI models from unauthorized access. Features such as multi-factor authentication, secure email gateways, and end-to-end encryption can ensure that only authorized users can interact with the Generative AI models. This can prevent misuse of the Gen AI models and protect the integrity of the generated content.

The privacy controls in these email systems can help protect sensitive data. For instance, when users interact with AI models via email, they often share personal or sensitive information in their queries. Privacy controls can ensure that this information is handled in a secure and compliant manner. This is particularly important for AI models used in sectors like healthcare or finance, where data privacy is paramount.

Using an email system to access AI models can provide better control over the use of the models. For example, access controls can be implemented to limit the use of AI models based on the user's role or subscription level. Additionally, usage logs can be maintained to monitor the use of AI models, which can be useful for auditing and compliance purposes.

The familiarity and ubiquity of email make it an accessible and user-friendly interface for interacting with AI models. Users can send queries to the AI model and receive responses directly in their inbox, without needing to learn a new interface or install additional software. This can lower the barrier to entry for users, making advanced AI models more accessible to a wider audience.

Many approaches to generative AI often require significant computational resources and time to generate content. This is especially true for complex tasks or large datasets.

Moreover, these models may not have mechanisms to prioritize tasks or manage resources effectively, leading to inefficiencies.

Typical Generative AI systems may not be user-friendly or easily accessible to non-expert users. They often require specialized knowledge or skills to use effectively. Furthermore, these systems may not support a wide range of formats or channels for input and output, limiting their usability. For instance, they may not be able to process requests via common communication channels like email or handle diverse types of prompts such as natural language queries, images, or code. Email applications that have AI tools like Apple's auto-complete or Google “Smart Compose” require use of their proprietary apps.

In contrast, a Generative AI via Email Interface addresses these challenges by incorporating advanced AI models, robust security measures, efficient scheduling and resource management mechanisms, and a user-friendly interface (e.g., a user's choice of app) that supports a wide range of prompts and communication channels.

A Generative AI via Email Interface is designed to provide a robust and secure method for handling user requests. It begins with an email sender transmitting a request email to an email server, initiating a communication request from a user or system. The interface server then accesses the email(s) from the email server, signifying the retrieval of the user's request. A receive request email is sent from the email server to the interface server, indicating the successful transmission of the email. The interface server interacts with a security module to verify the sender, ensuring the authenticity of the sender and protecting against unauthorized access.

Once the sender is authenticated, the interface server checks with a subscription module to confirm if the sender has sufficient credits. This step validates the sender's subscription status and ensures they have the necessary resources to proceed. The interface server then interacts with prompt extractors to extract prompts from the request email, parsing the email content to identify the user's request or command. The extracted prompts are then scheduled based on their nature by a scheduling module, organizing the processing of the prompts according to predefined rules or algorithms. The scheduled prompts are input into generative ai models, which process the prompts and generate the required output. The output is sent back to the interface server, which prepares the reply email. Finally, the prepared reply email is transmitted back to the email sender via the email server, completing the process.

A Generative AI via Email Interface offers numerous benefits over a chat interface, including enhanced security, efficiency, and accessibility. The system's security features, such as sender authentication and subscription verification, protect against unauthorized access and ensure that only legitimate users can access the system. The efficiency of the system is evident in its ability to process and respond to user requests promptly and accurately, thanks to, e.g., systematic scheduling of prompt inputting. Furthermore, the system's accessibility is enhanced by its ability to handle requests via email, a widely used and familiar communication medium. These features make a Generative AI via Email Interface a valuable tool for facilitating effective and secure communication between users and AI systems.

In some embodiments, an email server may be configured to receive and process incoming emails from the email sender, holding the emails until they are retrieved by the interface server. The interface server retrieves emails from the email server and facilitates communication between the email server and other system modules. In some embodiments, an interface server includes control circuitry for managing operational controls, processing circuitry for handling data processing, input/output path for facilitating communication channels, and storage/memory for data storage.

In some embodiments, a security module verifies the identity and authenticity of the Email Sender by performing authentication procedures such as checking the email address, password, and/or other credentials of the email sender. This ensures that only authorized users can access the system and request content generation. In some embodiments, a subscription module checks the subscription status and credit balance of the email sender, ensuring that users have an active subscription and sufficient credits to request content generation, deducting credits based on prompt submission and/or complexity. In some embodiments, a billing module handles all billing-related tasks, including tracking usage, calculating charges, generating invoices, and processing payments.

In some embodiments, a scheduling module may schedule the input of the prompts to one or more generative AI models based on the priority, urgency, and/or difficulty of the prompts. This may optimize the resource allocation and utilization of the generative AI models.

In some embodiments, one or more prompt extractors are configured to extract prompts from the request email and parse them into structured and standardized formats. Prompt extractors may include various modules such as an NLP module for processing natural language prompts, an address module for extracting and handling address-related prompts, the dynamic address module for handling dynamic address prompts, the image recognition module for processing image-based prompts, the OCR module for extracting text from images, and an automation module for executing automated tasks based on the prompts.

In some embodiments, one or more generative AI models may generate content using AI models based on the prompts. For instance, the generative AI models may include various modules such as the AI language generator for generating text-based content, the AI image generator for creating images based on prompts, the AI video generator for producing videos based on prompts, and the AI data generator for handling data-related requests based on prompts. These modules may be configured to work in harmony to ensure a robust and efficient system for processing and generating content.

### BRIEF DESCRIPTION OF DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

The above and other objects and advantages of the disclosure will be apparent upon consideration of the following detailed description, taken in conjunction with the accompanying drawings, in which like reference characters refer to like parts throughout, and in which:

FIG. 1 depicts an illustrative flow diagram for an interface processing request emails using a Gen AI platform, in accordance with some embodiments of this disclosure.

FIG. 2 depicts an illustrative flow diagram for an interface verifying and processing request emails using a Gen AI platform, in accordance with some embodiments of this disclosure.

FIG. 3 depicts an illustrative flow diagram for an interface scheduling and processing request emails using a Gen AI platform, in accordance with some embodiments of this disclosure.

FIG. 4 depicts an illustrative schematic diagram for an interface server and interconnected modules used in processing request emails using a Gen AI platform, in accordance with some embodiments of this disclosure.

FIG. 5A depicts an illustrative flow diagram for an interface processing request emails using a Gen AI platform and a subscription module, in accordance with some embodiments of this disclosure.

FIG. 5B depicts an illustrative flow diagram for an interface processing request emails using a Gen AI platform and a subscription module, in accordance with some embodiments of this disclosure.

FIG. 5C depicts an illustrative flow diagram for an interface processing request emails using a Gen AI platform and a scheduling module, in accordance with some embodiments of this disclosure.

FIG. 5D depicts an illustrative flow diagram for an interface processing request emails using a Gen AI platform and a natural language processing module, in accordance with some embodiments of this disclosure.

FIG. 5E depicts an illustrative flow diagram for an interface processing request emails using a Gen AI platform and an address module, in accordance with some embodiments of this disclosure.

FIG. 5F depicts an illustrative flow diagram for an interface processing request emails using a Gen AI platform and a dynamic address module, in accordance with some embodiments of this disclosure.

FIG. 5G depicts an illustrative flow diagram for an interface processing request emails using a Gen AI platform capable of generating images, in accordance with some embodiments of this disclosure.

FIG. 5H depicts an illustrative flow diagram for an interface processing request emails using a Gen AI platform and an image recognition module, in accordance with some embodiments of this disclosure.

FIG. 5I depicts an illustrative flow diagram for an interface processing request emails using a Gen AI platform and an automation module, in accordance with some embodiments of this disclosure.

FIG. 5J depicts an illustrative flow diagram for an interface processing request emails using a private Gen AI platform, in accordance with some embodiments of this disclosure.

FIG. 5K depicts an illustrative flow diagram for an interface processing request emails using a Second Generative AI platform, in accordance with some embodiments of this disclosure.

FIG. 5L depicts an illustrative flow diagram for an interface processing request emails using an AI Audio Generation Model, in accordance with some embodiments of this disclosure.

FIG. 6 depicts illustrative devices and systems for an interface processing request emails using a Gen AI platform, in accordance with some embodiments of this disclosure.

FIG. 7 depicts illustrative devices and systems for an interface processing request emails using a Gen AI platform, in accordance with some embodiments of this disclosure.

FIG. 8 depicts an illustrative sequence diagram for an interface processing request emails using a Gen AI platform, in accordance with some embodiments of this disclosure.

FIG. 9 depicts an illustrative queue data structure for processing request emails using a Gen AI platform, in accordance with some embodiments of this disclosure.

FIG. 10 is a flowchart illustrating a method for processing request emails using a Gen AI platform for an authenticated user, in accordance with some embodiments of this disclosure.

FIG. 11 is a flowchart illustrating a method for processing a new subscriber requesting processing of an email using a Gen AI platform for an authenticated user, in accordance with some embodiments of this disclosure.

FIG. 12 is a flowchart illustrating a method for processing request emails using a Gen AI platform, in accordance with some embodiments of this disclosure.

FIG. 13 is a flowchart illustrating a method for processing request emails using a Gen AI platform for a subscriber, in accordance with some embodiments of this disclosure.

FIG. 14 is an exemplary user interface for adjustable settings to be used when processing request emails using a Gen AI platform for a subscriber, in accordance with some embodiments of this disclosure.

FIG. 15A is a diagram depicting pseudo code for accessing an email server to download new emails to add to a request queue, in accordance with some embodiments of this disclosure.

FIG. 15B is a diagram depicting pseudo code for accessing an email server to download new emails to process, identify a prompt, and add to a request queue, in accordance with some embodiments of this disclosure.

FIG. 15C is a diagram depicting pseudo code for accessing an email server to download new emails to process, identify a due date and time, and add to a request queue, in accordance with some embodiments of this disclosure.

FIG. 15D is a diagram depicting pseudo code for working through a request queue, inputting each task from the queue into a Gen AI model, and generating an email message based on the output, in accordance with some embodiments of this disclosure.

FIG. 15E is a diagram depicting pseudo code for working through a request queue, inputting each task from the queue into a Gen AI model, generating an output email message based on the output, and sending the output email message, in accordance with some embodiments of this disclosure.

FIG. 16 depicts an illustrative flow diagram for an interface used in processing request multimedia messages using a Gen AI platform, in accordance with some embodiments of this disclosure.

### DETAILED DESCRIPTION

With Generative AI, chatbots are generally used to provide a conversational interface that allows users to interact with complex systems in a natural, intuitive manner. In the context of generative AI, chatbots serve as the standard medium for users to provide prompts or ask questions in natural language, and in return, receive responses generated by the AI. Generative AI chatbots represent a significant portion in the field of artificial intelligence and natural language processing. These chatbots leverage advanced machine learning algorithms to generate human-like text, enabling them to engage in interactive conversations with users. Generative AI has further enhanced the capabilities of chatbots, enabling them to produce contextually appropriate and coherent responses. Unlike rule-based chatbots, which are programmed with predefined responses to specific inputs, generative AI chatbots can generate unique responses to a wide range of inputs, making them more versatile and capable of handling complex and unpredictable conversations.

The development and deployment of generative AI chatbots also present several challenges. One of the primary challenges is the computational resources required to train and run these large language models. Training a large language model requires a significant amount of computational power and storage, making it a resource-intensive process. Similarly, generating responses in real-time requires efficient algorithms and hardware to ensure a smooth user experience.

The underlying technology of generative AI chatbots is often based on large language models trained on vast amounts of text data. Generative Pretrained Transformers (GPT) models leverage machine learning techniques to generate human-like text, making them highly effective for a wide range of applications. These models, such as GPT-3 or GPT-4, learn the statistical patterns of language from the training data and use this knowledge to generate text that is contextually relevant and grammatically correct. Customized GPT models can also be fine-tuned to adhere to specific guidelines or constraints. This ability to generate coherent and contextually appropriate responses is what sets generative AI chatbots apart from their rule-based counterparts. Such GPT models leverage machine learning techniques to generate human-like text, making them highly effective for a wide range of applications.

One of the most common types of generative AI is Generative Adversarial Networks (GANs). GANs consist of two neural networks, a generator and a discriminator, that are trained simultaneously. The generator creates new data instances, while the discriminator evaluates them for authenticity; i.e., whether they belong to the actual training dataset or not. This dynamic creates a compelling competition where the generator continually improves its ability to generate realistic data, and the discriminator enhances its ability to distinguish real data from the generated ones.

Another type of generative AI is Variational Autoencoders (VAEs). VAEs are a type of autoencoder, a neural network used for data encoding and decoding. VAEs add a probabilistic spin to autoencoders and are particularly useful when you want the model to learn a continuous, low-dimensional distribution of data. They are widely used in the generation of complex data like images, music, and speech.

Transformers, particularly those used in Natural Language Processing (NLP), represent another type of generative AI. Models like GPT-3 and BERT have shown remarkable ability in generating human-like text. These models can write essays, create poetry, and even generate code. They work by predicting the next word in a sentence and can generate a complete piece of text when this process is repeated.

While GANs are widely used in image generation, video generation, and voice generation, there are other techniques and architectures used in the field of generative AI. VAEs, are another popular generative model, especially for tasks where it's important to have a strong understanding of the latent space (like in anomaly detection or certain reinforcement learning tasks). Moreover, Transformer-based models, which were originally designed for natural language processing tasks, have also been adapted for image generation tasks. An example of this is DALL· E, a model by OpenAI, which generates images from textual descriptions.

Some generative AI models employ “stable diffusion” models to rapidly transform words into visually stunning images. Despite the impressive capabilities of AI in generating images, it is noteworthy that there is typically a human element involved in every image used.

The AI model, having been trained on massive volumes of data, generates new content based on the patterns it has learned from the dataset it was trained on. For instance, a chatbot like ChatGPT, which is a language generation model, can create all kinds of texts, from simple sentences to entire articles and essays.

When it comes to image generation, a chatbot like DALL. E, which is a 12-billion parameter version of GPT-3 trained to generate images from text descriptions, can create images from text captions for a wide range of concepts expressible in natural language. It receives both the text and the image as a single stream of data containing up to 1280 tokens and is trained using maximum likelihood to generate all of the tokens, one after another.

Another example is Visual ChatGPT, an AI chatbot that can produce and manipulate images based on user inputs. It combines the power of ChatGPT, a text-based conversational model, with Visual Foundation Models, a set of image processing algorithms.

The development and deployment of generative AI chatbots also present several challenges. One of the primary challenges is the computational resources required to train and run these large language models. Training a large language model requires a significant amount of computational power and storage, making it a resource-intensive process. Similarly, generating responses in real-time requires efficient algorithms and hardware to ensure a smooth user experience.

The underlying technology of generative AI chatbots is often based on large language models trained on vast amounts of text data. Generative Pretrained Transformers (GPT) models leverage machine learning techniques to generate human-like text, making them highly effective for a wide range of applications. These models, such as GPT-3 or GPT-4, learn the statistical patterns of language from the training data and use this knowledge to generate text that is contextually relevant and grammatically correct. Customized GPT models can also be fine-tuned to adhere to specific guidelines or constraints. This ability to generate coherent and contextually appropriate responses is what sets generative AI chatbots apart from their rule-based counterparts.

Such GPT models leverage machine learning techniques to generate human-like text, making them highly effective for a wide range of applications. Unlike rule-based systems, these chatbots can understand, summarize, predict, and generate new content, making the interaction more dynamic and engaging. This advancement has made chatbots more accessible and useful across various domains.

For instance, Google Cloud has leveraged the power of generative AI to enhance their chatbot services. Developers can now build AI-powered chatbots that can accurately answer questions, generate content, create summaries, and perform complex Natural Language Understanding (NLU) processing. While this allows developers to build AI-powered chatbots capable of complex tasks, it also reinforces the dominance of chatbots as the primary interface for interacting with AI systems. This could potentially limit the exploration of other innovative interfaces.

Another notable application of generative AI in chatbots is seen in the company Bestow. They have developed a chatbot that allows employees to interact with documents in a more efficient manner. The user can upload a document and the chatbot, powered by generative AI, enables them to ask any questions related to the document. Bestow's use of a chatbot to enable employees to interact with documents is an example of how the functionality of generative AI is being funneled almost exclusively through chatbots. While this may improve efficiency in some cases, it also risks oversimplifying the interaction and underutilizing the potential of generative AI.

In the healthcare and pharmaceutical industry, generative AI-powered chatbots are being used for continuous surveillance, helping companies stay up-to-date and make quick, informed decisions. As the technology continues to evolve, the possibilities for its application are vast and continue to grow. Still, the near-exclusive use of chatbots could limit the potential applications of generative AI.

Generative Pretrained Transformers (GPT) models leverage machine learning techniques to generate human-like text, making them highly effective for a wide range of applications. However, the use of generic GPT models can sometimes lead to outputs that lack the specificity or personalization required for certain tasks or users. This has led to the development of customized or personalized GPT models tailored to the needs of, e.g., a specific person, business, or governmental department.

Personalized GPT models can be trained on specific datasets to reflect the language style, tone, or subject matter expertise of a particular user or entity. For instance, a personalized GPT model for a legal professional might be trained on legal texts and court rulings, enabling it to generate text that aligns with legal terminology and reasoning. Similarly, a personalized GPT model for a business could be trained on the company's internal documents and communications to reflect its unique brand voice and industry jargon.

Customized GPT models can also be fine-tuned to adhere to specific guidelines or constraints. For example, a governmental department might require a GPT model that strictly complies with certain regulations or policies. By customizing the model's training and generation process, it can be ensured that the generated text meets these requirements.

However, the development of personalized GPT models presents several challenges. Ensuring that the model accurately reflects the desired style or expertise requires careful selection and preparation of the training data. Additionally, maintaining the privacy and security of the training data is paramount, especially when the data includes sensitive or proprietary information.

With the issues of chat and voice, email as a Gen AI interface should be considered as an alternative. Even with the advent of chatting, instant messaging, and social media, email remains popular today due to its versatility, reliability, and widespread acceptance in formal communication, particularly in business and academia. The development of more sophisticated email systems, incorporating advanced features and enhanced security measures, is a testament to the ongoing evolution and enduring popularity of email.

Email, short for electronic mail, has been a cornerstone of digital communication since its inception in the 1970s. Its popularity stems from its universality, simplicity, and efficiency. As a mode of communication, email is platform-independent, allowing users across different systems to communicate seamlessly. It is asynchronous, enabling users to send and receive messages at their convenience, thereby facilitating global communication across different time zones.

Email has become a ubiquitous form of communication, transcending age, physical abilities, and professional boundaries. Its simplicity, accessibility, and efficiency have made it a preferred mode of communication for diverse groups of people, including older adults, individuals with disabilities, and children.

In the business world, email is indispensable. It facilitates internal and external communication, document sharing, and coordination of tasks. Its ability to reach multiple recipients simultaneously makes it ideal for disseminating information to teams or entire organizations. Furthermore, the traceability of email communication aids accountability and record-keeping. Despite the rise of collaborative work platforms, email remains a mainstay in business communication due to its universality, versatility, and the privacy it offers for one-on-one communication.

Email communication, because of its unique convenience and ubiquitousness, has been a constant area of development in security and privacy. As a primary mode of digital communication, both for personal and professional purposes, emails often contain sensitive information that needs to be protected from unauthorized access and misuse.

The simplicity of email lies in its user-friendly interface and straightforward concept: digital letters sent and received from electronic mailboxes. This simplicity has allowed it to be adopted by users ranging from tech-savvy individuals to those with minimal technical knowledge. Furthermore, email provides a written record of communication, making it ideal for professional and formal correspondence where documentation is crucial.

Email communication has evolved significantly with the advent of new technologies and platforms, particularly with the rise of smartphones, web applications, and sophisticated software. These advancements have made email more accessible and convenient, transforming it into a versatile tool for personal and professional communication.

Smartphone apps have revolutionized email use by making it possible to send and receive emails anytime, anywhere. These apps are designed to provide a seamless user experience, with features such as push notifications for new emails, synchronization across multiple devices, and integration with other phone features like contacts and calendars. They also often include security features like encryption and spam filters to protect users' privacy and data.

Web applications for email offer the advantage of accessibility from any device with an internet connection and a web browser. This eliminates the need for software installation and allows users to access their emails from different devices. Web-based email applications often come with a host of features, including robust search capabilities, spam filtering, and integration with other web services. They also allow for real-time collaboration, such as document editing and calendar sharing, making them particularly useful for business and team environments.

Basic software applications for email, also known as email client applications, are programs installed on a computer to manage and send/receive emails. These software applications support multiple email accounts, offer offline access to downloaded emails, and provide advanced features like rules and filters for organizing emails, task management, and more. Email clients can offer more customization options compared to web-based email services, allowing users to tailor their email environment to their specific needs.

Efficiency in email also comes from its ability to handle various types of content—from plain text to multimedia attachments—and its capacity to reach multiple recipients simultaneously through features like CC (Carbon Copy) and BCC (Blind Carbon Copy). Moreover, email's integration with other productivity tools, such as calendar apps for scheduling and task management tools, enhances its utility in both personal and professional settings.

Underlying the operation of email are protocols like Simple Mail Transfer Protocol (SMTP) and Internet Message Access Protocol (IMAP). SMTP is a communication protocol for electronic mail transmission. As an Internet standard, it is used to send email messages from mail clients to mail servers and between mail servers. On the other hand, IMAP is an Internet standard protocol used by email clients to retrieve messages from a mail server. IMAP allows a client email program to access remote message stores as if they were local, enabling users to manage and synchronize their emails across different devices.

Email clients with their intuitive interfaces and user-friendly features—be they on a mobile device, web app, or PC—have significantly improved the accessibility of digital communication for a wide range of users. This includes novice users, older people, children, individuals with disabilities, new job hires, and more.

For novice users, familiar email clients provide an easy entry point into digital communication. The user-friendly design of these clients, coupled with features like auto-complete, spell check, and intuitive organization of emails into folders or labels, makes the process of sending, receiving, and managing emails straightforward and hassle-free.

Older adults, who may not be as comfortable with new technology, also benefit from the simplicity and familiarity of traditional email clients. Features such as adjustable display settings, easy-to-navigate menus, and the ability to work offline make email clients particularly accessible for older users. For older adults, email provides a convenient and familiar way to stay connected with family, friends, and community organizations. It allows them to communicate at their own pace and comfort, overcoming barriers such as physical distance and mobility issues. Moreover, the asynchronous nature of email communication is particularly beneficial for older adults who may prefer to take their time to compose responses.

Children and students represent another group of email users. While they may be more drawn to instant messaging and social media, email provides a platform for formal communication, such as correspondence with teachers or submission of school assignments. Learning to use email from a young age also helps children develop essential digital literacy skills. Other features like include text-to-speech and speech-to-text capabilities, high-contrast themes, and compatibility with assistive technologies. These make email clients more accessible to users with visual impairments, hearing impairments, or motor disabilities.

Individuals with disabilities also benefit significantly from email communication. For those with mobility impairments, email eliminates the physical demands of postal mail. For individuals with hearing impairments, email provides a visual means of communication that can be more accessible than phone calls. Assistive technologies, such as screen readers and voice recognition software, further enhance the accessibility of email for individuals with visual impairments or physical disabilities that affect typing.

For new job hires, familiar email clients can case the transition into a new work environment. Since email is a primary mode of communication in most workplaces, being able to navigate an email client effectively is crucial. Familiar email clients, with their intuitive interfaces and comprehensive features, can help new hires get up to speed quickly, enhancing productivity and communication efficiency.

One of the key aspects of email security is the protection of data in transit. Emails travel over the internet, passing through multiple servers before reaching the recipient. This makes them vulnerable to interception. To mitigate this risk, encryption is commonly used. Encryption transforms the content of the email into an unreadable format, which can only be deciphered using a decryption key.

Another aspect of email security is the authentication of users and servers. Authentication mechanisms, such as passwords, digital signatures, and two-factor authentication, are used to verify the identity of the user. Similarly, protocols like Sender Policy Framework (SPF) and DomainKeys Identified Mail (DKIM) are used to authenticate the servers involved in the email exchange, protecting against phishing attacks and email spoofing.

Privacy in email communication involves protecting the content of the email from being read by anyone other than the intended recipient. This includes protection from automated content analysis used for targeted advertising. Privacy also extends to the metadata associated with the email, such as the subject line, sender and recipient addresses, and time stamps, which can reveal a lot about the sender's activities and relationships.

Email communication, when implemented with robust security protocols, can offer a higher degree of security and privacy compared to entering information directly into an internet webpage, such as interacting with a chatbot. This is due to several reasons.

Email communication can be encrypted both in transit and at rest. Encryption in transit protects the data as it travels over the internet from the sender to the recipient, preventing unauthorized interception. Encryption at rest protects the data stored on the email servers. This dual layer of encryption ensures that the content of the email remains confidential and can only be accessed by the intended recipient.

Email systems often incorporate authentication mechanisms, such as passwords and two-factor authentication, to verify the identity of the user. This prevents unauthorized access to the email account. In contrast, information entered into a webpage can potentially be accessed by anyone who can view the webpage or the server logs.

Email allows for greater control over the data. Users can choose when to send the email, to whom, and what information to include. They can also delete emails from their sent folder or inbox. On a webpage, once the information is entered, users often have little control over who can access the data or how it is used.

In addition to these security measures, these email systems may also include privacy controls that limit who can access certain information and under what circumstances. For example, access controls can prevent unauthorized users from viewing sensitive emails, while audit logs can track who has accessed certain information and when. These controls not only protect sensitive information but also help corporations and government agencies comply with various privacy regulations.

Furthermore, these email systems may use secure email protocols, such as Secure/Multipurpose Internet Mail Extensions (S/MIME) or Pretty Good Privacy (PGP). These protocols provide cryptographic privacy and authentication for data communication, making email communication more secure. Of course, it is important to note that the security of email communication also depends on the user's practices, such as using strong passwords and not opening suspicious emails and/or links.

Some embodiments may use a private email server. A private email server is a server that hosts and manages email accounts and messages for a specific domain or organization. Unlike public email services, such as Gmail or Yahoo, a private email server gives the owner more control over the configuration, security, and privacy of their email communications.

Despite the need for security and privacy, corporations and government agencies may be comfortable with having emails stored and leaving a trail. This is because email trails serve as a record of communication, which can be crucial for accountability, transparency, and legal purposes. For instance, email trails can provide evidence of decisions, actions, and transactions. They can also help resolve disputes, investigate incidents, and ensure compliance with laws and regulations.

Email communication leaves a trail that can be audited for accountability. Each email has a header that contains information about the sender, recipient, and the path the email took through the network. This can be useful for tracking and resolving any security incidents. accessibility and user-friendliness of email clients are of significant value.

Email security and privacy may always remain areas in need for improvement due to the evolving nature of cyber threats. Innovations that enhance the security and privacy of email communication, such as advanced encryption algorithms, robust authentication mechanisms, and privacy-preserving features, have made great strides. These advancements not only protect users' data but also contribute to the trust and reliability of email as a mode of communication, which further solidifies the universal embrace of email for the foreseeable future.

When dealing with sensitive information, the type of email system a corporation or government agency uses is typically designed to balance the need for security and privacy with the benefits of accountability and transparency. While robust security measures and privacy controls are essential for protecting sensitive information, the storage of emails and the existence of an email trail can serve important functions in corporate and government settings. Therefore, innovations that enhance the security, privacy, and functionality of such email systems are of significant value.

Incorporating an email system as an interface for interacting with large language models or other generative AI models presents several advantages, one of which is the inherent requirement of an associated account for each email address. This feature of email systems can contribute significantly to the security, accountability, and personalization of AI model interactions.

The requirement of an associated account enhances the security of interactions with the AI model. Each email account is typically protected by a password or other authentication mechanisms, which helps prevent unauthorized access. This means that only the owner of the email account, who is authenticated, can send prompts to the AI model and receive responses.

The use of email accounts can improve accountability in AI model interactions. Each prompt sent via email is associated with a specific email account, creating a clear record of who made the request. This can be particularly useful in professional or educational settings, where it's important to track the usage of AI resources.

The use of email as an interface for AI model interactions leverages the widespread familiarity and accessibility of email. Most people already have an email account and know how to use it, reducing the barriers to entry for using AI models. Therefore, innovations that integrate email systems with the access mechanisms for generative AI models, leveraging the associated accounts of email addresses, are of significant value.

Incorporating an email system as an interface for interacting with large language models or other generative AI models presents several advantages, one of which is the elimination of the need to download a new application on your phone or computer. This aspect of using email systems can contribute significantly to the accessibility, convenience, and user-friendliness of AI model interactions.

The use of email as an interface reduces the barrier to entry for users. Since most users already have at least one email account and are familiar with how to use it, they can start interacting with the AI model immediately without needing to download, install, or learn how to use a new application. This is particularly beneficial for users who may not be tech-savvy or who may be reluctant to download new applications due to concerns about device storage space or data usage.

Using email allows for platform independence. Users can send prompts to the AI model and receive responses from any device that has an email client, which includes virtually all smartphones, tablets, and computers. This is in contrast to a standalone app, which may only be available on certain platforms or may require a specific operating system version.

Email communication is typically protected by various security measures implemented by the email service provider, such as data encryption and two-factor authentication. This means that users can interact with the AI model securely, without needing to trust or verify the security measures of a new app.

The use of an email system allows for asynchronous communication with the AI model. Users can send a prompt via email and then continue with their other tasks, checking the response from the AI model at their own convenience. This is a natural and familiar workflow for many users, making it an intuitive way to interact with AI models.

The integration of email systems for accessing AI models can offer enhanced accessibility, convenience, and security, making it a valuable feature for user-friendly and secure AI interactions.

Email-based sign-in systems offer a secure and convenient method for accessing services such as AI models. One of the primary advantages is the inherent security provided by email platforms. These platforms typically have robust security measures in place, including password protection, two-factor authentication, and encryption, which help protect against unauthorized access.

Moreover, once you're signed into your email account, you can send requests to the AI model directly via email without needing to sign in each time. This is because your email client (whether it's a web-based client like Gmail or a desktop client like Outlook) typically keeps you signed in until you choose to sign out. This provides a seamless user experience, allowing you to interact with the AI model as easily as sending an email.

In contrast, some platforms like ChatGPT require you to sign in each time you want to make a request. While this might be designed as a security measure, it can be less convenient as it adds an extra step to the process.

Furthermore, using email as the interface for interacting with an AI model also means you can access the model from any device where you can access your email, without needing to install any additional software or apps. This makes it highly accessible for a wide range of users.

Incorporating email sign-in systems for accessing AI models can offer enhanced security, convenience, and accessibility, making it a valuable feature for user-friendly and secure AI interactions.

Incorporating an email system as an interface for interacting with large language models or other generative AI models presents several advantages, one of which is the case of tracking usage. This is particularly beneficial when a credit system is implemented, where each subscriber is allotted a certain number of credits per month.

The use of an email system allows for a straightforward way to track the number of requests made by each user. Each email sent to the AI model can be counted as a credit, allowing the system to keep track of the number of credits used by each subscriber. This can be automated, ensuring accurate and efficient tracking of usage.

The credit system provides a fair and transparent method for allocating resources. Each subscriber is given an equal number of credits at the start of each month, ensuring that all users have equal access to the AI model. Users who wish to make more requests can opt for a premium subscription plan, which provides additional credits.

The credit system can help manage the load on the AI model. By limiting the number of requests that each user can make, the system can prevent overuse and ensure that the AI model is available to all subscribers. This can lead to improved performance and user satisfaction.

The use of an email system for interaction with the AI model means that users do not need to learn a new interface or system. They can send their prompts via email, a tool that most users are already familiar with. This makes the AI model more accessible to a wide range of users, from tech-savvy individuals to those with minimal technical skills.

Incorporating an email system for accessing AI models, coupled with a credit system for tracking usage, can offer enhanced accessibility, fairness, and efficiency. This approach ensures that all subscribers have equal access to the AI model, while also managing the load on the system and providing a familiar and user-friendly interface for interaction.

Incorporating an email system as an interface for interacting with large language models or other generative AI models presents several advantages, one of which is the potential for improving the quality of prompts submitted in a request email. Incorporating an email system for accessing AI models can offer enhanced user experience and prompt quality, making it a valuable feature for user-friendly and effective AI interactions.

Email provides a familiar and user-friendly interface for most users. This familiarity can encourage users to provide more detailed and well-thought-out prompts, as they can compose their prompts in a manner similar to writing an email. This can lead to more precise and meaningful interactions with the AI model.

Email allows for asynchronous communication. Users can take their time to compose their prompts, without feeling the pressure of a real-time interaction. This can result in more carefully crafted prompts, which can lead to better responses from the AI model.

Email clients often include features such as spell check and grammar suggestions, which can help users improve the quality of their prompts. By ensuring that their prompts are well-written and free of errors, users can increase the likelihood of receiving accurate and relevant responses from the AI model.

The use of email can facilitate the tracking and management of prompts. Users can easily keep a record of the prompts they have sent and the responses they have received, which can be useful for refining future prompts. Additionally, users can easily resend previous prompts or use them as templates for new prompts.

The integration of an email system with an AI model can also allow for the implementation of feedback mechanisms. Users can provide feedback on the AI model's responses directly via email, which can be used to continuously improve the model's performance.

The ability to attach images, PDFs, or other files to an email request is a significant advantage of using an email system as an interface for interacting with large language models or other generative AI models. This feature expands the range of prompts that users can submit and enhances the versatility of the AI model.

For instance, a user could attach an image to their email and ask the AI model to generate a description of the image, identify objects in the image, or even create a story based on the image. Similarly, a user could attach a PDF document and ask the AI model to summarize the document, translate it into another language, or extract specific information from it.

This feature also allows for more complex and creative interactions with the AI model. For example, a user could attach a piece of code and ask the AI model to explain what the code does, suggest improvements, or generate similar code for a different use case. Alternatively, a user could attach a music file and ask the AI model to generate lyrics that fit the melody.

Furthermore, the ability to attach files to email requests can be particularly useful in professional or educational settings. For instance, students could attach their essays and ask the AI model for feedback or suggestions for improvement. Similarly, professionals could attach business reports and ask the AI model to generate an executive summary or identify key insights.

The ability to attach files to email requests significantly enhances the functionality and user-friendliness of AI models, making them more accessible and useful to a wide range of users.

Incorporating an email system as an interface for interacting with large language models or other generative AI models presents several advantages, particularly for older users. One such advantage is the ability to forward emails to the AI model and ask it to generate a reply or verify if the email is spam.

The forwarding feature of email clients is a familiar function for most users, including older individuals. This familiarity can make it easier for them to interact with the AI model, as they can use the same process they would use to forward an email to a human recipient. By asking the AI model to generate a reply, older users can get assistance with crafting responses to emails. This can be particularly helpful for those who may struggle with typing or coming up with a response due to cognitive or physical challenges. The AI model can generate a draft reply, which the user can then review, edit if necessary, and send.

The ability to ask the AI model to verify if an email is spam can provide an additional layer of security for older users, who are often targets of phishing and other types of email scams. The AI model can analyze the content of the forwarded email and provide an assessment of its likelihood of being spam.

Using email as the interface for the AI model means that users do not need to download or learn how to use a new app or platform. This can lower the barrier to entry for older users, who may be less comfortable with learning new technologies. Incorporating an email system for accessing AI models can offer enhanced accessibility, convenience, and security for older users, making it a valuable feature for user-friendly and secure AI interactions.

A system should be accessible to users, regardless of their technical expertise. This means having an intuitive interface and being able to process requests in commonly used formats, such as emails. While generative AI, including large language models, may offer exciting possibilities, it's essential to address these challenges to harness their full potential effectively and responsibly.

The association of prompts with specific email accounts allows for personalized interactions with the AI model. The AI model may learn from the prompts sent from a specific email account over time, enabling it to tailor its responses to the preferences or needs of the user associated with that account.

The system and method of the present disclosure may provide a convenient way for users to request and receive content generation via email. The system and method also provide a secure, scalable, and efficient solution for content generation using generative AI models. In some embodiments, a security module ensures that only authorized and legitimate users can access the system and request content generation.

Some embodiments of the present disclosure may include a method for processing request emails using an AI model, including receiving a request email from a sender. Some embodiments may also include identifying the sender of the request email. Some embodiments may also include determining whether the sender may be an authenticated user.

Some embodiments may also include, if the sender may be not an authenticated user, generating a reply email inviting the sender to sign up. Some embodiments may also include, if the sender may be an authenticated user, determining a prompt from the request email and inputting the prompt into the AI model. Some embodiments may also include receiving an output from the AI model based on the prompt. Some embodiments may also include generating a reply email based on the output. Some embodiments may also include transmitting the reply email to the sender.

Some embodiments of the present disclosure may also include a method for processing and responding to a request email, including the steps of receiving a request email. Some embodiments may also include identifying a sender of the request email. Some embodiments may also include determining whether the sender has a subscription.

Some embodiments may also include, if the sender has a subscription generating a reply email based on the request email. Some embodiments may also include transmitting the reply email to the sender. Some embodiments may also include, if the sender does not have a subscription creating a new subscriber profile for the sender.

Some embodiments may also include initializing credits for the subscriber profile. Some embodiments may also include preparing a new subscriber form for the sender. Some embodiments may also include generating a new subscriber email with a link to the new subscriber form. Some embodiments may also include transmitting the new subscriber email to the sender.

Some embodiments of the present disclosure may also include a method for processing a request email and generating a reply, including the steps of receiving and processing a request email. Some embodiments may also include determining an email addressce, a subject, and a body of the request email. Some embodiments may also include checking for a prompt in the body of the request email.

Some embodiments may also include, if no prompt may be found, generating a status or help email and transmitting the status or help email to the email addressec. Some embodiments may also include, if a prompt may be found, checking for additional data in the body of the request email. Some embodiments may also include, if additional data may be present, inputting the prompt and the additional data into an AI model.

Some embodiments may also include, if no additional data may be present, inputting only the prompt into the AI model. Some embodiments may also include receiving an output from the AI model. Some embodiments may also include generating a reply email based on the output. Some embodiments may also include transmitting the reply email to the email addressec.

Some embodiments of the present disclosure may also include a method for processing and responding to a request email, including the steps of receiving a request email. Some embodiments may also include identifying a sender of the request email. Some embodiments may also include determining whether the sender has sufficient credits.

Some embodiments may also include, if the sender does not have sufficient credits generating a reply email notifying of insufficient credits. Some embodiments may also include transmitting the reply email to the sender. Some embodiments may also include, if the sender has sufficient credits determining a prompt from the request email.

Some embodiments may also include inputting the prompt into an AI model. Some embodiments may also include receiving an output from the AI model. Some embodiments may also include generating a reply email based on the output. Some embodiments may also include transmitting the reply email to the sender.

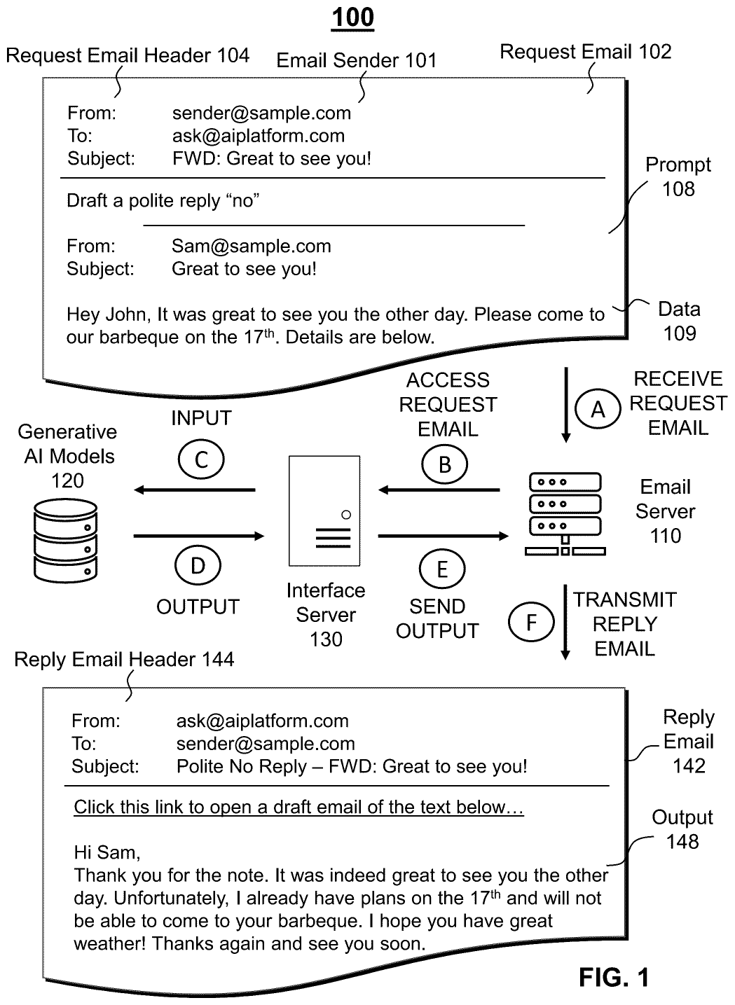

FIG. 1 depicts an illustrative flow diagram for an interface processing request emails using a Gen AI platform, in accordance with some embodiments of this disclosure. Scenario 100 of FIG. 1 depicts several steps (A-F) of a data flow for a Generative AI via Email Interface to process a request email for input of a prompt to one or more generative AI models for generation of an email reply to be sent back to the email sender. For instance, a subscriber to the Generative AI via Email platform may forward an email from a friend with instructions to an LLM to draft a polite declination of an invitation in the forwarded email. The subscriber may receive an email from the Generative AI via Email platform with a draft email response suitable for the subscriber to send to the friend.

As shown in FIG. 1, Scenario 100 includes Email Server 110, Interface Server 130, and Generative AI Model(s) 120. Email Server 110 is a system that manages and facilitates email communications between various entities, such as Email Sender 101 and the Generative AI via Email platform. Email server 110 may be any suitable type of email server, such as a Simple Mail Transfer Protocol (SMTP) server, an Internet Message Access Protocol (IMAP) server, a Post Office Protocol (POP) server, or a combination thereof. Scenario 100 of FIG. 1 depicts Request Email 102, from Email Sender 101, with a Request Email Header 104, Prompt 108, and Data 109.

Interface Server 130 may be configured to communicate with Email Server 110, Generative AI Model(s) 120, and the other modules of the system. Interface Server 130 acts as an intermediary between Email Server 110 and Generative AI Model(s) 120, enabling the exchange of data and commands between them. Interface Server 130 accesses the email(s) sent by the email sender to access a request email, which is the email that contains the prompt(s). In some embodiments, Interface Server 130 may also prepare and/or send the reply email, which is an email that comprises the AI-generated content. In some embodiments, Interface Server 130 may be configured to extract the prompts from the request email and parse them into structured and standardized formats. In some embodiments, Interface Server 130 may include an NLP module. In some embodiments, Interface Server 130 may use prompt extractor(s) modules to, e.g., extract one or more prompts and/or also perform preprocessing tasks such as removing noise, correcting spelling and grammar errors, and/or validating the prompts.

Generative AI Model(s) 120 is a system that comprises one or more artificial intelligence models capable of generating human-like text based on given prompts. Generative AI Models 120 may be configured to generate content based on the prompts using one or more artificial intelligence models. Generative AI Models 120 may use different models for different types of content, such as natural language, code, images, music, etc. Generative AI Models 120 may also use feedback mechanisms to improve the quality and relevance of the generated content.

Scenario 100 of FIG. 1 depicts a request email 102, from email sender 101, with a request email header 104, a prompt 108, and a data 109. Request email 102 is an email message that contains a request for generating a response using the generative AI via email platform. Request email 102 may be composed and sent by email sender 101 using any suitable email client, such as a web-based email client, a desktop email client, a mobile email client, or a combination thereof. Request email header 104 contains essential information for delivering and identifying request email 102, such as the sender's and recipient's email addresses, the subject of the email, the date and time of the email, and other metadata. In some embodiments, request email header 104 may also include one or more parameters for specifying the desired characteristics of the response, such as the tone, style, length, format, language, or other attributes.

In Step A, Email Server 110 receives Request Email 102 from Email Sender 101. Request Email 102 is an email message that contains a request to generate a reply email using the Generative AI via Email platform. Request Email 102 comprises Request Email Header 104, Prompt 108, and Data 109. Request Email Header 104 includes information such as the sender's email address, the recipient's email address, and the subject line of the email. Prompt 108 is a specific instruction within Request Email 102 that specifies the desired content and tone of the reply email. Data 109 is any additional information or content within Request Email 102 that may be relevant or useful for generating the reply email.

Prompt 108 is a text segment that provides instructions for generating a response using the generative AI via email platform. Prompt 108 may be written by email sender 101 or automatically generated by the email client based on the context of request email 102. Prompt 108 may include one or more keywords, phrases, sentences, questions, or other textual elements that indicate the purpose, topic, content, or structure of the response. In some embodiments, prompt 108 may also include one or more variables, placeholders, or tags that represent the dynamic or customizable parts of the response, such as the name, date, location, or other information. In the example of FIG. 1, prompt 108 is “Draft a polite reply ‘no”, which instructs the generative AI via email platform to generate a response that politely declines an invitation contained in data 109.

Data 109 is a text segment that provides additional information for generating a response using the generative AI via email platform. Data 109 may be written by email sender 101 or automatically extracted from request email 102 or other sources, such as the email sender's profile, contacts, calendar, or other applications. Data 109 may include one or more textual elements that are relevant, useful, or necessary for generating a response, such as the original email, the forwarded email, the attachment, the link, the reference, the context, the background, or other information. In some embodiments, data 109 may also include one or more images, videos, audio files, or other multimedia elements that can be processed by the generative AI via email platform. In the example of FIG. 1, data 109 is a forwarded email from Sam@sample.com inviting John to a barbeque on the 17th. Email server 110 receives request email 102 from email sender 101 via a network connection.

In Step B, Interface Server 130 accesses Request Email 102 stored in Email Server 110. Interface Server 130 may use various methods and protocols to access Request Email 102, such as web services, application programming interfaces (APIs), or secure sockets layer (SSL) encryption. Interface Server 130 may also perform authentication and authorization checks to ensure that the request is valid and authorized. Email server 110 then forwards request email 102 to interface server 130 via a network connection. Interface server 130 is a system that acts as an intermediary between email server 110 and generative AI models 120. In some embodiments, Interface server 130 may perform various functions, such as validating, parsing, formatting, routing, or processing request email 102 and the corresponding response. Interface server 130 may be implemented as a web server, an application server, a cloud server, or a combination thereof.

In Step C, Interface Server 130 extracts Prompt 108 from Request Email 102 and inputs it into Generative AI Model(s) 120. Interface Server 130 may also provide Data 109 or any other relevant information to Generative AI Model(s) 120 as additional input or context. Generative AI Model(s) 120 processes Prompt 108 using one or more artificial intelligence techniques, such as natural language processing (NLP), natural language generation (NLG), deep learning, or neural networks. In some embodiments, Interface Server 130 selects one or more Generative AI Model(s) 120 that are appropriate based on determining prompt 108.

In some embodiments, Interface server 130 extracts prompt 108 and data 109 from request email 102 and sends them as input (at Step C) to one or more generative AI models 120. In some embodiments, Generative AI models 120 are systems that use artificial intelligence techniques, such as natural language processing, natural language generation, machine learning, deep learning, or other methods, to generate a response based on the input. In some embodiments, Generative AI models 120 may be implemented as neural networks, transformers, recurrent neural networks, convolutional neural networks, generative adversarial networks, or other architectures. In some embodiments, Generative AI models 120 may be trained, fine-tuned, or updated using various datasets, such as text corpora, email archives, user feedback, or other sources. In some embodiments, Generative AI models 120 may be public AI models, proprietary AI models, personalized AI models, or a combination thereof.

In Step D, Generative AI Model(s) 120 produces Output 148, which is a text that represents a suitable reply email based on Prompt 108 and any other input or context provided by Interface Server 130. Output 148 is received by Interface Server 130, which may perform further processing or formatting on it, such as spell-checking, grammar-checking, or adding salutations or signatures.

In Step E, Interface Server 130 sends Output 148 as Reply Email 142 via Email Server 110. Reply Email 142 is an email message that contains the generated reply email based on Request Email 102. Reply Email 142 may include information such as the sender's email address, the recipient's email address, the subject line of the email, and the body of the email. Interface Server 130 may also attach or include any other information or content that may be relevant or useful for the recipient of Reply Email 142, such as attachments, links, or references. In some embodiments, Generative AI models 120 process prompt 108 and/or data 109 internally (at Step C) and generate output 148 (at Step D).

In scenario 100, output 148 is a text segment that contains the generated response using the generative AI via email platform. In some embodiments, the output 148 may follow the instructions, parameters, variables, placeholders, or tags specified in prompt 108. In some embodiments, the output 148 may also incorporate, modify, or summarize the information provided in data 109. In some embodiments, the output 148 may be formatted, structured, or organized according to the desired characteristics of the response, such as the tone, style, length, format, language, or other attributes. In some embodiments, output 148 may also include one or more images, videos, audio files, or other multimedia elements that are generated or selected by the generative AI via email platform. In the example of FIG. 1, output 148 is a polite reply that declines the invitation from Sam@sample.com.

Generative AI models 120 send output (at Step E) to interface server 130, which processes output 148 and converts it into a reply email 142. Reply email 142 is an email message that contains the generated response using the generative AI via email platform. Reply email 142 includes a reply email header 144 and an output 148. Reply email header 144 contains essential information for delivering and identifying reply email 142, such as the sender's and recipient's email addresses, the subject of the email, the date and time of the email, and other metadata. In some embodiments, reply email header 144 may also include one or more indicators, labels, or tags that identify reply email 142 as a generated response using the generative AI via email platform, such as a prefix, a suffix, a logo, a watermark, or a disclaimer. In the example of FIG. 1, reply email header 144 includes a subject line that indicates “Polite No Reply—FWD: Great to see you!”.

Output 148 of reply email 142 is a text segment that contains the generated response using the generative AI via email platform. Output 148 may be identical or similar to output generated by generative AI models 120 (at Step D), or may be further modified, edited, or enhanced by interface server 130. Output 148 may also include one or more links, buttons, or other interactive elements that allow email sender 101 to access, view, edit, or send reply email 142 using the email client. In some embodiments, output 148 may also include one or more images, videos, audio files, or other multimedia elements that are generated or selected by the generative AI via email platform. In the example of FIG. 1, output 148 includes a link that allows email sender 101 to open a draft email of the text below, which is a polite reply that declines the invitation from Sam@sample.com. Interface server 130 sends reply email 142 to email server 110 via another network connection at Step E.

At Step F, Email Server 110 transmits Reply Email 142 to Email Sender 101. Email Server 110 may use various methods and protocols to transmit Reply Email 142, such as simple mail transfer protocol (SMTP), internet message access protocol (IMAP), or post office protocol (POP). Email server 110 then delivers reply email 142 to email sender 101 via another network connection at Step F. Email sender 101 receives reply email 142 and can review, edit, or send it to the intended recipient using the email client. Alternatively, email sender 101 can request another response using the generative AI via email platform by sending another request email 102 with a different prompt 108 or data 109.

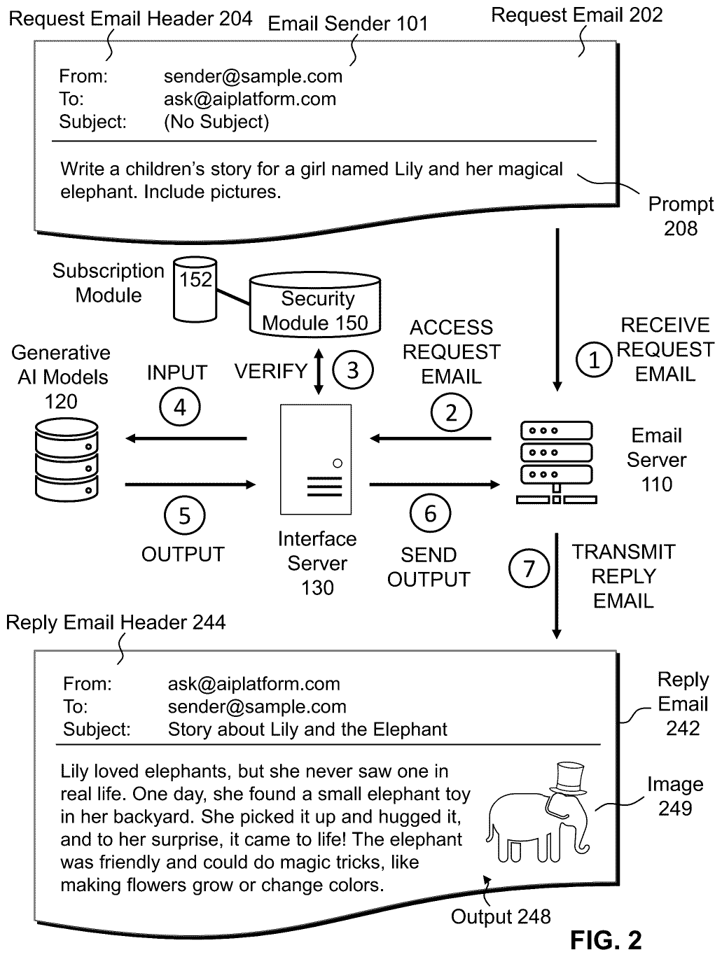

FIG. 2 depicts an illustrative flow diagram for an interface verifying and processing request emails using a Gen AI platform, in accordance with some embodiments of this disclosure. This sequence represents a robust and secure method for processing user requests via email, incorporating advanced AI models, and ensuring the integrity and efficiency of the process. For instance, FIG. 2 depicts a schematic diagram illustrating an exemplary scenario 200 of using a generative AI via email platform to create a children's story, according to some embodiments of the present disclosure. The flow diagram in FIG. 2 illustrates an exemplary process involving several components, such as Email Server 110, Generative AI Models 120, Interface Server 130, Security Module 150, and Subscription Module 152. Scenario 200 of FIG. 2 also depicts Request Email 202, from Email Sender 101, with a Request Email Header 204, Prompt 208, and Data 209.

Scenario 200 of FIG. 2 depicts a request email 202, from email sender 101, with a request email header 204 and a prompt 208. Request email 202 is an email message that contains a request for creating a children's story using the generative AI via email platform. Request email 202 may be composed and sent by email sender 101 using any suitable email client, such as a web-based email client, a desktop email client, a mobile email client, or a combination thereof. Request email header 204 contains essential information for delivering and identifying request email 202, such as the sender's and recipient's email addresses, the subject of the email, the date and time of the email, and other metadata. In some embodiments, request email header 204 may also include one or more parameters for specifying the desired characteristics of the story, such as the genre, theme, length, format, language, or other attributes.

In some embodiments, Security Module 150 may be configured to verify the identity and authenticity of the email sender. In some embodiments, Security Module 150 performs authentication procedures such as checking the email address, password, and/or other credentials of the email sender. In some embodiments, Security Module 150 ensures that only authorized and legitimate users can access the system and request content generation.

Subscription Module 152 may be configured to check the subscription status and credit balance of the email sender. In some embodiments, Subscription Module 152 determines whether the email sender has a valid and active subscription to the system and whether the email sender has sufficient credits to request content generation. In some embodiments, Subscription Module 152 may also deduct credits from the email sender's account based on the number and complexity of the prompts.

At Step 1 of Scenario 200, Email Server 110 receives Request Email 202 from Email Sender 101. Request Email 202 is an email message that contains a request to generate a reply email using the Generative AI via Email platform. Request Email 202 comprises Request Email Header 204, Prompt 208, and Data 209. Request Email Header 204 includes information such as the sender's email address, the recipient's email address, and the subject line of the email.

Prompt 208 is a specific instruction within Request Email 202 that specifies the desired content and tone of the reply email. Prompt 208 is a text segment that provides instructions for creating a children's story using the generative AI via email platform. Prompt 208 may be written by email sender 101 or automatically generated by the email client based on the context of request email 202. Prompt 208 may include one or more keywords, phrases, sentences, questions, or other textual elements that indicate the purpose, topic, content, or structure of the story. In some embodiments, prompt 208 may also include one or more variables, placeholders, or tags that represent the dynamic or customizable parts of the story, such as the name, age, gender, appearance, personality, or other traits of the characters, the setting, the plot, the conflict, the resolution, or other elements.

In the example of FIG. 2, prompt 208 is “Write a children's story for a girl named Lily and her magical elephant. Include pictures,” which instructs the generative AI via email platform to create a story that features a girl named Lily and her magical elephant as the main characters, and to include one or more pictures that illustrate the story. Some embodiments may include additional data (e.g., data 109) with any additional information or content within Request Email 202 that may be relevant or useful for generating the reply email.

Email server 110 receives request email 202 from email sender 101 via a network connection, e.g., at Step 1. Email server 110 then forwards request email 202 to interface server 130 via another network connection, e.g., at Step 2. Interface server 130 is a system that acts as an intermediary between email server 110 and generative AI models 120. In some embodiments, Interface server 130 may perform various functions, such as validating, parsing, formatting, routing, or processing request email 202 and the corresponding response. Interface server 130 may be implemented as a web server, an application server, a cloud server, or a combination thereof.

At Step 2 of scenario 200, Interface Server 130 accesses Request Email 202 stored in Email Server 110. Interface Server 130 may use various methods and protocols to access Request Email 202, such as web services, application programming interfaces (APIs), or secure sockets layer (SSL) encryption. Interface Server 130 may also perform authentication and authorization checks to ensure that the request is valid and authorized.

At Step 3 of Scenario 200, Interface Server 130 verifies Request Email 202 with Security Module 150 and/or Subscription Module 152. Security Module 150 may perform authentication procedures, such as checking the email address, password, and/or other credentials of the Email Sender 101, to verify the identity and authenticity of the user. Subscription Module 152 may check the subscription status and credit balance of the Email Sender 101, to ensure that the user has an active subscription and sufficient credits to request content generation, and to deduct credits based on the prompt complexity. If the verification is successful, Interface Server 130 proceeds to the next step. If the verification fails, Interface Server 130 may send an error message or a notification to the Email Sender 101, informing them of the reason for the failure and the possible actions to resolve it.

At Step 4 of Scenario 200, Interface Server 130 extracts Prompt 208 from Request Email 202 and inputs it into Generative AI Model(s) 120. Interface Server 130 may also provide any other relevant information to Generative AI Model(s) 120 as additional input or context. Generative AI Model(s) 120 processes Prompt 208 using one or more artificial intelligence techniques, such as natural language processing (NLP), natural language generation (NLG), deep learning, or neural networks. For instance, in scenario 200, Generative AI models 120 are systems that use artificial intelligence techniques, such as natural language processing, natural language generation, machine learning, deep learning, or other methods, to create a children's story based on the input. In some embodiments, Generative AI models 120 may be implemented as neural networks, transformers, recurrent neural networks, convolutional neural networks, generative adversarial networks, or other architectures. In some embodiments, Generative AI models 120 may be trained, fine-tuned, or updated using various datasets, such as text corpora, story archives, user feedback, or other sources. In scenario 200, Generative AI Model(s) 120 may also include an image generator to e.g., generate image 249. In some embodiments, Generative AI Model(s) 120 may be open-source, proprietary, and/or personalized generative AI model. For instance, verification by Security Module 150 may allow access to a proprietary model (e.g., for premium users) and enable a public model for non-verified users. In some embodiments, verification by Security Module 150 may allow access to an enterprise model for a specific group of users (e.g., with one domain or company) and enable a different private model for another group of verified users (e.g., a lower tier subscription). In some embodiments, Generative AI Model(s) 120 may be re-trained and/or fine-tuned to create content that simulates a person and/or group.

In some embodiments, output 248 may also include one or more images, videos, audio files, or other multimedia elements that are generated or selected by the generative AI via email platform to illustrate the story. Output 248 may also include one or more links, buttons, or other interactive elements that allow email sender 101 to access, view, edit, or send reply email 242 using the email client. In the example of FIG. 2, output 248 includes image 249 of an elephant with a top hat to accompany the children's story for a girl named Lily and her magical elephant in output 248.

At Step 5 of scenario 200, Generative AI Model(s) 120 produces Output 248, which is a text that represents a suitable reply email based on Prompt 208 and any other input or context provided by Interface Server 130. Output 248 may be identical or similar to the output at Step 5 created by generative AI models 120, or may be further modified, edited, or enhanced by interface server 130. Output 248 is received by Interface Server 130, which may perform further processing or formatting on it, such as spell-checking, grammar-checking, or adding salutations or signatures. In scenario 200, Generative AI models 120 process the input (at Step 4) internally and generate output 248 (at Step 5) based on the prompt 208.

In scenario 200, Output 248 is a multimedia output comprising a text segment that with a created children's story using a language generative AI platform and an image (249) of an elephant in a top hat created using an image generative AI. Output 248 may follow the instructions, parameters, variables, placeholders, or tags specified in prompt 208. Output (E) may also incorporate, modify, or summarize the information provided by the generative AI via email platform. Output 248 may be formatted, structured, or organized according to the desired characteristics of the story, such as the genre, theme, length, format, language, or other attributes. In some embodiments, output 248 may also include one or more images, videos, audio files, or other multimedia elements that are generated or selected by the generative AI via email platform to illustrate the story. In the example of FIG. 2, output 148 is a children's story for a girl named Lily and her magical elephant, with pictures, e.g., image 249.

At Step 6 of Scenario 200, Interface Server 130 sends Output 248 as Reply Email 242 via Email Server 110. For instance, Interface server 130 sends reply email 242 to email server 110 via network connection. Reply Email Header 244 is a header for Reply Email 242, an email message that contains the generated reply email based on Request Email 202. Reply Email Header 244 may include information such as the sender's email address, the recipient's email address, the subject line of the email, and the body of the email. In scenario 200, the subject line is “Story about Lily and the Elephant.” In some embodiments, Interface Server 130 may also attach or include any other information or content that may be relevant or useful for the recipient of Reply Email 242, such as attachments, links, or references.

At Step 7 of Scenario 200, Email Server 110 transmits Reply Email 242 to Email Sender 101. Email Server 110 may use various methods and protocols to transmit Reply Email 242, such as simple mail transfer protocol (SMTP), internet message access protocol (IMAP), or post office protocol (POP). In some embodiments, Email Sender 101 receives Reply Email 242 and may review, edit, or send it to the intended recipient. In some embodiments, email sender 101 can request another story using the generative AI via email platform by sending another request email 202 with a different prompt 208.

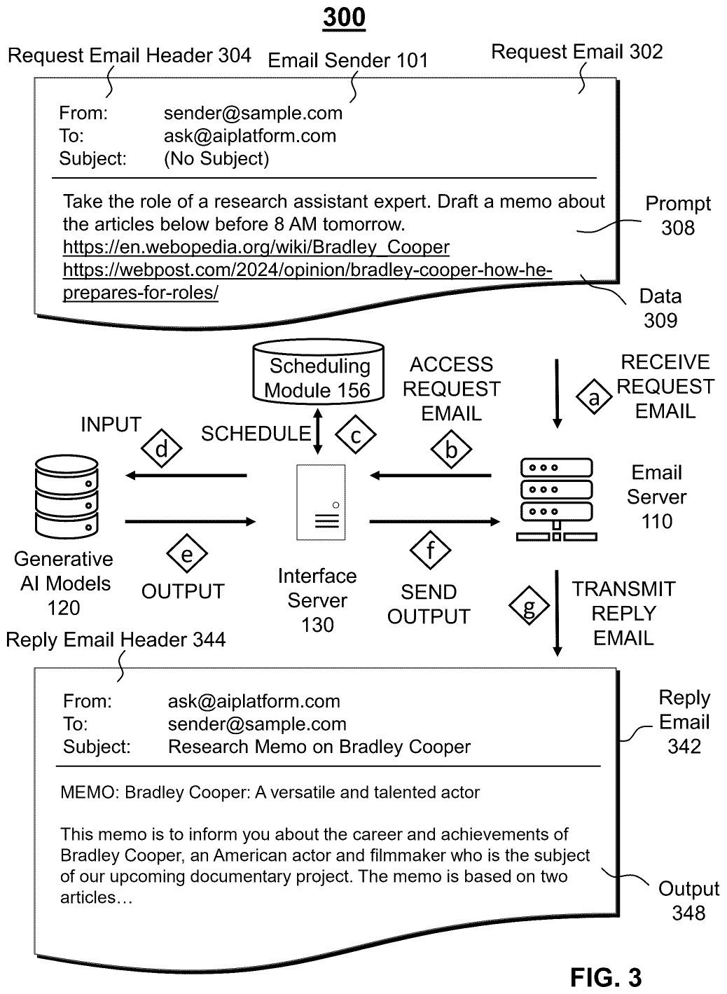

FIG. 3 depicts an illustrative flow diagram for an interface scheduling and processing request emails using a Gen AI platform, in accordance with some embodiments of this disclosure. For instance, FIG. 3 depicts a schematic diagram illustrating an exemplary scenario 300 of using a generative AI via email platform to draft a research memo, according to some embodiments of the present disclosure. The flow diagram in FIG. 3 illustrates a process involving several components: Email Server 110, Generative AI Models 120, Interface Server 130, and Scheduling Module 156. Scenario 300 of FIG. 3 also depicts Request Email 302, from Email Sender 101, with a Request Email Header 304, Prompt 308, and Data 309.

As shown in FIG. 3, Scenario 300 includes Email Server 110, Interface Server 130, Scheduling Module 156, and Generative AI Model(s) 120. Email Server 110 is a system that manages and facilitates email communications between various entities, such as Email Sender 101 and the Generative AI via Email platform. Interface Server 130 is a system that acts as an intermediary between Email Server 110 and Generative AI Model(s) 120, enabling the exchange of data and commands between them.

Scheduling Module 156 is a system that schedules the input of the prompts to Generative AI Model(s) 120 based on the priority, urgency, and/or difficulty of the prompts. In some embodiments, Scheduling Module 156 may also optimize the resource allocation and utilization of Generative AI Model(s) 120. Generative AI Model(s) 120 is a system that comprises one or more artificial intelligence models capable of generating human-like text based on given prompts.

Request email 302 is an email message that contains a request for drafting a research memo using the generative AI via email platform. Request email 302 may be composed and sent by email sender 101 using any suitable email client, such as a web-based email client, a desktop email client, a mobile email client, or a combination thereof. Request email header 304 contains essential information for delivering and identifying request email 302, such as the sender's and recipient's email addresses, the subject of the email, the date and time of the email, and other metadata. In some embodiments, request email header 304 may also include one or more parameters for specifying the desired characteristics of the memo, such as the topic, scope, length, format, language, or other attributes.

Prompt 308 is a text segment that provides instructions for drafting a research memo using the generative AI via email platform. Prompt 308 may be written by email sender 101 or automatically generated by the email client based on the context of request email 302. Prompt 308 may include one or more keywords, phrases, sentences, questions, or other textual elements that indicate the purpose, topic, content, or structure of the memo. In some embodiments, prompt 308 may also include one or more variables, placeholders, or tags that represent the dynamic or customizable parts of the memo, such as the name, date, title, citation, or other information. In the example of FIG. 3, prompt 308 is “Take the role of a research assistant expert. Draft a memo about the articles below before 8 AM tomorrow.”, which instructs the generative AI via email platform to draft a memo that summarizes and analyzes two articles about Bradley Cooper before a specified deadline.

Data 309 is a text segment (e.g., HTML hyperlink) that provides additional information for drafting a research memo using the generative AI via email platform. In some embodiments, data 309 may be written by email sender 101 or automatically extracted from request email 302 or other sources, such as the email sender's profile, contacts, calendar, or other applications. In some embodiments, Data 309 may include one or more textual elements that are relevant, useful, or necessary for drafting a memo, such as the links, titles, authors, abstracts, or summaries of the articles, the context, the background, or other information. In some embodiments, data 309 may also include one or more images, videos, audio files, or other multimedia elements that can be processed by the generative AI via email platform. In the example of FIG. 3, data 309 is two links to articles about Bradley Cooper.

In Step (a) of Scenario 300, Email Server 110 receives Request Email 302 from Email Sender 101. Request Email 302 is an email message that contains a request to generate a reply email using the Generative AI via Email platform. Request Email 302 comprises Request Email Header 304, Prompt 308, and Data 309. Request Email Header 304 includes information such as the sender's email address, the recipient's email address, and the subject line of the email. Prompt 308 is a specific instruction within Request Email 302 that specifies the desired content and tone of the reply email. Data 309 is any additional information or content within Request Email 302 that may be relevant or useful for generating the reply email. Interface server 130 is a system that acts as an intermediary between email server 110 and generative AI models 120. Interface server 130 may perform various functions, such as validating, parsing, formatting, routing, or processing request email 302 and the corresponding response. Interface server 130 may be implemented as a web server, an application server, a cloud server, or a combination thereof. In some embodiments, Email server 110 receives request email 302 from email sender 101 via a network connection. Email server 110 then forwards request email 302 to interface server 130 via another network connection.

At Step (b) of Scenario 300, Interface Server 130 accesses Request Email 302 stored in Email Server 110. Interface Server 130 may use various methods and protocols to access Request Email 302, such as web services, application programming interfaces (APIs), or secure sockets layer (SSL) encryption. In some embodiments, Interface Server 130 may also perform authentication and/or authorization checks to ensure that the request is valid and authorized.

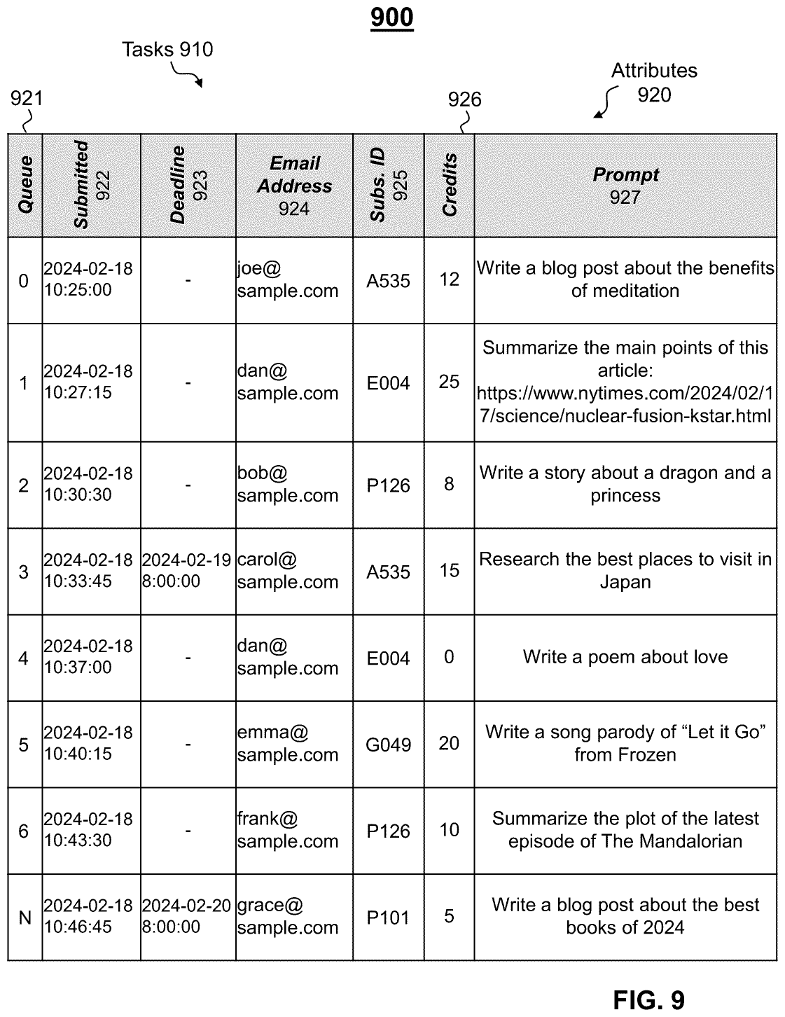

At Step (c) of Scenario 300, Interface Server 130 coordinates with Scheduling Module 156 to schedule the input of Prompt 308 to Generative AI Model(s) 120. Scheduling Module 156 may use various criteria and algorithms to determine the order and priority of processing different prompts, such as the urgency, complexity, length, or type of the prompts. Scheduling Module 156 may also optimize the resource allocation and utilization of Generative AI Model(s) 120, such as by balancing the workload, minimizing the latency, or maximizing the throughput of the AI models. In some embodiments, Scheduling Module 156, at Step (c) of Scenario 300, may create a queue like, e.g., exemplary queue system 900 of FIG. 9.

At Step (d) of Scenario 300, Interface Server 130 inputs Prompt 308 from Request Email 302 into Generative AI Model(s) 120. For example, Interface server 130 may extract prompt 308 and data 309 from request email 302 and send them as input to one or more generative AI models 120. Interface Server 130 may also provide Data 309 or any other relevant information to Generative AI Model(s) 120 as additional input or context. Generative AI Model(s) 120 processes Prompt 308 using one or more artificial intelligence techniques, such as natural language processing (NLP), natural language generation (NLG), deep learning, or neural networks. In some embodiments, Generative AI models 120 are systems that use artificial intelligence techniques, such as natural language processing, natural language generation, machine learning, deep learning, or other methods, to draft a research memo based on the input.

Generative AI models 120 may be implemented as neural networks, transformers, recurrent neural networks, convolutional neural networks, generative adversarial networks, or other architectures. Generative AI models 120 may be trained, fine-tuned, or updated using various datasets, such as text corpora, memo archives, user feedback, or other sources.

At Step (e) of Scenario 300, Generative AI Model(s) 120 produces Output 348, which is a text that represents a suitable reply email based on Prompt 308 and any other input or context provided by Interface Server 130. For instance, Generative AI models 120 process the input internally and generate output 348 based on the prompt 308 and data 309. In scenario 300, Output 348 is a text segment that contains the drafted research memo using the generative AI via email platform. Output 348 may follow the instructions, parameters, variables, placeholders, or tags specified in prompt 308. Output 348 may also incorporate, modify, or summarize the information provided in data 309. Output 348 may be formatted, structured, or organized according to the desired characteristics of the memo, such as the topic, scope, length, format, language, or other attributes. In some embodiments, output 348 may also include one or more images, videos, audio files, or other multimedia elements that are generated or selected by the generative AI via email platform to support the memo.

In the example of FIG. 3, output 348 is a research memo that summarizes and analyzes two articles about Bradley Cooper. In some embodiments, Output 348 is received by Interface Server 130, which may perform further processing or formatting on it, such as spell-checking, grammar-checking, or adding salutations or signatures.

At Step (f) of Scenario 300, Interface Server 130 sends Output 348 as Reply Email 342 via Email Server 110. For instance, Generative AI models 120 send output 348 to interface server 130, which processes output 348 and converts it into a reply email 342. Reply Email 342 is an email message that contains the generated reply email based on Request Email 302. In scenario 300, Reply email 342 is an email message that contains the drafted research memo using the generative AI via email platform. Reply email 342 includes a reply email header 344 and an output 348. Reply email header 344 contains essential information for delivering and identifying reply email 342, such as the sender's and recipient's email addresses, the subject of the email, the date and time of the email, and other metadata.

In some embodiments, reply email header 344 may also include one or more indicators, labels, or tags that identify reply email 342 as a drafted memo using the generative AI via email platform, such as a prefix, a suffix, a logo, a watermark, or a disclaimer. In the example of FIG. 3, reply email header 344 includes a subject line that indicates “Research Memo on Bradley Cooper.” Reply Email 342 may include information such as the sender's email address, the recipient's email address, the subject line of the email, and the body of the email. Interface Server 130 may also attach or include any other information or content that may be relevant or useful for the recipient of Reply Email 342, such as attachments, links, or references. In Step (g) of Scenario 300, Email Server 110 transmits Reply Email 342 to Email Sender 101.

For instance, output 348 of reply email 342 is a text segment that contains the drafted research memo using the generative AI via email platform. Output 348 may be identical or similar to output (E) drafted by generative AI models 120, or may be further modified, edited, or enhanced by interface server 130. Output 348 may also include one or more links, buttons, or other interactive elements that allow email sender 101 to access, view, edit, or send reply email 342 using the email client. In some embodiments, output 348 may also include one or more images, videos, audio files, or other multimedia elements that are generated or selected by the generative AI via email platform to support the memo. In the example of FIG. 3, output 348 includes a research memo that summarizes and analyzes two articles about Bradley Cooper. Email Server 110 may use various methods and protocols to transmit Reply Email 342, such as simple mail transfer protocol (SMTP), internet message access protocol (IMAP), or post office protocol (POP). Email Sender 101 receives Reply Email 342 and may review, edit, or send it to the intended recipient.

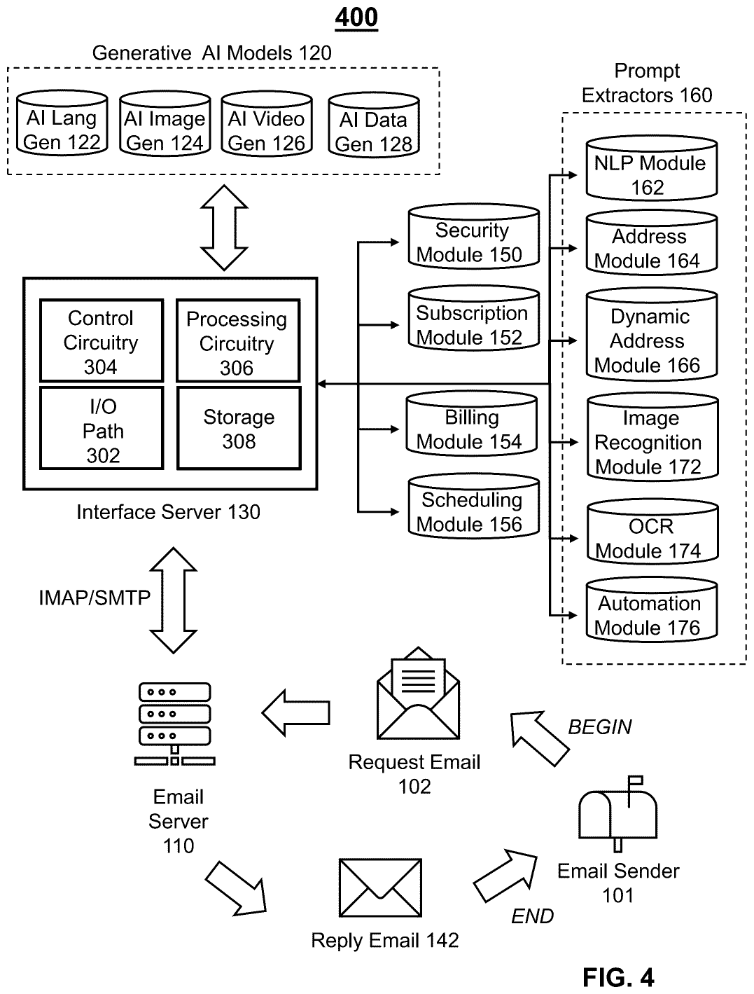

FIG. 4 depicts an illustrative schematic diagram for an interface server and interconnected modules used in processing request emails using a Gen AI platform, in accordance with some embodiments of this disclosure.

The schematic diagram in FIG. 4 illustrates a comprehensive system for processing and generating content in response to email requests. The system incorporates various modules for security, subscription verification, prompt extraction, scheduling, and content generation through AI models, which may be integrated in and/or run on servers/computers in network communication with Interface Server 130.

Interface Server 130 may be configured to retrieve emails from the Email Server 110 and facilitate communication between the Email Server 110 and other system modules. For instance, Email Server 110 may be configured to receive and process incoming emails from an email sender. Email Server 110 may hold the emails until they are retrieved by the Interface Server 130. Interface Server 130 may include, e.g., Control Circuitry 304, Processing Circuitry 306, Input/Output Path 302, and Storage 308. Interface Server 130 may receive content and data via input/output (I/O) path 402. I/O path 402 may provide content (e.g., broadcast programming, on-demand programming, Internet content, content available over a local area network (LAN) or wide area network (WAN), and/or other content) and data to control circuitry 404, which may comprise processing circuitry 406 and storage 408. Control circuitry 404 may be used to send and receive commands, requests, and other suitable data using I/O path 402, which may comprise I/O circuitry. I/O path 402 may connect control circuitry 404 (and specifically processing circuitry 406) to one or more communications paths (described below). I/O functions may be provided by one or more of these communications paths but are shown as a single path in FIG. 4 to avoid overcomplicating the drawing. While Interface Server 130 is depicted as a server in FIGS. 1-3 and 5 for illustration, any suitable computing device having processing circuitry, control circuitry, and storage may be used in accordance with the present disclosure.

Security Module 150 may be configured to verify the identity and authenticity of the Email Sender 101 by performing authentication procedures such as checking the email address, password, and/or other credentials of the email sender.

Subscription Module 152 may be configured to check the subscription status and credit balance of the Email Sender. It ensures that users have an active subscription and sufficient credits to request content generation, deducting credits based on prompt complexity.

Scheduling Module 156 may be configured to schedule the input of the prompts to Generative AI Models 120 based on the priority, urgency, and/or difficulty of the prompts.

Billing Module 154 may be configured to handle all billing-related tasks, including tracking usage, calculating charges, generating invoices, and processing payments.

Prompt Extractors 160 may be configured to extract prompts from the request email and parse them into structured and standardized formats. In some embodiments, Prompt Extractors 160 is a module that includes several sub-modules. The NLP Module 162 may be configured to process natural language prompts. Address Module 164 has the capability to extract and handle address-related prompts. Dynamic Address Module 166 may be configured to handle dynamic address prompts, e.g., prompts that are conveyed as part of a dynamic email address. Image Recognition Module 172 is tasked with processing image-based prompts. OCR Module 174 is designed to extract text from images. Automation Module 176 may be configured to execute automated tasks based on the prompts.

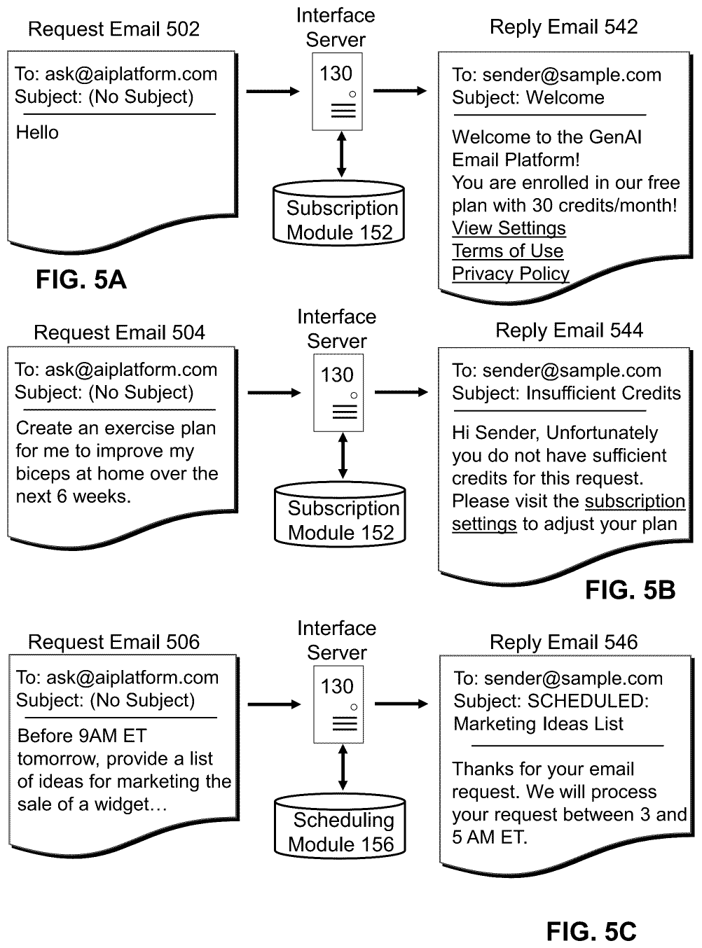

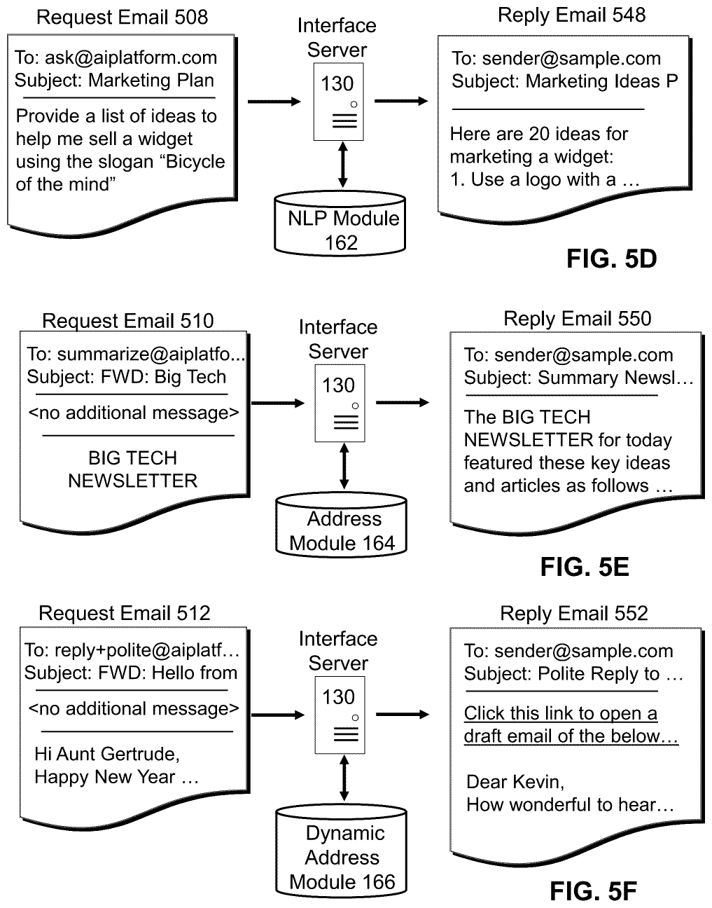

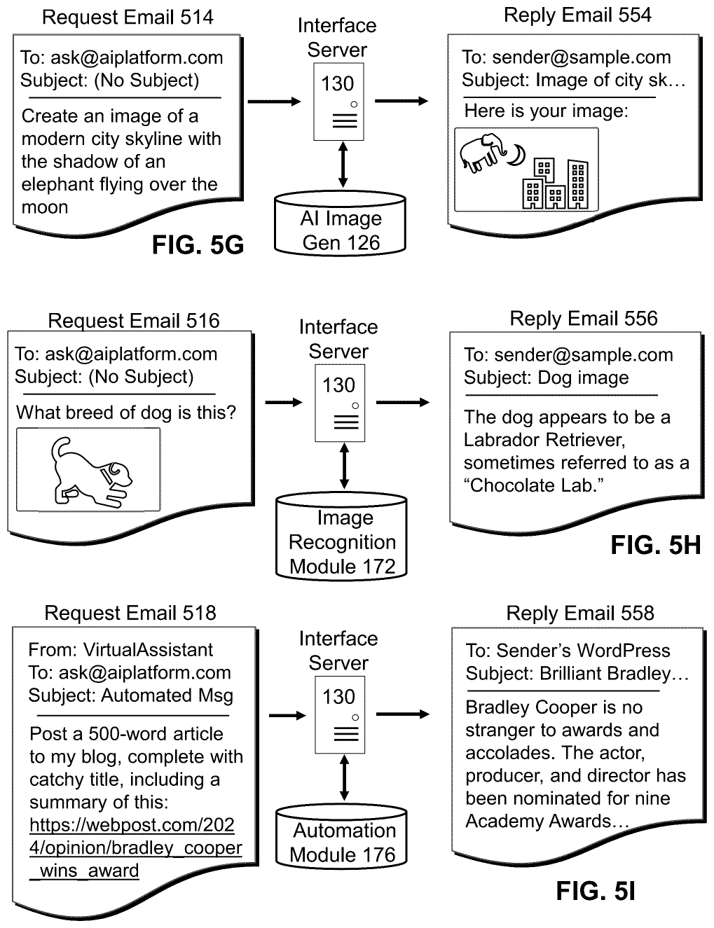

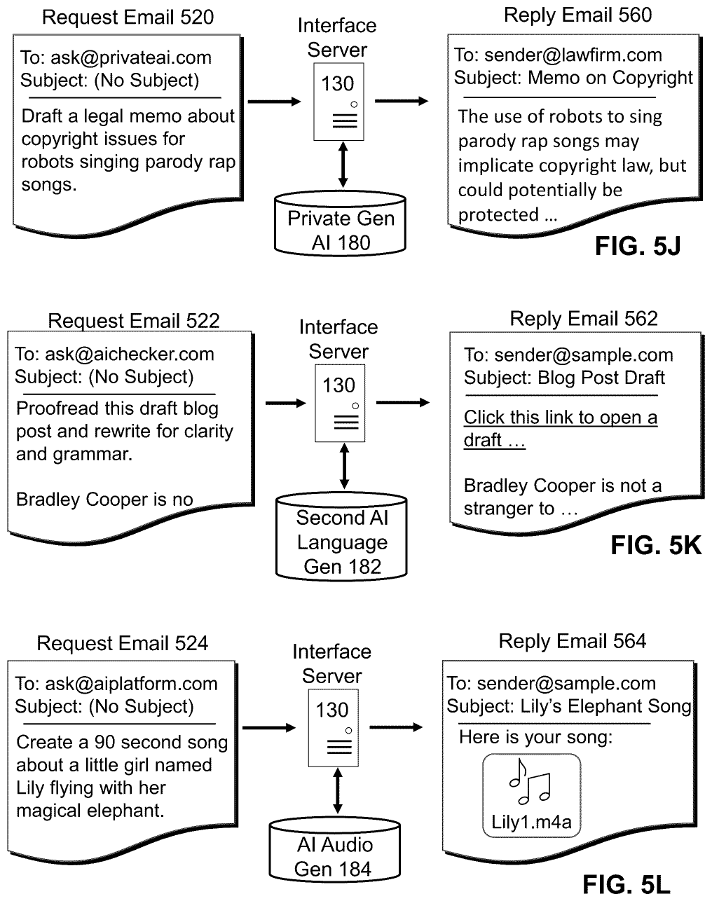

Generative AI Models 120 may be configured to generate content using AI models based on the prompts. In some embodiments, Generative AI Models 120 may include various sub-modules such as the AI Language Generator 122, which generates text-based content. In some embodiments, AI Image Generator 124 creates images based on prompts. In some embodiments, AI Video Generator 126 produces videos based on prompts. In some embodiments, AI Data Generator 128 may generate data based on prompts. In some embodiments, Private Generative AI Model 180 (see FIG. 5J) may generate private data based on prompts. In some embodiments, Second AI Language Generator 182 (see FIG. 5K) may generate editing and/or proofreading data based on prompts. In some embodiments, AI Audio Generator 184 (see FIG. 5L) may generate audio and/or music data based on prompts. In some embodiments, two or more of these modules work together to process and generate content.

Looking at the schematic diagram of FIG. 4, the data flow begins with Email Sender 101 transmitting a request email to Email Server 110. This represents the initiation of a communication request from a user or system. Interface Server 130 then accesses the email(s) from Email Server 110, signifying the retrieval of the user's request. The Interface Server 130 is configured with Control Circuitry 304 for managing operational controls, Processing Circuitry 306 for handling data processing, Input/Output Path 302 for facilitating communication channels, and Storage 308 for efficient data storage. A receive request email is sent from Email Server 110 to Interface Server 130, indicating the successful transmission of the email.

Interface Server 130 then interacts with Security Module 150 to verify the sender. This step ensures the authenticity of the sender and protects against unauthorized access. The Security Module 150 performs authentication procedures such as checking the email address, password, and/or other credentials of the email sender.

Once the sender is authenticated, Interface Server 130 checks with Subscription Module 152 to confirm if the sender has sufficient credits. This step validates the sender's subscription status and ensures they have the necessary resources to proceed. The Subscription Module 152 determines whether the email sender has a valid and active subscription to the system and whether the email sender has sufficient credits to request content generation.

Upon confirmation of sufficient credits, Interface Server 130 interacts with Prompt Extractors 160 to extract prompts from the request email. This step involves parsing the email content to identify the user's request or command. The Prompt Extractors 160 includes various modules such as NLP Module 162 for natural language processing, Address Module 164 for address extraction, Dynamic Address Module 166 for dynamic address handling, Image Recognition Module 172 for image-based prompts, OCR Module 174 for text extraction from images, and Automation Module 176 for automated task execution.

The extracted prompts are then scheduled based on their nature by Scheduling Module 156. This step organizes the processing of the prompts according to predefined rules or algorithms.

The scheduled prompts are input into Generative AI Models 120. These models process the prompts and generate the required output. The Generative AI Models 120 includes various modules such as AI Language Generator 122 for text-based content, AI Image Generator 124 for image creation, AI Video Generator 126 for video production, and AI Data Gen 128 for handling data-related requests.

The output from Generative AI Models 120 is sent back to Interface Server 130, which prepares the reply email. Finally, the prepared reply email is transmitted back to Email Sender 101 via Email Server 110, completing the process.

FIG. 5A depicts an illustrative flow diagram for an interface processing request emails using a Gen AI platform and a subscription module, in accordance with some embodiments of this disclosure. FIG. 5A depicts how, for example, Interface Server 120 may process a new user/subscriber. For instance, Request Email 502 may be received by Interface Server 120 via Email Server 110, communicate with Subscription Module 152, and send an output as Reply Email 542 via Email Server 110. In FIG. 5A, Subscription Module 152 is a component that manages the subscription status and credits of the users of the Gen AI platform, and provides them with access to different features and functionalities based on their subscription plans. In some embodiments, Interface Server 120 may communicate with and Generative AI Model(s) 120 to, e.g., generate a welcome email; however, but in the initial setup email(s), AI models may not be necessary as algorithmic replies may be sufficient.

Request Email 502 is an example of an email that a user may send to the Gen AI platform to initiate a subscription or request a service. In this example, Request Email 502 is addressed to ask@aiplatform.com, has no subject line, and has a simple “Hello” as its body content. Request Email 502 may be sent by a user who is interested in using the Gen AI platform but has not yet registered or subscribed to any plan.

Interface Server 120 is a server that processes the incoming and outgoing emails for the Gen AI platform, e.g., via Email Server 110. Interface Server 120 receives Request Email 502 via Email Server 110, which is a server that facilitates the email communication between the user and the Gen AI platform. In some embodiments, Interface Server 120 may parse the content and metadata of Request Email 502 and determines the appropriate action to take based on the user's request and subscription status.

Subscription Module 152 is a module that interacts with Interface Server 120 to verify and update the subscription status and credits of the user. Subscription Module 152 may access a database or a cloud service that stores the user information, such as name, email address, subscription plan, credits, etc. Subscription Module 152 may also provide Interface Server 120 with the relevant information and instructions to process the user's request and generate a reply email. In some embodiments, Subscription Module 152 may communicate with and/or work in conjunction with a security module, e.g., Security Module 150.

Reply Email 542 is an example of an email that Interface Server 120 may send to the user as a response to Request Email 502. In this example, Reply Email 542 is addressed to sender@sample.com, has “Welcome” as its subject line, and has a body content that includes a welcome message, details about the user's enrollment in a free plan with 30 credits per month, and links to view settings, terms of use, and privacy policy. Reply Email 542 may be sent by Interface Server 120 via Email Server 110. In some embodiments, Reply Email 542 may include content that is generated by Generative AI Model(s) 120 based on the user's request and subscription status.

FIG. 5A illustrates an exemplary embodiment of an interface processing system that uses a Gen AI platform and a subscription module to provide users with a personalized and engaging email service. The interface processing system may be implemented in various ways and may include other components and features that are not shown in FIG. 5A. The interface processing system may also be adapted to process other types of requests and generate other types of content using the Gen AI platform.

FIG. 5B depicts an illustrative flow diagram for an interface processing request emails using a Gen AI platform and a subscription module, in accordance with some embodiments of this disclosure. In FIG. 5B, for example, Subscription Module 152 is a component that manages the subscription status and credits of the users of the Gen AI platform and provides them with access to different features and functionalities based on their subscription plans.

FIG. 5B depicts how, for example, Interface Server 120 may process a request from a user/subscriber who has insufficient credits to carry out a request. For instance, Request Email 504 may be received by Interface Server 120 via Email Server 110, communicate with Subscription Module 152 and Generative AI Model(s) 120, and send an output as Reply Email 544 via Email Server 110.

Request Email 504 is an example of an email that a user may send to the Gen AI platform to request a service that requires a certain amount of credits. In this example, Request Email 504 is addressed to ask@aiplatform.com, has no subject line, and has a body content that asks the Gen AI platform to create an exercise plan for the user to improve their biceps at home over the next six weeks. Request Email 504 may be sent by a user who is already registered or subscribed to a plan but has exhausted their credits for the month.

Interface Server 120 is a server that handles the incoming and outgoing emails for the Gen AI platform. Interface Server 120 receives Request Email 504 via Email Server 110, which is a server that facilitates the email communication between the user and the Gen AI platform. In some embodiments, Interface Server 120 may parse the content and metadata of Request Email 504 and determines the appropriate action to take based on the user's request and subscription status.

Subscription Module 152 is a module that interacts with Interface Server 120 to verify and update the subscription status and credits of the user. Subscription Module 152 may access a database or a cloud service that stores the user information, such as name, email address, subscription plan, credits, etc. Subscription Module 152 may also provide Interface Server 120 with the relevant information and instructions to process the user's request and generate a reply email.

Reply Email 544 is an example of an email that Interface Server 120 may send to the user as a response to Request Email 504. In this example, Reply Email 544 is addressed to sender@sample.com, has “Insufficient Credits” as its subject line, and has a body content that informs the user that they do not have enough credits for their request, and directs them to visit a URL for the subscription settings to adjust their plan. Reply Email 544 may be sent by Interface Server 120 via Email Server 110 and may include content generated by Generative AI Model(s) 120 based on the user's request and subscription status. In some embodiments, AI models may not be necessary as an algorithmic reply may be sufficient.

FIG. 5B illustrates an exemplary embodiment of an interface processing system that uses a Gen AI platform and a subscription module to provide users with a personalized and engaging email service. The interface processing system may be implemented in various ways and may include other components and features that are not shown in FIG. 5B. The interface processing system may also be adapted to process other types of requests and generate other types of content using the Gen AI platform.

FIG. 5C depicts an illustrative flow diagram for an interface processing request emails using a Gen AI platform and a scheduling module, in accordance with some embodiments of this disclosure. In FIG. 5C, Scheduling Module 156 is a component that manages the timing and priority of the requests from the users of a Gen AI email platform while providing them with options to choose a delayed schedule for their requests. A delayed schedule may reduce the resources used at a given time and improve the processing efficiency. In some embodiments, a user may be charged less and/or rewarded with an additional credit (e.g., this month or next month) for requesting a delayed response.

FIG. 5C depicts how, for example, Interface Server 120 may process a request from a user/subscriber on a delayed schedule as instructed in the request. For instance, Request Email 506 may be received by Interface Server 120 via Email Server 110, communicate with Scheduling Module 156 and Generative AI Model(s) 120, and send an output as Reply Email 546 via Email Server 110. In this case, Reply Email 546 is a notification of when the request will be processed.

Request Email 506 is an example of an email that a user may send to the Gen AI platform to request a service that can be performed on a delayed schedule. In this example, Request Email 506 is addressed to ask@aiplatform.com, has no subject line, and has a body content that asks the Gen AI platform to provide a list of ideas for marketing the sale of a widget before 9 AM ET tomorrow. Request Email 506 may be sent by a user who is willing to wait for a delayed response, e.g., in exchange for a lower cost or extra credit.

Interface Server 120 is a server that handles the incoming and outgoing emails for the Gen AI platform. Interface Server 120 receives Request Email 506 via Email Server 110, which is a server that facilitates the email communication between the user and the Gen AI platform. In some embodiments, Interface Server 120 may parse the content and metadata of Request Email 506 and determines the appropriate action to take based on the user's request and schedule preference.

Scheduling Module 156 is a module that interacts with Interface Server 120 to manage the timing and priority of the requests from the users. Scheduling Module 156 may access a database or a cloud service that stores the request information, such as request type, content, deadline, schedule preference, cost, credit, etc. Scheduling Module 156 may also provide Interface Server 120 with the relevant information and instructions to process the user's request and generate a reply email, e.g., before a specified time.

Reply Email 546 is an example of an email that Interface Server 120 may send to the user as a response to Request Email 506. In this example, Reply Email 546 is addressed to sender@sample.com, has “SCHEDULED: Marketing Ideas List” as its subject line, and has a body content that thanks the user for their email request, and informs them that their request will be processed between 3 and 5 AM ET. Reply Email 546 may be sent by Interface Server 120 via Email Server 110 and may include content that is generated by Generative AI Model(s) 120 based on the user's request and schedule preference. In some embodiments, AI models may not be necessary as an algorithmic reply may be sufficient.

FIG. 5C illustrates an exemplary embodiment of an interface processing system that uses a Gen AI platform and a scheduling module to provide users with a personalized and engaging email service. The interface processing system may be implemented in various ways and may include other components and features that are not shown in FIG. 5C. The interface processing system may also be adapted to process other types of requests and generate other types of content using the Gen AI platform.

FIG. 5D depicts an illustrative flow diagram for an interface processing request emails using a Gen AI platform and a natural language processing module, in accordance with some embodiments of this disclosure. In FIG. 5D, a natural language processing module (e.g., NLP Module 162) is a component that analyzes and interprets the natural language content of the request emails and provides them with suitable prompts to generate the desired output using the Gen AI model(s).

FIG. 5D depicts how, for example, Interface Server 120 may process a request email that includes a subject line and a body content. For instance, Request Email 508 may be received by Interface Server 120 via Email Server 110, communicate with NLP Module 162 to develop a prompt, input the prompt into Generative AI Model(s) 120, and send an output as Reply Email 548 via Email Server 110. In this case, Request Email 508 includes a subject line that should be processed with the prompt in the body of email 508.

Request Email 508 is an example of an email that a user may send to the Gen AI platform to request a service that involves generating a list of ideas for marketing a widget using the slogan “Bicycle of the mind.” In this example, Request Email 508 is addressed to ask@aiplatform.com, has “Marketing Plan” as its subject line, and has a body content that provides the prompt for the Gen AI platform to generate the list of ideas.

Interface Server 120 is a server that handles the incoming and outgoing emails for the Gen AI platform. Interface Server 120 receives Request Email 508 via Email Server 110, which is a server that facilitates the email communication between the user and the Gen AI platform. In some embodiments, Interface Server 120 may parse the content and metadata of Request Email 508 and determines the appropriate action to take based on the user's request and subject line. NLP Module 162 is a module that interacts with Interface Server 120 to analyze and

interpret the natural language content of the request emails. In some embodiments, NLP Module 162 may combine a subject line and a body of, e.g., a request email to create a prompt. NLP Module 162 may use various techniques, such as tokenization, parsing, semantic analysis, etc., to extract the key information and requirements from the request emails. NLP Module 162 may also provide Interface Server 120 with suitable prompts to generate the desired output using the Gen AI model(s).

Reply Email 548 is an example of an email that Interface Server 120 may send to the user as a response to Request Email 508. In this example, Reply Email 548 is addressed to sender@sample.com, has “Marketing Ideas Plan” as its subject line, and has a body content that includes a list of, e.g., 20 ideas for marketing a widget using the slogan “Bicycle of the mind.” Reply Email 548 may be sent by Interface Server 120 via Email Server 110 and may include content that is generated by Generative AI Model(s) 120 based on the prompt provided.

FIG. 5D illustrates an exemplary embodiment of an interface processing system that uses a Gen AI email platform and a natural language processing module to provide users with a personalized and engaging email service. The interface processing system may be implemented in various ways and may include other components and features that are not shown in FIG. 5D. The interface processing system may also be adapted to process other types of requests and generate other types of content using the Gen AI platform.

FIG. 5E depicts an illustrative flow diagram for an interface processing request emails using a Gen AI platform and an address module, in accordance with some embodiments of this disclosure. In some embodiments, an address module (e.g., Address Module 164) is a component that assigns different email addresses to the Gen AI platform based on the specific prompts or tasks that the user may request, such as summarizing an article (e.g., “summarize”), making a blog post (e.g. “blog”), generating an image (e.g., “image”), generating a sound (e.g., “audio” or “song”), generating a letter (e.g., “letter” or “reply”), generating a plan (e.g., “business.plan” or “food.plan” or “vacation.plan”), writing code (e.g., “code”), etc. In some embodiments, address module 164 may also work in conjunction with a natural language processing module to create a prompt from the address, subject, and/or body of a request email.

FIG. 5E depicts how, for example, Interface Server 120 may process a request email that is addressed to a specific email address of the Gen AI platform. For instance, Request Email 510 may be received by Interface Server 120 via Email Server 110, communicate with Address Module 164 to develop a prompt, input the prompt into Generative AI Model(s) 120, and send an output as Reply Email 550 via Email Server 110. In this case, Request Email 510 is addressed to summarize@aiplatform.com, which indicates that the user wants the Gen AI platform to summarize the content of the email.

Request Email 510 is an example of an email that a user may send to the Gen AI platform to request a service that is associated with a specific email address. In this example, Request Email 510 is addressed to summarize@aiplatform.com, has “FWD: Big Tech” as its subject line, and has no additional message other than the forwarded BIG TECH NEWSLETTER as its body content. Request Email 510 may be sent by a user who wants the Gen AI platform to provide a concise summary of the newsletter included in the forwarded email. In some embodiments, Interface Server 120 may input multiple newsletters (e.g., received in one day or during a predetermined amount of time of one another) and output summaries of multiple newsletters, e.g., in one reply email.

Interface Server 120 is a server that handles the incoming and outgoing emails for the Gen AI platform. Interface Server 120 receives Request Email 510 via Email Server 110, which is a server that facilitates the email communication between the user and the Gen AI platform. In some embodiments, Interface Server 120 may parse the content and metadata of Request Email 510 and determines the appropriate action to take based on the user's request and sent-to email address.

Address Module 164 is a module that interacts with Interface Server 120 to assign and manage different email addresses for the Gen AI platform based on the specific prompts or tasks that the user may request. Address Module 164 may access a database or a cloud service that stores the email address information, such as address, prompt, task, cost, credit, etc. Address Module 164 may also provide Interface Server 120 with suitable prompts to generate the desired output using the Gen AI platform.

Generative AI Model(s) 120 are one or more generative artificial intelligence models that are used by Interface Server 120 to create the content for the reply email. Generative AI Model(s) 120 may be trained on various types of data, such as text, images, audio, video, etc., and may use different techniques, such as natural language generation, computer vision, speech synthesis, etc., to generate the content. Generative AI Model(s) 120 may also take into account the user's inputs, preferences, and feedback to customize the content.

Reply Email 550 is an example of an email that Interface Server 120 may send to the user as a response to Request Email 510. In this example, Reply Email 550 is addressed to sender@sample.com, has “Summary Newsletter” as its subject line, and has a body content that includes a summary of the key ideas and articles featured in the BIG TECH NEWSLETTER. Reply Email 550 may be sent by Interface Server 120 via Email Server 110 and may include content that is generated by Generative AI Model(s) 120 based on the prompt provided by the Address Module 164.

FIG. 5E illustrates an exemplary embodiment of an interface processing system that uses a Gen AI platform and an address module to provide users with a personalized and engaging email service. The interface processing system may be implemented in various ways and may include other components and features that are not shown in FIG. 5E. The interface processing system may also be adapted to process other types of requests and generate other types of content using the Gen AI platform.

FIG. 5F depicts an illustrative flow diagram for an interface processing request emails using a Gen AI email platform and a dynamic address module, in accordance with some embodiments of this disclosure. The dynamic address module (e.g., Dynamic Email Module 166) is a component that enables the user to send request emails to different email addresses of the Gen AI platform based on dynamic prompts or tasks that the user may want to perform, such as summarizing a website (e.g., summarize.website), writing a tweet (tweet+about), generating an image (e.g., draw+anime), generating music (e.g., create.parody), drafting a letter (formal+letter), generating a marketing plan for a week (week+marketing+plan), writing code (e.g., python+coding), etc. In some embodiments, Dynamic Address Module 166 may also work in conjunction with a natural language processing module to create a prompt from the address, subject, and/or body of a request email.

Dynamic Address Module 166 may be configured to receive email addressed to dynamic email addresses using a catch-all or wildcard email address and an email service provider. A dynamic email address is an email address that can be created on the fly based on certain criteria, such as user input, request type, or email content. A catch-all or wildcard email address is a special email address that can receive any email sent to a domain that does not match an existing email account. An email service provider is a service that offers features for sending and receiving emails using dynamic email addresses.

In some embodiments, the following steps may be required to, e.g., configure Dynamic Address Module 166: (1) set up a domain or subdomain for the email service, such as seller.com or mail.seller.com. The domain or subdomain may be owned by the user or provided by the email service provider as a sandbox domain; (2) configure the DNS records to point the domain or subdomain to the email service provider's servers. The DNS records may include MX, SPF, DKIM, and DMARC records to verify the domain and ensure email deliverability and security; (3) create a catch-all or wildcard email address for the domain or subdomain, such as *@seller.com. The catch-all or wildcard email address may be an existing email account or a new one created for this purpose. The catch-all or wildcard email address may receive any email sent to the domain or subdomain that does not match an existing email account, such as question+shipping@seller.com, feedback@seller.com, or support@seller.com; (4) use the email service provider's APIs or webhooks to process the incoming emails to the catch-all or wildcard email address. The email service provider may use the email address, subject, or body of the email to determine the type of request and generate a suitable response. The email service provider may also use templates or dynamic content to customize the response based on the user's input or preferences.

FIG. 5F depicts how, for example, Interface Server 120 may process a request email that is addressed to a dynamic email address of the Gen AI platform. For instance, Request Email 512 may be received by Interface Server 120 via Email Server 110, communicate with Dynamic Address Module 166 to develop a prompt, input the prompt into Generative AI Model(s) 120, and send an output as Reply Email 550 via Email Server 110. In this case, Request Email 512 is addressed to reply+polite@aiplatform.com, which indicates that the user wants the Gen AI platform to generate a polite reply to a forwarded email.

Request Email 512 is an example of an email that a user may send to the Gen AI platform to request a service that is associated with a dynamic email address. In this example, Request Email 512 is addressed to reply+polite@aiplatform.com, has “FWD: Hello from your nephew” as its subject line, and has no additional message other than the forwarded email from the user's nephew as its body content. Request Email 512 may be sent by a user who wants the Gen AI platform to help them write a polite reply to her nephew.

Interface Server 120 is a server that handles the incoming and outgoing emails for the Gen AI platform. Interface Server 120 receives Request Email 512 via Email Server 110, which is a server that facilitates the email communication between the user and the Gen AI platform. In some embodiments, Interface Server 120 may parse the content and metadata of Request Email 512 and determines the appropriate action to take based on the user's request and email address.

Dynamic Address Module 166 is a module that interacts with Interface Server 120 to enable and manage different email addresses for the Gen AI platform based on the specific prompts or tasks that the user may want to perform. Dynamic Address Module 166 may use a catch-all or wildcard email address to receive any email sent to the Gen AI platform that does not match an existing email account. Dynamic Address Module 166 may also use services like Mailgun or Sendgrid to create and handle dynamic email addresses for the Gen AI platform. Dynamic Address Module 166 may also provide Interface Server 120 with suitable prompts to generate the desired output using the Gen AI platform. In some embodiments, Dynamic Address Module 166 may use webhooks. In some embodiments, Dynamic Address Module 166 may enable the user to handle different types of requests or inquiries without creating separate email accounts for each one. In some embodiments, Dynamic Address Module 166 may also provide the user with flexibility and convenience in using dynamic email addresses for various purposes. In some embodiments, Dynamic Address Module 166 may also optimize the email server's performance and resource utilization by reducing the number of email accounts and emails.

Reply Email 550 is an example of an email that Interface Server 120 may send to the user as a response to Request Email 512. In this example, Reply Email 550 is addressed to sender@sample.com, has “Polite Reply to Aunt Gertrude” as its subject line, and has a body content that includes a link to open a draft email of a polite reply to the user's nephew. Reply Email 550 may be sent by Interface Server 120 via Email Server 110, and may include content that is generated by Generative AI Model(s) 120 based on the prompt provided by the Dynamic Address Module 166.

FIG. 5F illustrates an exemplary embodiment of an interface processing system that uses a Gen AI platform and a dynamic address module to provide users with a personalized and engaging email service. The interface processing system may be implemented in various ways and may include other components and features that are not shown in FIG. 5F. The interface processing system may also be adapted to process other types of requests and generate other types of content using the Gen AI platform.

FIG. 5G depicts an illustrative flow diagram for an interface processing request emails using a Gen AI platform and an AI Image Generation Model (e.g., AI Image Generation Model 126), in accordance with some embodiments of this disclosure. AI Image Generation Model 126 may be, e.g., a component that generates images based on prompts provided by the user or the interface.

FIG. 5G depicts how, for example, Interface Server 120 may process a request email that requests the creation of an image based on a prompt in the body of the email. For instance, Request Email 514 may be received by Interface Server 120 via Email Server 110, and a prompt input into AI Image Generation Model 126 (e.g., as part of Generative AI Model(s) 120) and send an output as Reply Email 554 via Email Server 110. In this case, Request Email 514 requests the creation of an image of a modern city skyline with the shadow of an elephant flying over the moon.

Request Email 514 is an example of an email that a user may send to the Gen AI platform to request the creation of an image based on a prompt in the body of the email. In this example, Request Email 514 is addressed to ask@aiplatform.com, has no subject line, and has a body content that contains the prompt “Create an image of a modern city skyline with the shadow of an elephant flying over the moon”. Request Email 514 may be sent by a user who wants the Gen AI platform to generate an image that matches their imagination or creativity.

Interface Server 120 is a server that handles the incoming and outgoing emails for the Gen AI platform. Interface Server 120 receives Request Email 514 via Email Server 110, which is a server that facilitates the email communication between the user and the Gen AI platform.

AI Image Generation Model 126 is a model that interacts with Interface Server 120 to generate images based on prompts provided by the user or the interface. AI Image Generation Model 126 may use various techniques, such as deep learning, generative adversarial networks, neural style transfer, etc., to generate realistic and high-quality images. AI Image Generation Model 126 may also take into account the user's inputs, preferences, and feedback to customize the images.

Reply Email 554 is an example of an email that Interface Server 120 may send to the user as a response to Request Email 514. In this example, Reply Email 554 is addressed to sender@sample.com, has “Image of city skyline . . . ” as its subject line, and has a body content that includes the image generated by AI Image Generation Model 126 based on the prompt provided by the user. The image shows a modern city skyline with the shadow of an elephant flying over the moon, as requested by the user. Reply Email 554 may be sent by Interface Server 120 via Email Server 110 and may include a link or an attachment to the image.

FIG. 5G illustrates an exemplary embodiment of an interface processing system that uses a Gen AI platform and an AI Image Generation Model to provide users with a personalized and engaging email service. The interface processing system may be implemented in various ways and may include other components and features that are not shown in FIG. 5G. The interface processing system may also be adapted to process other types of requests and generate other types of content using the Gen AI platform.

FIG. 5H depicts an illustrative flow diagram for an interface processing request emails using a Gen AI platform and an image recognition module, in accordance with some embodiments of this disclosure. As depicted in FIG. 5H, the schematic diagram illustrates an interface processing request emails using a Gen AI platform and an Image Recognition Model (e.g., Image Recognition Module 172).

The process begins with the receipt of Request Email 516 by Interface Server 120 via Email Server 110. Request Email 516 is addressed to ask@aiplatform.com with no subject indicated. The body of the email contains a query: “What breed of dog is this?” accompanied by an image of a brown dog.

Upon receipt, Interface Server 120 communicates with Image Recognition Module 172 to interpret and analyze the included image. Image Recognition Module 172 employs algorithms and machine learning techniques to identify and categorize the visual content within images attached in emails. In this instance, it processes the image of the dog included in Request Email 516 to assist in generating an appropriate response.

Post analysis, Interface Server 120 inputs a developed prompt incorporating insights from Image Recognition Module into Generative AI Model(s) 120. These AI models are, e.g., equipped with capabilities to generate human-like text based on given prompts, ensuring responses are contextually relevant and accurate.

In FIG. 5H's scenario, Generative AI Model(s) 120 crafts a detailed response identifying the breed of dog depicted in the attached image. This output is then converted into Reply Email 556 by Interface Server 130 before being dispatched back to the original sender via Email Server 110.

Reply Email 556 addresses sender@sample.com with “Dog Image” as its subject line. The body confirms that “The dog appears to be a Labrador Retriever, sometimes referred to as a ‘Chocolate Lab’,” accompanied by additional images for reference or comparison purposes.

FIG. 5H illustrates an exemplary embodiment of an interface processing system that uses a Gen AI platform and an Image Recognition Module to provide users with a personalized and engaging email service. The interface processing system may be implemented in various ways and may include other components and features that are not shown in FIG. 5H. The interface processing system may also be adapted to process other types of requests and generate other types of content using this and/or other Gen AI platforms.

FIG. 5I depicts an illustrative flow diagram for an interface processing request emails using a Gen AI platform and an automation module, in accordance with some embodiments of this disclosure. For instance, FIG. 5I illustrates an advanced flow diagram for processing request emails utilizing both a Gen AI platform and an Automation Module 176, as per certain embodiments of this disclosure. In this case, the Gen AI platform is adept at creating diverse content types, while the Automation Module enhances efficiency in handling and responding to emails.

In FIG. 5I, Request Email 518, originating from a Virtual Assistant for a subscriber, is directed to ask@aiplatform.com with the subject “Automated Msg.” The body of the email contains instructions to post a 500-word article on the subscriber's blog, summarizing content from a provided URL.

Upon receipt by Interface Server 130 via Email Server 110, Request Email 518 triggers an automated process where its content and instructions are analyzed and interpreted by Generative AI Model(s) after being prompted by Interface Server 130.

Automation Module 176 plays a pivotal role in identifying new reply email addresses ensuring that responses are directed appropriately. In this instance, it identifies that Reply Email should be sent directly to Sender's WordPress account rather than reverting back to the Virtual Assistant and/or the subscriber. In some embodiments, Automation Module 176 may direct the Reply Email 558 to be sent to, e.g., the Virtual Assistant and/or the subscriber. In some embodiments, Automation Module 176 may direct the Reply Email 558 to be sent to, e.g., an email address specified in the settings and/or in Request Email 518.

Generative AI Model(s) then crafts Reply Email 558 addressed to Sender's WordPress with the subject “Brilliant Bradley . . . ” The body contains an article celebrating Bradley Cooper's achievements in film industry as requested in Request Email 518. The integration between Interface Server 130 and Automation Module 176 ensures that Reply Emails are generated and dispatched efficiently via Email Server 110 to the correct address.

This illustrative flow diagram provides an exemplary view of how a Gen AI email platform and Automation Module may work in tandem to process request emails and generate appropriate responses. The system may be implemented in various ways and may include other components and features not shown in FIG. 5D. The system may also be adapted to process other types of requests and generate other types of content using one or more Gen AI platforms.

FIG. 5J depicts an illustrative flow diagram for an interface processing request emails using a private generative AI platform, in accordance with some embodiments of this disclosure. Private Generative AI Platform may be a system that leverages generative artificial intelligence models to create various types of content, such as text, images, audio, video, etc., based on user inputs and preferences. Generally, in FIG. 5J, Private Generative AI 180 would work in conjunction with a private email server and private interface server 130 to, e.g., maintain end-to-end privacy. In some embodiments, Private Generative AI 180 may be a customized GPT, tailored for a sender or a sender's company/firm.

FIG. 5J depicts how, for example, Interface Server 130 may process a request email that requests the drafting of a legal memo about copyright issues for robots singing parody rap songs. For instance, Request Email 520 may be received by Interface Server 130 via Email Server 110, and a prompt input into Private Generative AI Model 180, and send an output as Reply Email 560 via Email Server 110 to the sender. In this case, Request Email 520 requests the drafting of a legal memo about copyright issues for robots singing parody rap songs.

Request Email 520 is an example of an email that a user may send to the Private Generative AI platform to request the drafting of a legal memo based on a prompt in the body of the email. In this example, Request Email 520 is addressed to ask@privateai.com, has no subject line, and has a body content that contains the prompt “Draft a legal memo about copyright issues for robots singing parody rap songs.”. Request Email 520 may be sent by a user who wants the Private Generative AI platform to generate a legal memo that matches their requirements.

Interface Server 130 is a server that handles the incoming and outgoing emails for the Private Generative AI platform. Interface Server 130 receives Request Email 520 via Email Server 110, which is a server that facilitates the email communication between the user and the Private Generative AI platform. Interface Server 130 parses the content and metadata of Request Email 520 and determines the appropriate action to take based on the user's request and prompt.

Private Gen AI 180 is a model that interacts with Interface Server 130 to generate content based on prompts provided by the user or the interface. Private Gen AI 180 may use various techniques, such as machine learning algorithms, natural language processing, etc., to generate realistic and high-quality content tailored according to user's inputs and preferences.

Reply Email 560 is an example of an email that Interface Server 130 may send to the user as a response to Request Email 520. In this example, Reply Email 560 is addressed to sender@lawfirm.com, has “Memo on Copyright” as its subject line, and has a body content that includes the drafted legal memo indicating that robots singing parody rap songs could potentially be protected under copyright law. Reply Email 560 may be sent by Interface Server 130 via Email Server 110 and may include a link to the drafted legal memo.

In the scenario of FIG. 5J, Request Email 520 is received by Interface Server 130 via Email Server 110. Request Email 520 is addressed to ask@privateai.com and, e.g., is from sender@lawfirm.com, contains a specific query in its body: “Draft a legal memo about copyright issues for robots singing parody rap songs.” Email messages may contain sensitive or confidential information that could be intercepted, tampered with, or stolen by malicious actors. To prevent this, in some embodiments, a private email server should use encryption protocols, such as SSL/TLS and S/MIME, to protect the data in transit and at rest. SSL/TLS encrypts the connection between the server and the client, while S/MIME encrypts and digitally signs the email content and attachments. Additionally, in some embodiments, a private email server will have a valid SSL certificate to verify its identity and avoid spoofing or phishing attacks.

In some embodiments, to combat threats of malware and spam, a private email server should employ anti-malware and anti-spam solutions that scan and filter incoming and outgoing emails. In some embodiments, a private email will should implement strong password policies and two-factor authentication to prevent unauthorized access and brute-force attacks.

Interface Server 130 acts as the intermediary that facilitates communication between the incoming request emails of Email Server 120 and Private Generative AI Model(s) 180. Interface Server 130 may be equipped with features that enable it to parse and interpret the content and metadata of incoming emails efficiently.

Upon receiving the prompt from Interface Server 130, Private Generative AI Model(s) 180 generates a response addressing copyright implications for robots engaged in performing parody rap songs. These models are private and secure, ensuring that sensitive information contained within legal queries is handled with utmost confidentiality and integrity.

Reply Email 560 exemplifies an output generated by Private Generative AI Model(s) 180. It is addressed back to sender@lawfirm.com with “Memo on Copyright . . . ” as its subject line. For example, the body of Reply Email 560 includes a memorandum elaborating on potential copyright law implications, e.g., with further exploration and discussion on protections available under specific circumstances.

The integration of these components-Interface Server 130, Private Generative AI Models 180, and Email Servers 120-demonstrates an approach to handling private queries through automation while maintaining quality AI-generated responses. In context of FIG. 5J, privacy remains paramount; hence utilization of Private Generative AI 180 to maintain confidentiality while delivering bespoke solutions addressing confidential queries like those presented in Request Email 520. Moreover, in some embodiments, Private Generative AI 180 may be a customized GPT, tailored for a sender or a sender's company/firm.

The integration between various components depicted in FIG. 5J highlights adaptability; each element from receipt of request emails to generation of replies is meticulously crafted ensuring seamless operations that are both scalable and efficient catering to diverse legal needs as exemplified by Reply Email 560's detailed response. FIG. 5J demonstrates that practical, potential advancements in efficiency, accuracy, and reliability of automated systems integrated with advanced artificial intelligence capable of addressing complex queries while upholding confidentiality-a cornerstone in top-secret industries, legal practice, medical records, and more.

FIG. 5J illustrates an exemplary embodiment of an interface processing system that uses a Private Generative AI platform and a Private Gen AI to provide users with a personalized and engaging email service. The interface processing system may be implemented in various ways, and may include other components and features that are not shown in FIG. 5J. The interface processing system may also be adapted to process other types of requests and generate other types of content using the Private Generative AI platform.

FIG. 5K depicts an illustrative flow diagram for an interface processing request emails using a Second Generative AI platform, in accordance with some embodiments of this disclosure. The Second AI Language Model 182 may be a sophisticated AI system that can be employed to review and/or modify content that has been previously generated by AI and/or drafted by a human. Second AI Language Model 182 is a component that checks and/or edits a prior generated content item.

FIG. 5K depicts how, for example, Interface Server 120 may process a request email that requests the checking and/or editing of a prior generated content item. For instance, Request Email 522 may be received by Interface Server 120 via Email Server 110, and a prompt input into Second AI Language Model 182 and send an output as Reply Email 562 via Email Server 110 to the sender. In this case, Request Email 522 requests the proofreading and rewriting of a draft blog post for clarity and grammar.

Request Email 522 is an example of an email that a user may send to the Second Generative AI platform to request the checking and/or editing of a prior generated content item. In this example, Request Email 522 is addressed to ask@aichecker.com, has no subject line, and has a body content that contains the prompt “Proofread this draft blog post and rewrite for clarity and grammar” and data including “Bradley Cooper is no . . . ”. Request Email 522 may be sent by a user who wants the Second Generative AI platform to check and/or edit a prior generated content item (e.g., by another generative AI model).

Interface Server 120 is a server that handles the incoming and outgoing emails for the Second Generative AI platform. Interface Server 120 receives Request Email 522 via Email Server 110, which is a server that facilitates the email communication between the user and the Second Generative AI platform. Interface Server 120 parses the content and metadata of Request Email 522 and determines the appropriate action to take based on the user's request and prompt.

Second AI Language Model 182 is a model that interacts with Interface Server 120 to check and/or edit a prior generated content item based on prompts provided by the user or the interface. Second AI Language Model 182 may use various techniques, such as deep learning or other generative methods, to check and/or edit a prior generated content item. Second AI Language Model 182 may also take into account the user's inputs, preferences, and feedback to customize the checking and/or editing of a prior generated content item.

Reply Email 562 is an example of an email that Interface Server 120 may send to the user as a response to Request Email 522. In this example, Reply Email 562 is addressed to sender@sample.com, has “Blog Post Draft” as its subject line, and has a body content that includes a link to open a draft of the checked and/or edited content item. The checked and/or edited content item begins with “Bradley Cooper is not a stranger to . . . ”, as requested by the user. Reply Email 562 may be sent by Interface Server 120 via Email Server 110, and may include a link to the checked and/or edited content item.

FIG. 5K illustrates an exemplary embodiment of an interface processing system that uses a Second AI Language Model to provide users with a personalized and engaging email service. The interface processing system may be implemented in various ways, and may include other components and features that are not shown in FIG. 5K. The interface processing system may also be adapted to process other types of requests and generate other types of content using a Second Generative AI platform.

FIG. 5L depicts an illustrative flow diagram for an interface processing request emails using a Gen AI platform and an AI Audio Generation Model (e.g., AI Audio Generation Model 184), in accordance with some embodiments of this disclosure. AI Audio Generation Model 184 is a component that, e.g., generates audio/music based on prompts provided by the user or the interface. In some embodiments, AI Audio Generation Model 184 may, e.g., create an audio transcription of some text.

FIG. 5L depicts how, for example, Interface Server 130 may process a request email that requests the creation of an audio piece based on a prompt in the body of the email. For instance, Request Email 524 may be received by Interface Server 130, and a prompt input into AI Audio Generation Model 184 and send an output as Reply Email 564. In this case, Request Email 524 requests the creation of a 90-second song about a little girl named Lily flying with her magical elephant.

Request Email 524 is an example of an email that a user may send to the Gen AI platform to request the creation of an audio piece based on a prompt in the body of the email. In this example, Request Email 524 is addressed to ask@aiplatform.com, has no subject line, and has a body content that contains the prompt “Create a 90 second song about a little girl named Lily flying with her magical elephant”. Request Email 524 may be sent by a user who wants the Gen AI platform to generate an audio piece that matches their imagination or creativity.

Interface Server 130 is a server that handles the incoming and outgoing emails for the Gen AI platform. Interface Server 130 receives Request Email 524, parses the content and metadata of Request Email 524, and determines the appropriate action to take based on the user's request and prompt.

AI Audio Generation Model 184 is a model that interacts with Interface Server 130 to generate audio/music based on prompts provided by the user or the interface. AI Audio Generation Model 184 may use various techniques, such as deep learning or other generative methods, to generate realistic and high-quality audio pieces. AI Audio Generation Model 184 may also take into account the user's inputs, preferences, and feedback to customize the audio pieces.

Reply Email 564 is an example of an email that Interface Server 130 may send to the user as a response to Request Email 524. In this example, Reply Email 564 is addressed to sender@sample.com, has “Lily's Elephant Song” as its subject line, and has a body content that includes an icon representing “Lilyl.m4a,” e.g., a song file created by AI Audio Generation Model 184 based on the prompt provided in Request Email 524.

FIG. 5L illustrates an exemplary embodiment of an interface processing system that uses a Gen AI platform and an AI Audio Generation Model to provide a personalized and engaging service. The interface processing system may be implemented in various ways and may include other components and features that are not shown in FIG. 5L. The interface processing system may also be adapted to process other types of requests and generate other types of content using a Gen AI platform.

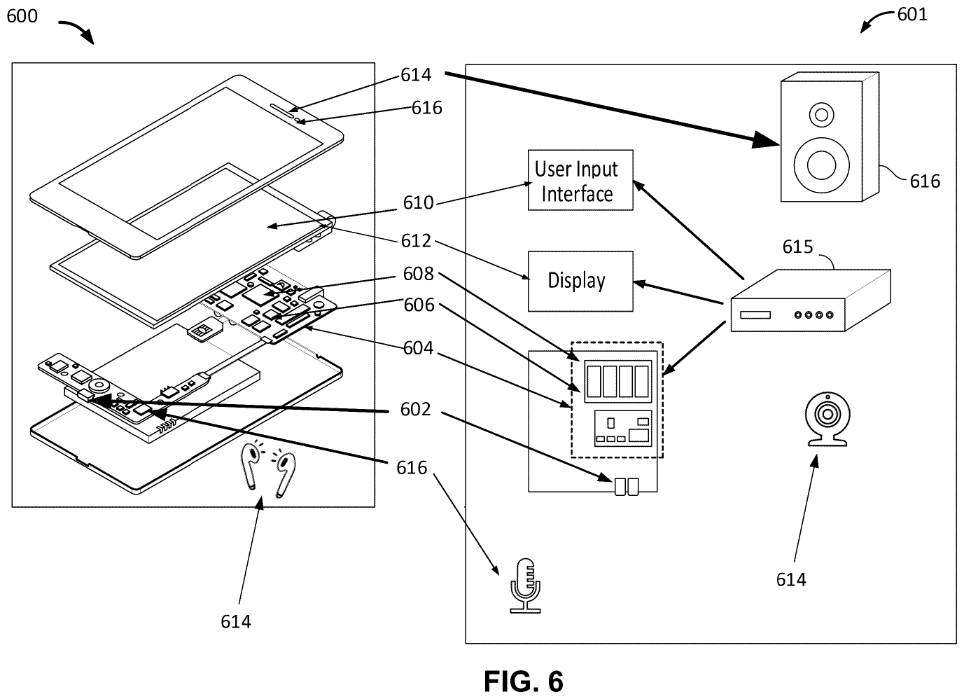

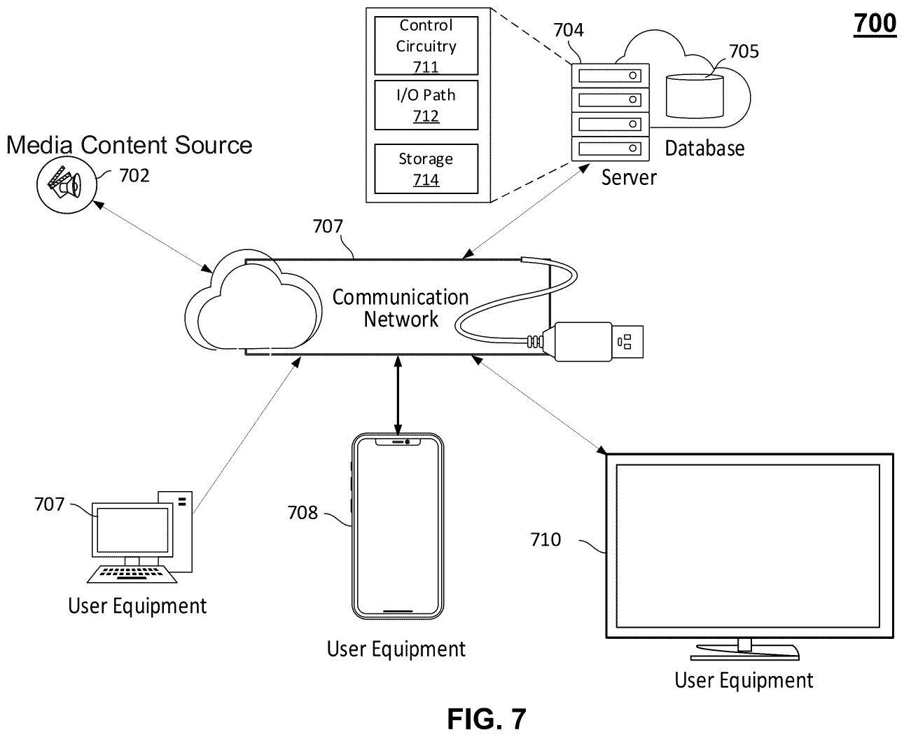

FIGS. 6-7 show illustrative devices, systems, servers, and related hardware for performing radial blurring of at least one image, in accordance with some embodiments of this disclosure. FIG. 6 shows generalized embodiments of illustrative user devices 600 and 601, which may correspond to, e.g., Interface Server 130. For example, user device 600 may be a smartphone device, a tablet, a near-eye display device, an XR device, or any other suitable computing device. In another example, user device 601 may be a user television equipment system or device. User television equipment device 601 may include set-top box 615. Set-top box 615 may be communicatively connected to microphone 616, audio output equipment (e.g., speaker or headphones 614), and display 612. In some embodiments, microphone 616 may receive audio corresponding to a voice of a video conference participant and/or ambient audio data during a video conference. In some embodiments, display 612 may be a television display or a computer display. In some embodiments, set-top box 615 may be communicatively connected to user input interface 610. In some embodiments, user input interface 610 may be a remote control device. Set-top box 615 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user devices are discussed below in connection with FIG. 7. In some embodiments, device 600 may comprise any suitable number of sensors (e.g., gyroscope or gyrometer, or accelerometer, etc.), and/or a GPS module (e.g., in communication with one or more servers and/or cell towers and/or satellites) to ascertain a location of device 600. In some embodiments, device 600 comprises a rechargeable battery that is configured to provide power to the components of the device.

Each one of user device 600 and user device 601 may receive content and data via input/output (I/O) path 602. I/O path 602 may provide content (e.g., broadcast programming, on-demand programming, Internet content, content available over a local area network (LAN) or wide area network (WAN), and/or other content) and data to control circuitry 604, which may comprise processing circuitry 606 and storage 608. Control circuitry 604 may be used to send and receive commands, requests, and other suitable data using I/O path 602, which may comprise I/O circuitry. I/O path 602 may connect control circuitry 604 (and specifically processing circuitry 606) to one or more communications paths (described below). I/O functions may be provided by one or more of these communications paths but are shown as a single path in FIG. 6 to avoid overcomplicating the drawing. While Interface Server 130 is depicted as a server in FIGS. 1-4 et al. for illustration, any suitable computing device having processing circuitry, control circuitry, and storage may be used in accordance with the present disclosure. For example, Interface Server 130 may be replaced by, or complemented by, a personal computer (e.g., a notebook, a laptop, a desktop), a smartphone, an XR device, a tablet, a network-based server hosting a user-accessible client device, a non-user-owned device, any other suitable device, or any combination thereof.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for the interface server application stored in memory (e.g., storage 608). Specifically, control circuitry 604 may be instructed by the interface server application to perform the functions discussed above and below. In some implementations, processing or actions performed by control circuitry 604 may be based on instructions received from the interface server application.

In client/server-based embodiments, control circuitry 604 may include communications circuitry suitable for communicating with a server or other networks or servers. The interface server application may be a stand-alone application implemented on a device or a server. The interface server application may be implemented as software or a set of executable instructions. The instructions for performing any of the embodiments discussed herein of the interface server application may be encoded on non-transitory computer-readable media (e.g., a hard drive, random-access memory on a DRAM integrated circuit, read-only memory on a BLU-RAY disk, etc.). For example, in FIG. 3, the instructions may be stored in storage 608, and executed by control circuitry 604 of a device 600.

In some embodiments, the interface server application may be a client/server application where only the client application resides on device 600 (e.g., device 104), and a server application resides on an external server (e.g., server 704 and/or server 704). For example, the interface server application may be implemented partially as a client application on control circuitry 604 of device 600 and partially on server 704 as a server application running on control circuitry 711. Server 704 may be a part of a local area network with one or more of devices 600, 601 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 704 and/or an edge computing device), referred to as “the cloud.” Device 600 may be a cloud client that relies on the cloud computing capabilities from server 704 to determine whether processing (e.g., at least a portion of virtual background processing and/or at least a portion of other processing tasks) should be offloaded from the mobile device and facilitate such offloading. When executed by control circuitry of server 704, the interface server application may instruct control circuitry 711 to perform processing tasks for the client device and facilitate the automated radial blurring. The client application may instruct control circuitry 604 to determine whether processing should be offloaded. In some embodiments, the video conference may correspond to one or more of online meetings, virtual meeting rooms, video calls, Internet Protocol (IP) video calls, etc.

Control circuitry 604 may include communications circuitry suitable for communicating with a server, edge computing systems and devices, a table or database server, or other networks or servers The instructions for carrying out the above-mentioned functionality may be stored on a server (which is described in more detail in connection with FIG. 7. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 7).

In addition, communications circuitry may include circuitry that enables peer-to-peer communication of user devices, or communication of user devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as the interface server application data described above. Nonvolatile memory may also be used (e.g., to launch a boot-up routine and other instructions). Cloud-based storage, described in more detail in relation to FIG. 7, may be used to supplement storage 608 or instead of storage 608.

Control circuitry 604 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 604 may also include scaler circuitry for upconverting and downconverting content into the preferred output format of user 600. Control circuitry 604 may also include digital-to-analog converter circuitry and analog-to-digital converter circuitry for converting between digital and analog signals. The tuning and encoding circuitry may be used by user device 600, 601 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user device 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user device 600 and user device 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 615.

Audio output equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of device 600 and equipment 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words or terms or numbers that are received by the microphone and converted to text by control circuitry 604. In a further example, a user may voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card.

The interface server application may be implemented using any suitable architecture. For example, it may be a stand-alone application wholly implemented on each one of user device 600 and user device 601. In such an approach, instructions of the application may be stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to provide video conferencing functionality and generate any of the displays discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 604 may allow a user to provide user profile information or may automatically compile user profile information. For example, control circuitry 604 may access and monitor network data, video data, audio data, processing data, participation data from a conference participant profile. Control circuitry 604 may obtain all or part of other user profiles that are related to a particular user (e.g., via social media networks), and/or obtain information about the user from other sources that control circuitry 604 may access. As a result, a user can be provided with a unified experience across the user's different devices.

In some embodiments, the interface server application is a client/server-based application. Data for use by a thick or thin client implemented on each one of user device 600 and user device 601 may be retrieved on-demand by issuing requests to a server remote to each one of user device 600 and user device 601. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on device 600. This way, the processing of the instructions is performed remotely by the server while the resulting displays (e.g., that may include text, a keyboard, or other visuals) are provided locally on device 600. Device 600 may receive inputs from the user via input interface 310 and transmit those inputs to the remote server for processing and generating the corresponding displays. For example, device 600 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to device 600 for presentation to the user.

In some embodiments, the interface server application may be downloaded and interpreted or otherwise run by an interpreter or virtual machine (run by control circuitry 604). In some embodiments, the interface server application may be encoded in the ETV Binary Interchange Format (EBIF), received by control circuitry 604 as part of a suitable feed, and interpreted by a user agent running on control circuitry 604. For example, the interface server application may be an EBIF application. In some embodiments, the interface server application may be defined by a series of JAVA-based files that are received and run by a local virtual machine or other suitable middleware executed by control circuitry 604. In some of such embodiments (e.g., those employing MPEG-2, MPEG-4, HEVC or any other suitable digital media encoding schemes), the interface server application may be, for example, encoded and transmitted in an MPEG-2 object carousel with the MPEG audio and video packets of a program.

FIG. 7 is a diagram of an illustrative system 700 for enabling user controlled extended reality, in accordance with some embodiments of this disclosure. User devices 707, 708, 710 (which may correspond to, e.g., user device 600 or 601) may be coupled to communication network 709. Communication network 709 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 709) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user devices may also communicate with each other directly through an indirect path via communication network 709.

System 700 may comprise media content source 702, one or more servers 704, and/or one or more edge computing devices. In some embodiments, the interface server application may be executed at one or more of control circuitry 711 of server 704 (and/or control circuitry of user devices 707, 708, 710 and/or control circuitry of one or more edge computing devices). In some embodiments, the media content source and/or server 704 may be configured to host or otherwise facilitate video communication sessions between user devices 707, 708, 710 and/or any other suitable user devices, and/or host or otherwise be in communication (e.g., over network 709) with one or more social network services.

In some embodiments, server 704 may include control circuitry 711 and storage 714 (e.g., RAM, ROM, Hard Disk, Removable Disk, etc.). Storage 714 may store one or more databases. Server 704 may also include an input/output path 712. I/O path 712 may provide video conferencing data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 (and specifically control circuitry) to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 711 executes instructions for an emulation system application stored in memory (e.g., the storage 714). Memory may be an electronic storage device provided as storage 714 that is part of control circuitry 711.

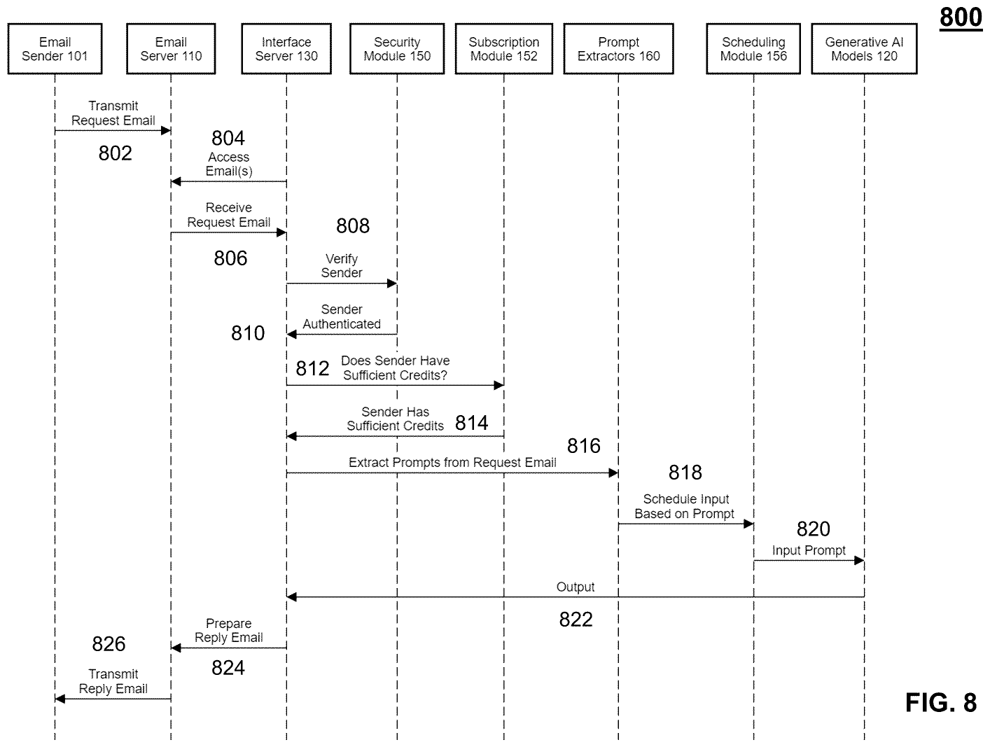

The sequence diagram in FIG. 8 depicts a process for generating and delivering content based on prompts received via email. In some embodiments, a system performing such a process may comprise an email server, an interface server, a security module, a subscription module, a prompt extractors module, a scheduling module, and a generative AI models module. For instance, process 800 of FIG. 8 involves several components: Email Sender 101, Email Server 110, Generative AI Models 120, Interface Server 130, Security Module 150, Subscription Module 152, Scheduling Module 156, and Prompt Extractors 160. This sequence represents, e.g., a robust and secure method for processing user requests via email, incorporating advanced AI models, and ensuring the integrity and efficiency of the process. It is a key component of the patent application.

In process 800 of FIG. 8, Email Server 110 is configured to receive and transmit emails from and to an email sender. Email Sender 101 may be a device of a user who, e.g., requests content generation by sending an email with one or more prompts to the email server. A prompt may be considered a text (or multimedia) input that specifies, e.g., the type, format, and/or topic of the desired content.

Interface Server 130 may be configured to communicate with Email Server 110 and the other modules of the system. Interface Server 130 accesses the email(s) sent by the email sender to access a request email, which is the email that contains the prompt(s). In some embodiments, Interface Server 130 may also prepare and/or send the reply email, which is an email that comprises the AI-generated content.

Security Module 150 may be configured to verify the identity and authenticity of the email sender. In some embodiments, Security Module 150 performs authentication procedures such as checking the email address, password, and/or other credentials of the email sender. In some embodiments, Security Module 150 ensures that only authorized and legitimate users can access the system and request content generation.

Subscription Module 152 may be configured to check the subscription status and credit balance of the email sender. In some embodiments, Subscription Module 152 determines whether the email sender has a valid and active subscription to the system and whether the email sender has sufficient credits to request content generation. In some embodiments, Subscription Module 152 may also deduct credits from the email sender's account based on the number and complexity of the prompts.

Prompt Extractors 160 may be configured to extract the prompts from the request email and parse them into structured and standardized formats. In some embodiments, Prompt Extractors 160 may include an NLP module. In some embodiments, Prompt Extractors 160 may also perform preprocessing tasks such as removing noise, correcting spelling and grammar errors, and/or validating the prompts.

Scheduling Module 156 may be configured to schedule the input of the prompts to Generative AI Models 120 based on the priority, urgency, and/or difficulty of the prompts. In some embodiments, Scheduling Module 156 may also optimize the resource allocation and utilization of Generative AI Models 120.

Generative AI Models 120 may be configured to generate content based on the prompts using one or more artificial intelligence models. Generative AI Models 120 may use different models for different types of content, such as natural language, code, images, music, etc. Generative AI Models 120 may also use feedback mechanisms to improve the quality and relevance of the generated content.

Process 800 may begin with Email Sender 101 transmitting a request email to Email Server 110. This represents, e.g., the initiation of a communication request from a user or system. Interface Server 130 then accesses the email(s) from Email Server 110, signifying the retrieval of the user's request. A receive request email is sent from Email Server 110 to Interface Server 130, indicating the successful transmission of the email. Interface Server 130 then interacts with Security Module 150 to verify the sender. This step may ensure the authenticity of the sender and protects against unauthorized access.

Once the sender is authenticated, Interface Server 130 checks with Subscription Module 152 to confirm if the sender has sufficient credits. This step, e.g., validates the sender's subscription status and ensures they have the necessary resources to proceed. Upon confirmation of sufficient credits, Interface Server 130 interacts with Prompt Extractors 160 to extract prompts from the request email. This step involves parsing the email content to identify the user's request or command. The extracted prompts are then scheduled based on their nature by Scheduling Module 156. This step organizes the processing of the prompts according to predefined rules or algorithms.

The scheduled prompts are input into Generative AI Models 120. These models process the prompts and generate the required output. The output from Generative AI Models 120 is delivered back to Interface Server 130, which may prepare the reply email. Then, the prepared reply email may be transmitted to Email Sender 101 via Email Server 110, completing the process.

FIG. 9 is a schematic diagram of an exemplary queue system 900 for a service that provides various tasks to an artificial intelligence platform, according to some embodiments of the present disclosure. The queue system 900 comprises a plurality of tasks 910, each having a set of attributes 920. The attributes 920 include, but are not limited to, a queue number 921, a submitted date and time 922, deadline date and time 923, email address 924, subscriber ID 925, credits remaining 926, and prompt 927. In some embodiments, tasks 910 may be put into queue system 900, e.g., by an interface server in conjunction with a scheduling module, based on a priority assigned based on a prompt. For instance, if a request email indicates that a memo needs to be drafted before 8:00 AM tomorrow, then the interface server in conjunction with a scheduling module will prioritize the task accordingly by either completing the task during a scheduled window or during less popular times (e.g., 3:00 to 5:00 AM).

The queue number 921 is an index that indicates the order of the tasks 910 in the queue system 900. The tasks 910 are processed by the service in a first-in, first-out (FIFO) manner, based on the queue number 921. The submitted date and time 922 is a timestamp that indicates when the task 910 was submitted to the service by a user. The deadline date and time 923 is a timestamp that indicates when the user expects to receive the result of the task 910 from the service. The email address 924 is an identifier that indicates the user who submitted the task 910 to the service. The subscriber ID 925 is an identifier that indicates the subscription status of the user. The subscription status determines the amount of credits that the user has to use the service. The credits remaining 926 is a value that indicates the number of credits that the user has left to use the service. The prompt 927 is a request that indicates the type and content of the task 910 that the user wants the AI platform to perform.

The queue system 900 is configured to receive the tasks 910 from the users, assign the attributes 920 to the tasks 910, store the tasks 910 in a database, and send the tasks 910 to the AI platform for processing. The queue system 900 is further configured to receive the results of the tasks 910 from the AI platform, store the results in the database, and send the results to the users via email or other communication channels.

Queue scheduling system 900 below shows an example of the queue system 900 with 90 tasks 910 and their corresponding attributes 920, according to some embodiments of the present disclosure.

Queue scheduling system 900 is a representation of a queue system for a service that allows users to submit various tasks to an AI platform, such as Copilot. Queue scheduling system 900 has, e.g., 10 rows and 7 columns, each containing different information about the tasks and the users.

The first column, Queue, is a numerical index that indicates the order of the tasks 910 in the queue system 900. The tasks 910 are assigned a queue number 921 from 0 to 9, with 0 being the first task 910 to be processed and 9 being the last. The queue system 900 operates on a first-in, first-out (FIFO) basis, meaning that the tasks 910 are processed by the service in the same order as they are submitted by the users. In some embodiments, queue number 921 may shift based on new high-priority tasks and/or an approaching deadline 923.

The second column, Submitted Date and Time 922, may be a timestamp that indicates when the task 910 was submitted to the service by a user. The timestamp is in the format of YYYY-MM-DD HH: MM: SS, where YYYY is the year, MM is the month, DD is the day, HH is the hour, MM is the minute, and SS is the second. The timestamp is based on the local time zone of the user, which is GMT-05:00 in this case. The timestamp is assigned to the task 910 as a submitted date and time 922.

The third column, Deadline Date and Time 923, may be a timestamp that indicates when the user expects to receive the result of the task 910 from the service. The timestamp is in the same format and time zone as the submitted date and time 922. The deadline is set by the user based on their preference and urgency of the task 910. The timestamp is assigned to the task 910 as a deadline date and time 923. In some embodiments, no deadline may be specified and/or assigned.

The fourth column, Email Address 924 that originated the task, is a string that indicates the email address of the user who submitted the task 910 to the service. The email address is typically composed of a local part, an @ symbol, and a domain name. For example, joc@sample.com is an email address where joe is the local part and sample.com is the domain name. The email address is assigned to the task 910 as an email address 924. In some embodiments, the email address may refer to a phone number or other address.

The fifth column, Subscriber ID 925, is a numerical identifier that indicates the subscription identifier number of the user who submitted the task 910 to the service. In some embodiments, some subscribers may have multiple email addresses attached to their subscriber ID.

The sixth column, Credits Remaining 926, is a numerical value that indicates the number of credits that the user has left to use the service after submitting the task (e.g., and the task is fulfilled). The credits are deducted from the user's account every time they submit a task 910 to the service. The credits remaining is a number, e.g., in a range from 0 to 35 (if 35 were allocated each month). In some embodiments, credits may be allotted on a per day basis. The lower the credits remaining, the fewer tasks 910 the user can submit. In some embodiments, if there are insufficient credits, an email may be sent indicating there are insufficient credits and/or offering an opportunity to purchase more. In some embodiments, if there are insufficient credits, an email may be sent indicating an opportunity to wait until a specific time. In some embodiments, limits on tasks/credits may be based on frequency of use over a period of time (e.g., 24 hours, a week, each month, etc.) and/or a history of a subscriber's use/abuse of the platform.

The seventh column, Prompt 927, is a string that indicates the type and content of the task 910 that the user wants the AI platform to perform. The prompt is a brief request that specifies what the user wants the AI platform to do. For example, “Write a blog post about the benefits of meditation” is a prompt that asks the AI platform to generate a blog post on the given topic. The prompt can vary in length and complexity depending on the user's needs and preferences. The prompt is assigned to the task 910 as a prompt 927.

The other columns in each row show the attributes 920 of the corresponding task 910. For example, the first row (row 0) shows that the task 910 was submitted by joe@sample.com at 2024 Feb. 18 10:25:00, with a deadline of 2024 Feb. 18 11:00:00. The user has a subscriber ID 925 of 923, which means they have a low subscription status and a limited number of credits to use the service. The user has 12 credits remaining 926, which means they can submit 12 more tasks 910 to the service. The prompt 927 of the task 910 is to write a blog post about the benefits of meditation, which means the user wants the AI platform to generate a blog post on that topic. The other rows show the similar information for the other tasks 910 and users.

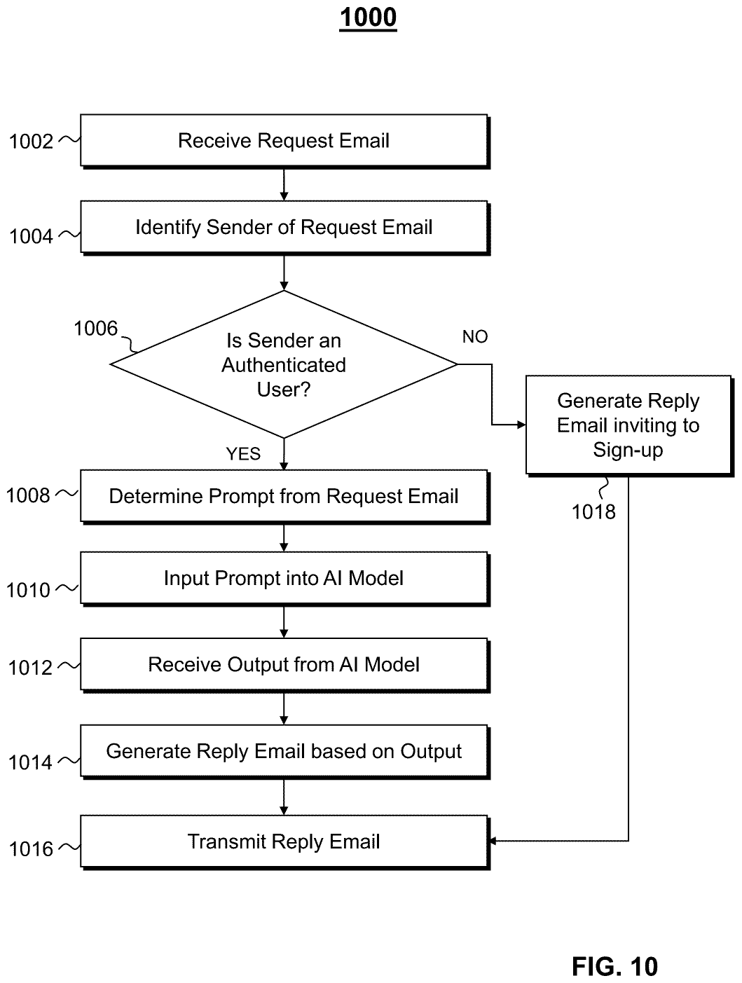

FIG. 10 depicts a flowchart describing a method for processing request emails, according to some embodiments of the present disclosure. In some embodiments, at step 1002, the method may include receiving a request email from a sender. At step 1004, the method may include identifying the sender of the request email. At step 1006, the method may include determining whether the sender may be an authenticated user. Some embodiments may use a security module to, e.g., authenticate a user/subscriber. At step 1008, the method may include, if the sender may be not an authenticated user, generating a reply email inviting the sender to sign up. At step 1010, the method may include, if the sender may be an authenticated user, determining a prompt from the request email and inputting the prompt into the AI model. At step 1012, the method may include receiving an output from the AI model based on the prompt. At step 1014, the method may include generating a reply email based on the output. At step 1016, the method may include transmitting the reply email to the sender.

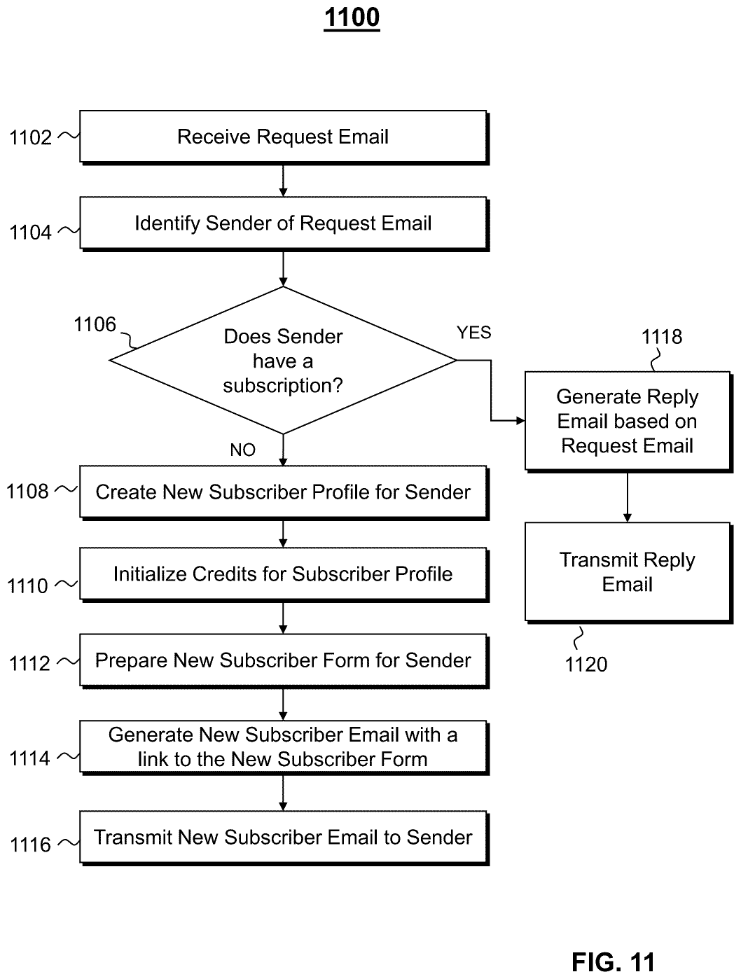

FIG. 11 depicts a flowchart describing a method for processing, according to some embodiments of the present disclosure. In some embodiments, at step 1102, the method may include receiving a request email. At step 1104, the method may include identifying a sender of the request email. At step 1106, the method may include determining whether the sender has a subscription. Some embodiments may use a security module to, e.g., authenticate a user/subscriber. At step 1108, the method may include generating a reply email based on the request email. At step 1110, the method may include transmitting the reply email to the sender. At step 1112, the method may include creating a new subscriber profile for the sender. At step 1114, the method may include initializing credits for the subscriber profile. At step 1116, the method may include preparing a new subscriber form for the sender. At step 1118, the method may include generating a new subscriber email with a link to the new subscriber form. At step 1120, the method may include transmitting the new subscriber email to the sender. The method may include the steps of 1102 to 1120. If the sender may have a subscription, the method may include 1108 to 1110. If the sender may do not have a subscription, the method may include steps 1112 to 1120.

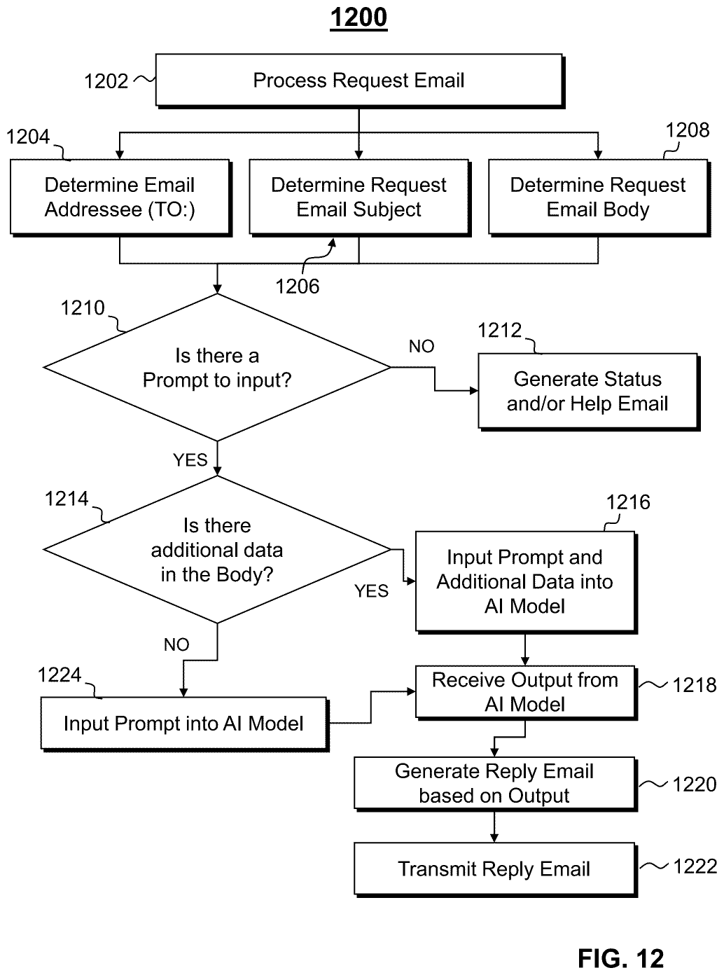

FIG. 12 depicts a flowchart describing a method for processing a request email, according to some embodiments of the present disclosure. In some embodiments, at step 1202, the method may include receiving and processing a request email. Some embodiments may use one or more prompt extractors to, e.g., determine a prompt. At step 1204, the method may include determining an email addressce of the request email, e.g., in order to check for a prompt. At step 1206, the method may include checking for a prompt in the subject line of the request email. At step 1208, the method may include checking for a prompt in the body of the request email.

At step 1210, the method may include, determining if there is a prompt in one or more of the email addressce, the subject line, an/or the email body. If a prompt is not found, at step 1212, the method may include generating a status and/or help email. For example, a help email may include a link to instructions for the subscriber to use to include a prompt.

If a prompt is found, then at step 1214, the method may include checking for additional data in the body of the request email. At step 1216, the method may include, if additional data may be present, inputting the prompt and the additional data into an AI model. At step 1224, the method may include, if no additional data may be present, inputting only the prompt into the AI model.

At step 1218, the method may include receiving an output from the AI model. At step 1220, the method may include generating a reply email based on the output. At step 1222, the method may include transmitting the reply email, e.g., to the email sender or other designated email address.

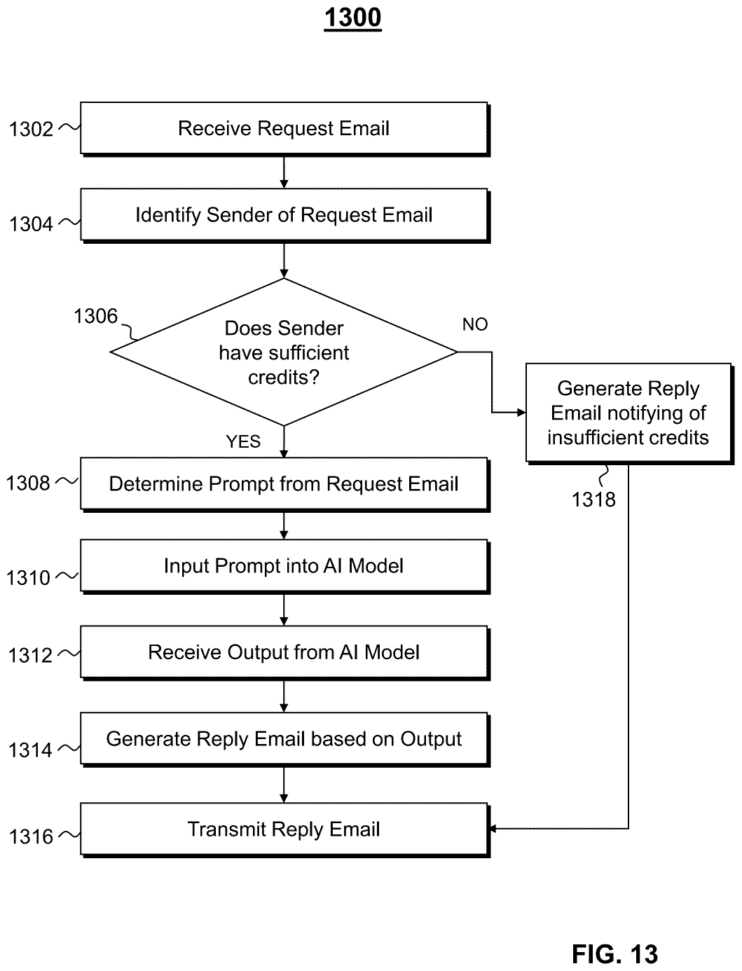

FIG. 13 depicts a flowchart describing a method for processing, according to some embodiments of the present disclosure. In some embodiments, at step 1302, the method may include receiving a request email. At step 1304, the method may include identifying a sender of the request email. At step 1306, the method may include determining whether the sender has sufficient credits. Some embodiments may use an interface sever working in conjunction with a subscriber module and/or billing module to determine whether the subscriber associated with the sender email has sufficient credits available.

At step 1312, the method may include determining a prompt from the request email. At step 1310, the method may include inputting the prompt into an AI model. At step 1312, the method may include receiving an output from the AI model. At 1314, the method may include generating a reply email based on the output. At 1316, the method may include transmitting the reply email to the sender.

At step 1318, the method may include generating a reply email notifying of insufficient credits. Some embodiments may not use an AI model to generate an email notifying there is insufficient credits as algorithmically generated emails may be sufficient. Then, at step 1316, the method may include transmitting the reply email to the sender.

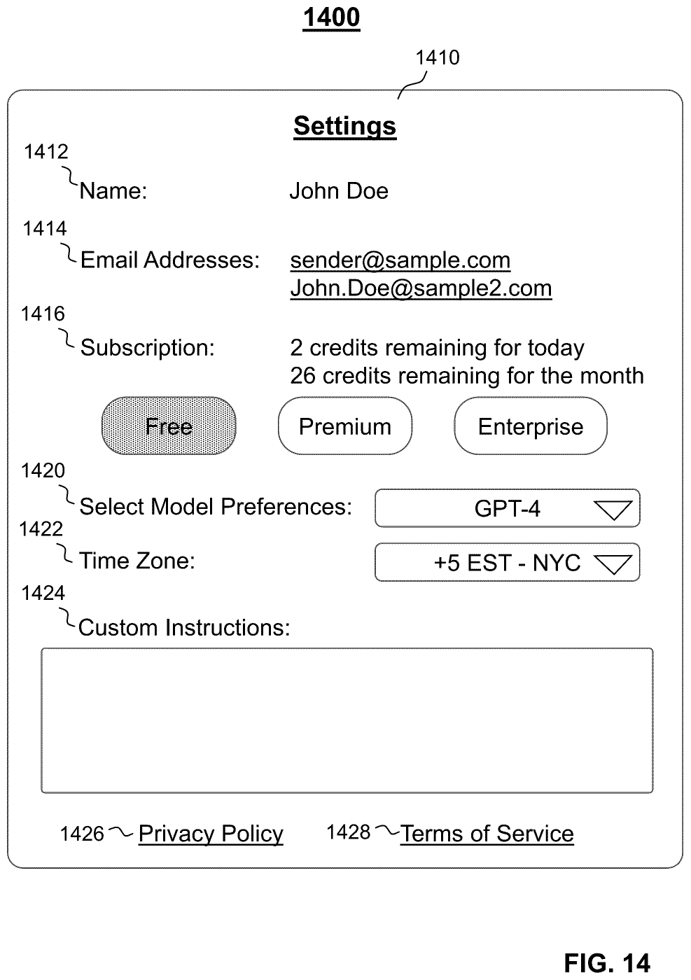

FIG. 14 is an exemplary user interface for adjustable settings to be used when processing request emails using a Gen AI platform for a subscriber, in accordance with some embodiments of this disclosure. More specifically, FIG. 14 is a diagram illustrating an exemplary embodiment of an interface 1410 for settings of a generative AI email platform. The interface 1410 is configured to allow users to customize various aspects of their interactions with the generative AI email platform, such as their profile information, subscription details, model preferences, time zone, custom instructions, and privacy and terms policies.

The interface 1410 includes a Name section 1412, which displays the user's name, such as “John Doe”. The Name section 1412 enables the user to personalize their profile and identity on the generative AI email platform. The user may edit or update their name by selecting the Name section 1412 and entering a new name.

The interface 1410 also includes an Email Address(es) section 1414, which lists the user's email addresses, such as “sender@sample.com” and “John. Doe@sample2.com”. The Email Address(es) section 1414 enables the user to manage multiple email accounts on the generative AI email platform. The user may add, remove, or switch between email addresses by selecting the Email Address(es) section 1414 and performing the desired actions.

The interface 1410 further includes a Subscription section 1416, which shows the user's subscription status, such as “2 credits remaining for today” and “26 credits remaining for the month”. The Subscription section 1416 enables the user to monitor their usage and consumption of the generative AI email platform. The user may also choose between different subscription plans, such as “Free”, “Premium”, or “Enterprise”, by selecting the corresponding buttons on the Subscription section 1416. Selecting a different subscription plan may initiate a subscription upgrade process at another page.

The interface 1410 additionally includes a Model Selection section 1420, which allows the user to select from various AI models, such as GPT-3.5, GPT-4, StableDiffusion, and more. The Model Selection section 1420 enables the user to specify their preferred AI model for generating content on the generative AI email platform. The user may select a different AI model by selecting the Model Selection section 1420 and choosing from the available options. The selected AI model may be dynamic based on the prompt, but a preference may be given in the Model Selection section 1420.

The interface 1410 also includes a Time Zone section 1422, which displays the user's time zone, such as “+5 EST-NYC”. The Time Zone section 1422 enables the user to set their local time zone for the generative AI email platform. The user may change their time zone by selecting the Time Zone section 1422 and entering a new time zone. Setting the correct time zone can help keep the scheduling of the generative AI email platform on track, so that when the user requests something generated at a specific time, the interface server can facilitate its generation at the right time.

The interface 1410 further includes a Custom Instructions section 1424, which allows the user to add preferences or requirements that they would like the AI model to consider when generating its responses. The Custom Instructions section 1424 enables the user to provide additional context or guidance to the AI model for producing more personalized and relevant content. The user may enter or edit their custom instructions by selecting the Custom Instructions section 1424 and typing in their desired inputs. The AI model will consider the custom instructions every time it responds, so the user won't have to repeat their preferences or information in every emailed or submitted prompt.

Interface 1410 includes links to a Privacy Policy section 1426 and a Terms of Service section 1428, which provide the user with access to the generative AI email platform's policies and terms. The Privacy Policy section 1426 and the Terms of Service section 1428 enable the user to review and understand how the generative AI email platform handles their data and what their rights and obligations are when using the platform. The user may view the privacy policy and the terms of service by selecting the respective links on the interface 1410.

For example, a privacy policy for a generative AI via email platform should clearly state what user data is collected, how it's used, and users' rights over their data, including access and deletion. It should also describe how the AI generates content, the sources of input data, and any measures taken to ensure user privacy during training. Addressing potential risks like bias or misinformation in generated content and outlining moderation measures is crucial. Additionally, the policy should emphasize security measures implemented to protect user data, such as encryption and access controls, along with compliance with relevant privacy laws like GDPR or CCPA. Providing clear contact information for privacy concerns and outlining procedures for handling data breaches further enhances transparency and user trust. Overall, the privacy policy aims to inform users about data practices, mitigate risks associated with AI-generated content, and demonstrate commitment to privacy and security standards. Generative AI is improving but users should beware of errors and hallucinations.

As another example, the terms of service for a generative AI via email platform should address users' conduct and responsibilities must be clearly outlined, specifying prohibited activities and the consequences of violating the terms, including account suspension or termination. Additionally, users should be held responsible for the accuracy and legality of the content they submit, with provisions for compliance with relevant laws and regulations. Limitation of liability clauses should be included to protect the application provider from damages arising from use or inability to use the application, while also specifying exceptions to liability limitations. Finally, provisions for dispute resolution, such as arbitration or mediation, should be established to address any disputes or claims arising from the terms of service, along with information about jurisdiction and legal procedures. These measures help establish clear guidelines for users, protect the interests of the application provider, and ensure compliance with legal requirements. A generative AI via email platform can help to limit abuse of generative AI but enforcing a strong terms of service will still be necessary.

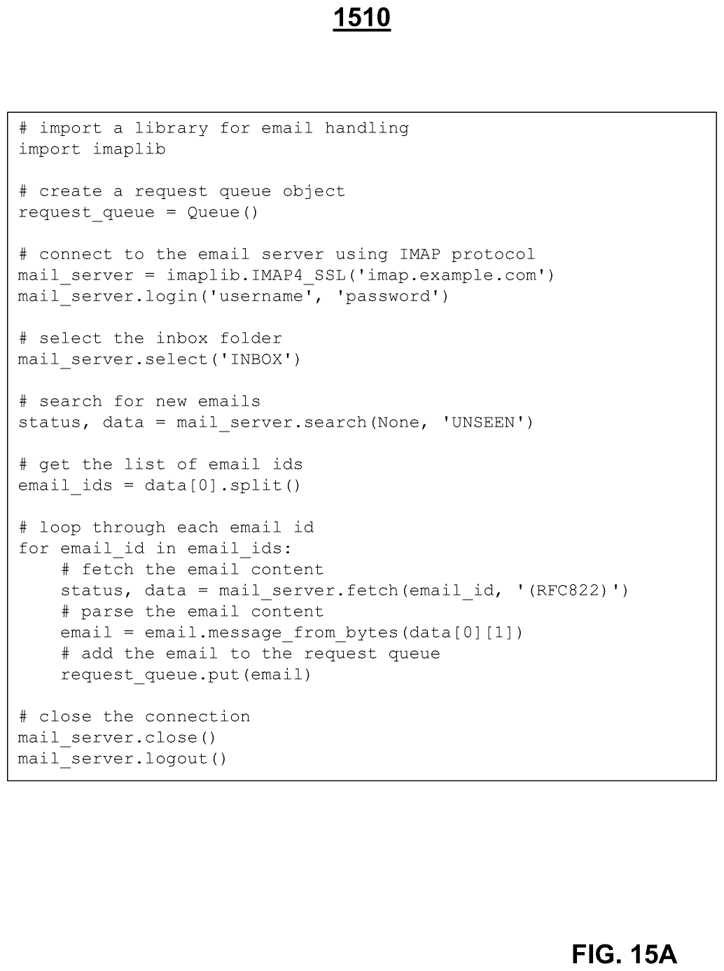

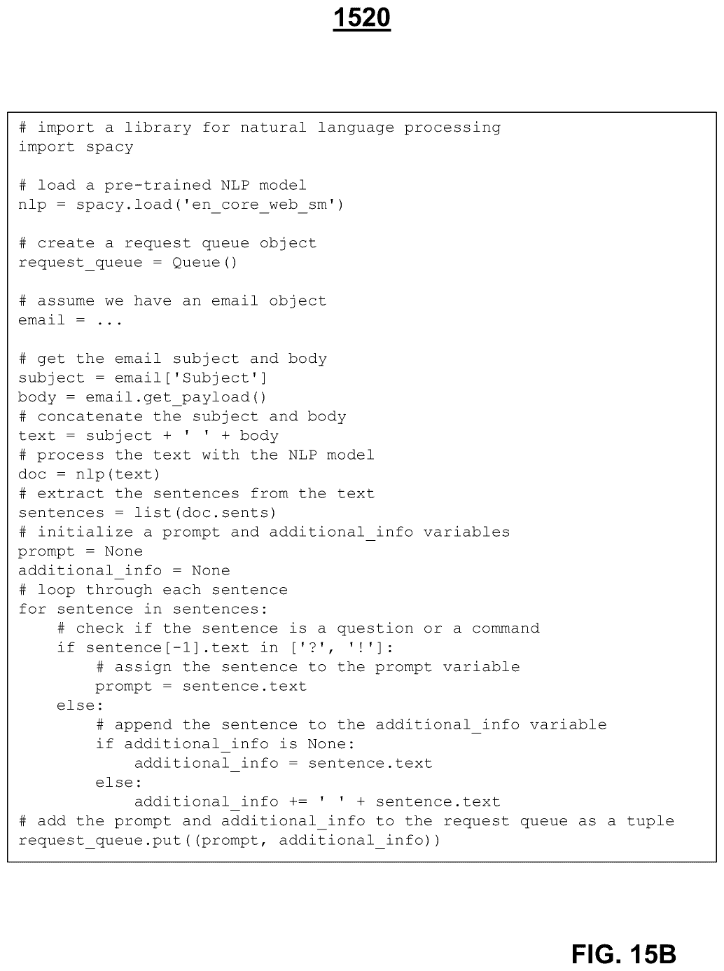

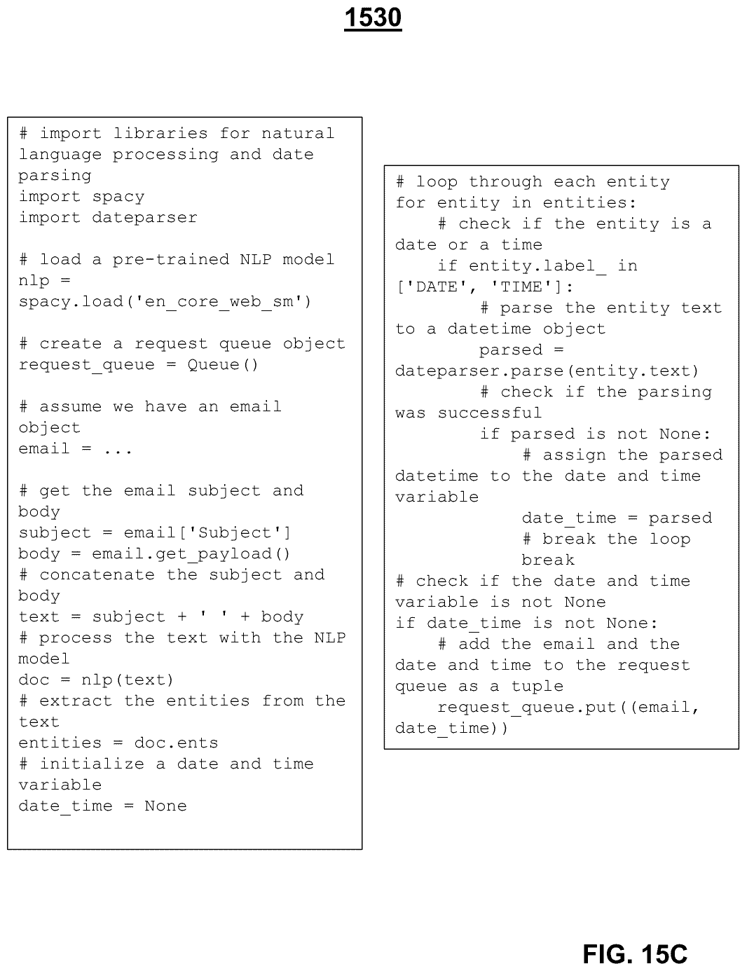

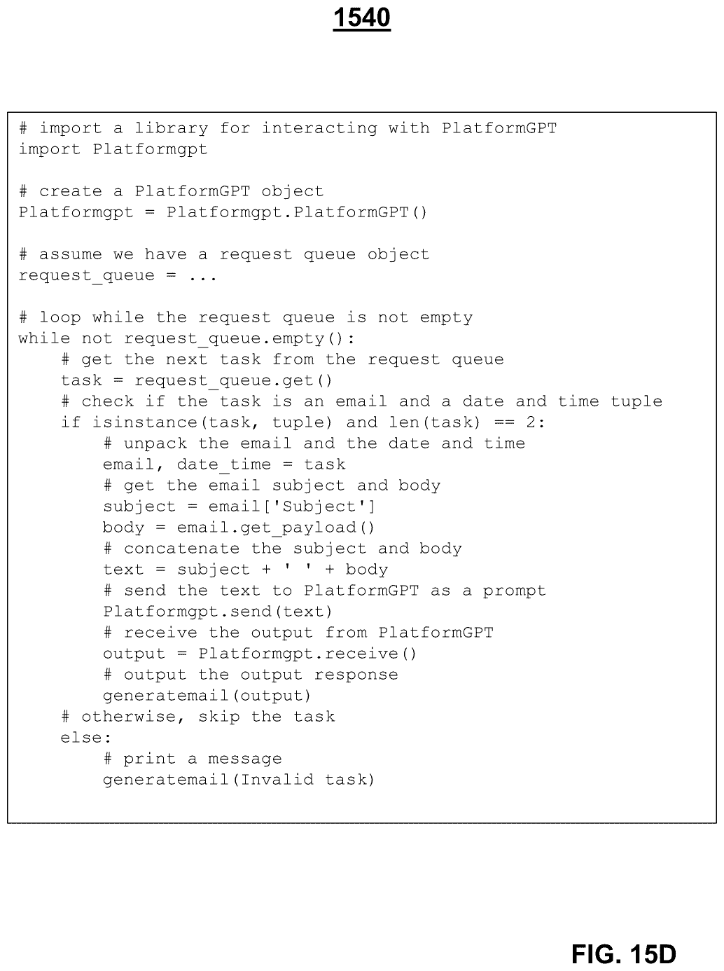

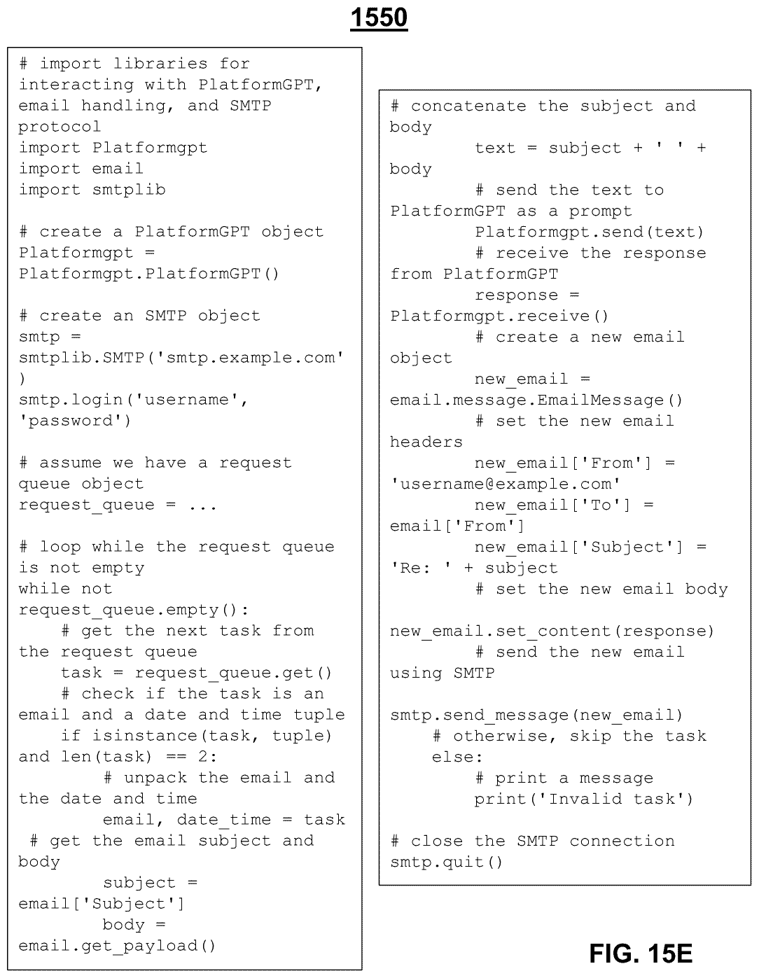

FIG. 15A is a diagram depicting pseudo code for accessing an email server to download new emails to add to a request queue, in accordance with some embodiments of this disclosure. For instance, FIG. 15A depicts pseudo code for processing email requests using a request queue, according to an embodiment of the present disclosure, is illustrated in FIG. 15A. The script in FIG. 15A starts by importing a library for email handling. The library may provide functions or methods for interacting with an email server using an Internet Message Access Protocol (IMAP) or any other protocol.

Next, a request queue object is created. The request queue may store and retrieve email requests in a first-in, first-out (FIFO) manner. The request queue may use a list, an array, a linked list, a queue, or any other suitable data structure. Then, a connection to the email server is established using the IMAP protocol. The connection may require a username and a password for authentication. The email server may host or manage email accounts and messages for one or more users. After that, the inbox folder of the email account is selected. The inbox folder may be the default or primary folder that stores incoming email messages for the user. The selection of the inbox folder may allow accessing or manipulating the email messages in the folder. Subsequently, a search for new email messages is performed. The search may use a criterion or a filter that specifies the desired email messages to be retrieved. For example, the criterion may be ‘UNSEEN’, which means that only email messages that have not been marked as read or seen by the user are retrieved.

Next in the script, a list of email ids is obtained from the search result. The email ids may be unique identifiers or numbers that correspond to each email message in the inbox folder. The email ids may be used to fetch the email content from the email server. Next, a loop is initiated to iterate through each email id in the list. For each email id, the following actions are performed:
The email content is fetched from the email server using the email id and the RFC822 format. The RFC822 format is a standard format for text messages that are sent using electronic mail systems. The email content may include the header, the body, and any attachments of the email message.
The email content is parsed using a function or a method that converts the email content from bytes to an email object. The email object may be a representation or a model of the email message that allows accessing or manipulating its attributes or properties, such as the sender, the recipient, the subject, the date, the content type, etc.
The email object is added to the request queue. The request queue may store the email object until it is processed by another component or module of the system.
The loop ends after all the email ids in the list have been processed. Finally, the connection to the email server is closed and logged out. The method ends at this point.

FIG. 15B is a diagram depicting pseudo code for accessing an email server to download new emails to process, identify a prompt, and add to a request queue, in accordance with some embodiments of this disclosure. For instance, FIG. 15B depicts pseudo code for processing an email using natural language processing with the spacy library, according to an embodiment of the present disclosure, is illustrated in FIG. 15B. The method begins by importing the spacy library for natural language processing. The spacy library may provide functions or methods for analyzing, extracting, and manipulating natural language text.

Next, a pre-trained NLP model is loaded into a variable named nlp. The NLP model may be any suitable model that has been trained on a large corpus of text and can perform various natural language tasks, such as tokenization, lemmatization, part-of-speech tagging, named entity recognition, dependency parsing, etc. In this example, the NLP model is ‘en_core_web_sm’, which is a small English model that can perform the basic natural language tasks.

Then, a request queue object is created named request_queue. The request queue may store and retrieve email requests in a first-in, first-out (FIFO) manner. The request queue may use a list, an array, a linked list, a queue, or any other suitable data structure.

After that, an assumption is made that there is an email object named email. The email object may be a representation or a model of an email message that allows accessing or manipulating its attributes or properties, such as the sender, the recipient, the subject, the date, the content type, etc.

Subsequently, the email subject and body are extracted from the email object and concatenated into a string named text. The email subject may be the title or the summary of the email message, and the email body may be the main content or the message of the email. The concatenation of the email subject and body may allow processing the whole email as a single text. Then, the text is processed with the NLP model, resulting in a doc object. The doc object may be a container or a sequence of tokens that have been analyzed and annotated by the NLP model. The doc object may allow accessing or manipulating the tokens and their attributes or properties, such as the text, the lemma, the part-of-speech, the named entity, the dependency, etc.

Next, the sentences are extracted from the doc object into a list named sentences. The sentences may be the units or the segments of the text that are separated by punctuation marks, such as periods, question marks, or exclamation points. The extraction of the sentences may allow processing the text at a sentence level.

Then, two variables, prompt and additional_info, are initialized. The prompt variable may store the question or the command that is extracted from the email, and the additional_info variable may store the additional information that is extracted from the email.

Next, a loop is initiated to iterate through each sentence in sentences. For each sentence, the following actions are performed:
The sentence is checked if it is a question or a command by looking at the last character of the sentence. If the last character is a question mark or an exclamation point, the sentence is considered as a question or a command, respectively.
If the sentence is a question or a command, the sentence is assigned to the prompt variable. The prompt variable may store only one question or command from the email and may overwrite any previous question or command that was assigned to it.
If the sentence is not a question or a command, the sentence is appended to the additional_info variable. The additional_info variable may store all the sentences that are not questions or commands from the email and may concatenate them with spaces.
The loop ends after all the sentences in sentences have been processed. Finally, both prompt and additional_info are added as a tuple to request_queue. The tuple may store the question or command and the additional information that are extracted from the email and may be processed by another component or module of the system. The method ends at this point.

FIG. 15C is a diagram depicting pseudo code for accessing an email server to download new emails to process, identify a due date and time, and add to a request queue, in accordance with some embodiments of this disclosure. For instance, FIG. 15C depicts pseudo code for processing an email using natural language processing and date parsing, according to an embodiment of the present disclosure, is illustrated in FIG. 15C. The method starts by importing the spacy library for natural language processing and the dateparser library for date parsing. The spacy library may provide functions or methods for analyzing, extracting, and manipulating natural language text. The dateparser library may provide functions or methods for parsing dates and times from text.

Next, a pre-trained NLP model is loaded into a variable named nlp. The NLP model may be any suitable model that has been trained on a large corpus of text and can perform various natural language tasks, such as tokenization, lemmatization, part-of-speech tagging, named entity recognition, dependency parsing, etc. In this example, the NLP model is ‘en_core_web_sm’, which is a small English model that can perform the basic natural language tasks.

Then, a request queue object is created named request_queue. The request queue may store and retrieve email requests in a first-in, first-out (FIFO) manner. The request queue may use a list, an array, a linked list, a queue, or any other suitable data structure.

After that, an assumption is made that there is an email object named email. The email object may be a representation or a model of an email message that allows accessing or manipulating its attributes or properties, such as the sender, the recipient, the subject, the date, the content type, etc. Subsequently, the email subject and body are extracted from the email object and concatenated into a string named text. The email subject may be the title or the summary of the email message, and the email body may be the main content or the message of the email. The concatenation of the email subject and body may allow processing the whole email as a single text.

Then, the text is processed with the NLP model, resulting in a doc object. The doc object may be a container or a sequence of tokens that have been analyzed and annotated by the NLP model. The doc object may allow accessing or manipulating the tokens and their attributes or properties, such as the text, the lemma, the part-of-speech, the named entity, the dependency, etc. Next, the entities are extracted from the doc object into a variable named entities. The entities may be the words or phrases that have a specific meaning or category, such as names, places, dates, times, etc. The extraction of the entities may allow processing the text at an entity level.

Then, a date and time variable is initialized. The date and time variable may store the date and time that is extracted from the email, if any. Next, a loop is initiated to iterate through each entity in entities. For each entity, the following actions are performed:
The entity is checked if it is a date or a time by looking at its label or category. If the label is ‘DATE’ or ‘TIME’, the entity is considered as a date or a time, respectively.
If the entity is a date or a time, the entity text is parsed to a datetime object using the dateparser library. The dateparser library may provide functions or methods for parsing dates and times from text in various formats and languages.
If the parsing was successful, the parsed datetime is assigned to the date and time variable. The date and time variable may store only one date and time from the email, and may overwrite any previous date and time that was assigned to it.
The loop is broken after the date and time variable is assigned.

The loop ends after all the entities in entities have been processed or the date and time variable is assigned. Finally, if the date and time variable is not None, the email and the date and time are added as a tuple to request_queue. The tuple may store the email and the date and time that are extracted from the email, and may be processed by another component or module of the system. The method ends at this point.

FIG. 15D is a diagram depicting pseudo code for working through a request queue, inputting each task from the queue into a Gen AI model, and generating an email message based on the output, in accordance with some embodiments of this disclosure. For instance, FIG. 15D depicts pseudo code for processing an email using PlatformGPT, according to an embodiment of the present disclosure, is illustrated in FIG. 15D. The method starts by importing a library named Platformgpt. The Platformgpt library may provide functions or methods for interacting with PlatformGPT, which is a conversational artificial intelligence system that can generate natural language responses based on prompts.

Next, a PlatformGPT object is created. The PlatformGPT object may allow sending and receiving messages to and from PlatformGPT using methods such as send and receive. Then, an assumption is made that there is a request queue object named request_queue. The request queue object may store and retrieve email requests in a first-in, first-out (FIFO) manner. The request queue object may use a list, an array, a linked list, a queue, or any other suitable data structure. After that, a loop is initiated to process tasks from the request queue until it is empty. Inside the loop, the following actions are performed:
The next task is obtained from the request queue using the get method. The task may be any object that is stored in the request queue.
The task is checked if it is a tuple containing an email and a date and time. The tuple may store the email and the date and time that are extracted from the email using natural language processing and date parsing, as described in FIG. 15C.
If the task is a tuple containing an email and a date and time, the email and the date and time are unpacked into two variables named email and date_time, respectively. The email may be a representation or a model of an email message that allows accessing or manipulating its attributes or properties, such as the sender, the recipient, the subject, the date, the content type, etc. The date and time may be a datetime object that represents a specific date and time.
The email subject and body are extracted from the email and concatenated into a string named text. The email subject may be the title or the summary of the email message, and the email body may be the main content or the message of the email. The concatenation of the email subject and body may allow processing the whole email as a single text.
The text is sent to PlatformGPT as a prompt using the send method of the PlatformGPT object. The prompt may be any text that is used to initiate or continue a conversation with PlatformGPT. The prompt may contain a question, a command, a statement, or any other natural language expression.
The output from PlatformGPT is received using the receive method of the PlatformGPT object. The output may be any text that is generated by PlatformGPT based on the prompt. The output may contain an answer, a response, a confirmation, a clarification, or any other natural language expression.
The output from PlatformGPT is processed by a function named generatemail. The generatemail function may perform any actions or operations based on the output from PlatformGPT, such as generating an email reply, scheduling an appointment, updating a calendar, sending a notification, etc.
If the task is not a tuple containing an email and a date and time, the task is skipped with a message “Invalid task”. The message may be printed or displayed using the generatemail function.

The loop ends after all the tasks in the request queue have been processed. The method ends at this point.

FIG. 15E is a diagram depicting pseudo code for working through a request queue, inputting each task from the queue into a Gen AI model, generating an output email message based on the output, and sending the output email message, in accordance with some embodiments of this disclosure. For instance, FIG. 15E depicts pseudo code for processing an email using PlatformGPT, according to an embodiment of the present disclosure, is illustrated in FIG. 15E. The method starts by importing the Platformgpt, email, and smtplib libraries. The Platformgpt library may provide functions or methods for interacting with PlatformGPT, which is a conversational artificial intelligence system that can generate natural language responses based on prompts. The email library may provide functions or methods for creating, parsing, and manipulating email messages. The smtplib library may provide functions or methods for sending email messages using the Simple Mail Transfer Protocol (SMTP).

Next, a PlatformGPT object is created. The PlatformGPT object may allow sending and receiving messages to and from PlatformGPT using methods such as send and receive. Then, an SMTP object is created. The SMTP object may allow establishing a connection to an email server using the SMTP protocol. The connection may require a username and a password for authentication. The email server may host or manage email accounts and messages for one or more users. After that, an assumption is made that there is a request queue object named request_queue. The request queue object may store and retrieve email requests in a first-in, first-out (FIFO) manner. The request queue object may use a list, an array, a linked list, a queue, or any other suitable data structure.

Subsequently, a loop is initiated to process tasks from the request queue until it is empty. Inside the loop, the following actions are performed:
The next task is obtained from the request queue using the get method. The task may be any object that is stored in the request queue.
The task is checked if it is a tuple containing an email and a date and time. The tuple may store the email and the date and time that are extracted from the email using natural language processing and date parsing, as described in FIG. 15C.
If the task is a tuple containing an email and a date and time, the email and the date and time are unpacked into two variables named email and date_time, respectively. The email may be a representation or a model of an email message that allows accessing or manipulating its attributes or properties, such as the sender, the recipient, the subject, the date, the content type, etc. The date and time may be a datetime object that represents a specific date and time.
The email subject and body are extracted from the email and concatenated into a string named text. The email subject may be the title or the summary of the email message, and the email body may be the main content or the message of the email. The concatenation of the email subject and body may allow processing the whole email as a single text.
The text is sent to PlatformGPT as a prompt using the send method of the PlatformGPT object. The prompt may be any text that is used to initiate or continue a conversation with PlatformGPT. The prompt may contain a question, a command, a statement, or any other natural language expression.
The response from PlatformGPT is received using the receive method of the PlatformGPT object. The response may be any text that is generated by PlatformGPT based on the prompt. The response may contain an answer, a response, a confirmation, a clarification, or any other natural language expression.
A new email object is created using the EmailMessage class of the email library. The new email object may be a representation or a model of an email message that allows setting or getting its attributes or properties, such as the headers and the body.
The new email headers are set using the _setitem_ method of the new email object. The headers may include the ‘From’, ‘To’, and ‘Subject’ fields. The ‘From’ field may be set to the username of the sender, the ‘To’ field may be set to the email address of the original sender of the email, and the ‘Subject’ field may be set to ‘Re:’ followed by the original subject of the email.
The new email body is set using the set_content method of the new email object. The body may be set to the response from PlatformGPT.
The new email is sent using the send_message method of the SMTP object. The new email may be sent to the email address specified in the ‘To’ field of the new email.
If the task is not a tuple containing an email and a date and time, the task is skipped with a message “Invalid task”. The message may be printed or displayed using the print function.

The loop ends after all the tasks in the request queue have been processed. Finally, the connection to the email server is closed using the quit method of the SMTP object. The method ends at this point.

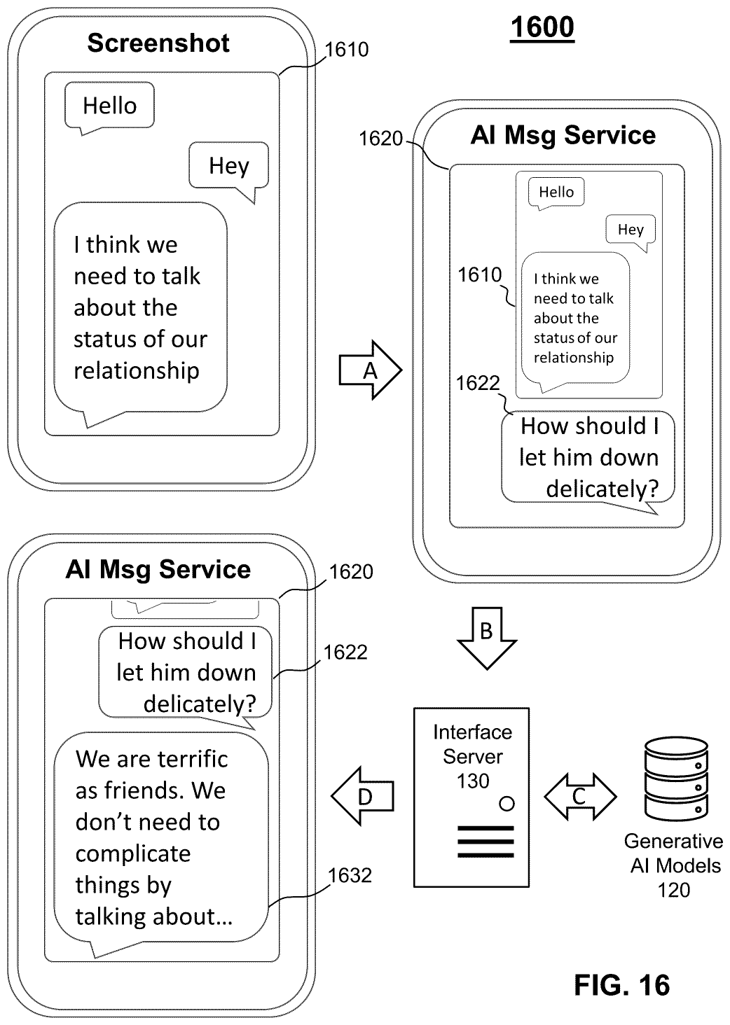

FIG. 16 depicts an illustrative flow diagram for an interface used in processing request multimedia messages using a Gen AI platform (e.g., an AI Message Service), in accordance with some embodiments of this disclosure. In some embodiments, Interface Server 130 (and/or Email Server 110) may comprise, work in conjunction with, and/or be replaced by a message server that can facilitate the sending of SMS and MMS messages, e.g., via smartphone. Messages may be, e.g., treated as emails relaying prompts or responses.

The user initiates the process by capturing screenshot 1610 on a smartphone, which contains a text message conversation with another person. The conversation includes phrases such as “Hello,” “Hey,” and “I think we need to talk about the status of our relationship.”

Following arrow A, the user sends a text message to the AI Message Service requesting advice on how to delicately address the situation presented in screenshot 1610. The text message contains prompt 1622, which is a natural language query that expresses the user's intention, such as “How should I let him down delicately.” The text message also includes screenshot 1610 as an attachment for providing additional context to the AI Message Service.

Upon receipt of the text message containing prompt 1622 and screenshot 1610 at interface server 130, at arrow B, OCR or another image-to-text method is employed to extract and convert the text within screenshot 1610 into machine-readable format. This extracted text, along with prompt 1622, is then passed onto generative AI models 120 for processing.

At bidirectional arrow C, Generative AI models 120 are tasked with generating an appropriate response based on both the extracted text from screenshot 1610 and prompt 1622. These models consider the context provided by these inputs to ensure that the response generated aligns with both the specific query and the underlying conversation tone or content. For example, the models may use natural language understanding, natural language generation, sentiment analysis, and other techniques to produce a response that is respectful, considerate, and appropriate for the given situation.

Response 1632 is generated as output from generative AI models 120 at arrow D.

Response 1632 provides a suggested reply for addressing the sensitive topic introduced in screenshot 1610 delicately. For instance, response 1632 may say: “We are terrific as friends. We don't need to complicate things by talking about . . . ” This response is then relayed back through interface server 130 to the user's smartphone.

The smartphone user receives response 1632 via their device's messaging interface where they have full autonomy over its utilization-they can choose to copy, edit, or directly send this suggested reply as their own message in continuation of their ongoing conversation captured in screenshot 1610. Alternatively, the user may ignore or discard response 1632 and compose their own message without any assistance from the AI Message Service.

This entire process depicts an application of artificial intelligence in real-time communication scenarios where users seek guidance or support in crafting messages that are sensitive or complex in nature. With interface Server 130, an AI Message Generator can leverage generative AI models to provide users with personalized and context-aware suggestions that can help them communicate more effectively and appropriately.

The systems and processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present disclosure includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, via an email server, a request email from an email sender address;
determining whether the email sender address corresponds to a registered user account;
if the email sender address corresponds to a registered user account:
determining an input prompt from the request email comprising;
providing the input prompt from the request email as input to a trained model, wherein the trained model is trained to generate a response based on the input;
receiving an output from the trained model based on the input prompt; and
transmitting, via the email server, a reply email comprising the output received from the trained model based on the input prompt.

2. The method of claim 1, wherein determining whether the email sender address corresponds to a registered user account further comprises determining whether the registered user account associated with the email sender address has sufficient credits to use the trained model.

3. The method of claim 1, wherein determining the input prompt from the request email further comprises determining timing data from the request email and scheduling a delay for providing the input prompt to the trained model based on a queue of pending requests.

4. The method of claim 3, wherein scheduling a delay for providing the input prompt to the trained model further comprises reordering the queue of pending requests based on a determined priority for the request email, wherein the priority is based on one or more of the email sender address, the subject of the request email, the body of the request email, or an attachment of the request email.

5. The method of claim 1, wherein if the email sender address does not correspond to one of a plurality of registered user accounts, the method further comprises transmitting to the email sender address, via the email server, an initial email comprising an invitation to register a new user account.

6. The method of claim 1, wherein determining the input prompt from the request email comprises determining the input prompt based on the subject of the request email and the body of the request email.

7. The method of claim 1, wherein determining an input prompt from the request email comprises determining an input prompt based on a forwarded email included in the request email.

8. The method of claim 1, wherein determining an input prompt from the request email comprises determining an input prompt based on an attached image or a combination of the body and the attached image of the request email.

9. The method of claim 1, wherein determining an input prompt from the request email comprises determining an input prompt based on a body of the request email and an attachment of the request email, wherein the attachment is a document.

10. The method of claim 1, wherein determining an input prompt from the request email comprises determining an input prompt based on an email address to which the request email is addressed.

11. The method of claim 10, wherein the email address to which the request email is sent is a dynamic email address.

12. The method of claim 1, wherein the reply email comprises a link to open a draft email comprising the output received from the trained model based on the input prompt and a recipient address corresponding to an email address in the request email.

13. The method of claim 1, wherein the output received from the trained model based on the input prompt is one or more selected from a list consisting of text, image, video, audio, and data.

14. The method of claim 1, wherein the trained model is a private model trained with private data or fine-tuned with private data provided by an entity associated with the email sender address.

15. The method of claim 1, wherein transmitting, via the email server, a reply email comprising the output received from the trained model based on the input prompt further comprises sending the reply email to a second email address based on information from one or more selected from a list consisting of: an addressee of the request email, a subject of the request email, a body of the request email, an attachment of the request email, and settings for the user account associated with the email sender address.

16. A system comprising:
memory configured to store a request email from an email sender address;
control circuitry configured to:
receive, via an email server, the request email;
determine whether the email sender address corresponds to a registered user account;
if the email sender address corresponds to a registered user account:
determine an input prompt from the request email comprising;
provide the input prompt from the request email as input to a trained model, wherein the trained model is trained to generate a response based on the input;
receive an output from the trained model based on the input prompt; and
transmit, using the input/output circuitry, via the email server, a reply email comprising the output received from the trained model based on the input prompt.

17. The system of claim 16, wherein the control circuitry is configured to determine whether the email sender address corresponds to a registered user account further by determining whether the registered user account associated with the email sender address has sufficient credits to use the trained model.

18. The system of claim 16, wherein the control circuitry is configured to determine the input prompt from the request email by determining timing data from the request email and scheduling a delay for providing the input prompt to the trained model based on a queue of pending requests.

19. The system of claim 18, wherein the control circuitry is configured to determine scheduling a delay for providing the input prompt to the trained model further comprises reordering the queue of pending requests based on a determined priority for the request email, wherein the priority is based on one or more of the email sender address, the subject of the request email, the body of the request email, or an attachment of the request email.

20. The system of claim 16, wherein the control circuitry is configured to, if the email sender address does not correspond to one of a plurality of registered user accounts, transmit to the email sender address, via the email server, an initial email comprising an invitation to register a new user account.

21.-50. (canceled)
